(19) United States
(12) Patent Application Publication
(10) Pub. No.: US 2024/0256631 A1
(43) Pub. Date: Aug. 1, 2024

(54) MATRIX SUMMATION USING INTEGRATED MATRICES

(71) Applicant: SambaNova Systems, Inc., Palo Alto, CA (US)

(72) Inventors: Pramod NATARAJA, San Jose, CA (US); Raghu PRABHAKAR, San Jose, CA (US); David Brian JACKSON, Dana Point, CA (US); Ram SIVARAMAKRISHNAN, San Jose, CA (US)

(73) Assignee: SambaNova Systems, Inc., Palo Alto, CA (US)

(21) Appl. No.: 18/102,658

(22) Filed: Jan. 27, 2023

(51) Int. Cl. G06F 17/16

(52) U.S. Cl. CPC G06F 17/16

(57) ABSTRACT

A computing method comprises combining an M×K multiplicand matrix and P number of addend vectors to generate an M×(K+P) integrated matrix. The addend vectors can comprise a vector of constants and/or a column of an addend matrix. The method further comprises generating a row-extended matrix comprising a K×N multiplicand matrix and P rows of a constant vector. The method computes (K+P) products of a row of the integrated matrix multiplied by a column of the row-extended matrix and computing an integrated sum of the products. A multiply-accumulate computation can compute the integrated sum and is equivalent to a sum of K number of products of a column of the M×K matrix multiplied by a row of the K×N multiplicand matrix and added to the P number of addend vectors. A computing system can implement the method and can include a matrix computation unit.

### INCORPORATIONS

The following are incorporated by reference for all purposes as if fully set forth herein:
Prabhakar et al., “Plasticine: A Reconfigurable Architecture for Parallel Patterns,” ISCA '17, Jun. 24-28, 2017, Toronto, ON, Canada;
U.S. patent application Ser. No. 16/239,252, filed Jan. 3, 2019, entitled “VIRTUALIZATION OF A RECONFIGURABLE DATA PROCESSOR,” (Attorney Docket No. SBNV1000USN01; and,
U.S. patent application Ser. No. 16/922,975, filed Jul. 7, 2020, entitled “RUNTIME VIRTUALIZATION OF RECONFIGURABLE DATA FLOW RESOURCES,” (Attorney Docket No. SBNV1026USN01).

### CROSS-REFERENCE TO RELATED APPLICATIONS

This application is a continuation of and claims benefit of priority to U.S. Provisional Patent Application No. 63/308,916 filed Feb. 10, 2022, titled “INTEGRATED TENSOR COMPUTATIONS IN A COMPUTING SYSTEM”, which is incorporated by reference herein in its entirety.

This application is a continuation of and claims benefit of priority to U.S. Provisional Patent Application No. 63/310,058 filed Feb. 14, 2022, titled “INTEGRATED TENSOR COMPUTATIONS UTILIZING CONSTANTS”, which is incorporated by reference herein in its entirety.

This application is a continuation of and claims benefit of priority to U.S. Provisional Patent Application No. 63/310,049 filed Feb. 14, 2022, titled “INTEGRATED TENSOR COMPUTATIONS WITH BACK PROPAGATION”, which is incorporated by reference herein in its entirety.

### FIELD OF THE TECHNOLOGY

The technology disclosed relates to computing devices and methods for performing matrix and tensor computations in computing systems. The computations can be utilized in applications such as artificial intelligence (e.g., knowledge-based systems, reasoning systems, machine learning systems, and knowledge acquisition systems), unstructured data (e.g., video, audio, and natural language) analysis, and neural networks. Computing systems and/or devices utilizing technology disclosed herein can comprise Coarse-Grained Reconfigurable Architectures (CGRAs).

### BACKGROUND

The present disclosure relates to computing systems for executing data parallel and/or DP computing applications, such as in machine learning and neural networks. The disclosure further relates to methods and structures of a computing system to perform tensor and/or matrix computations such as can be included in machine learning and/or neural networks. Computing systems of the present disclosure include computing systems utilizing reconfigurable processing architectures, such as computing systems comprising Coarse-Grained Reconfigurable Processors (CGRPs)

### BRIEF DESCRIPTION OF THE DRAWINGS

The drawings included in the present disclosure are incorporated into, and form part of, the specification. They illustrate implementations of the present disclosure (hereinafter, “the disclosure) and, along with the description, serve to explain the principles of the disclosure. The drawings are intended to be only illustrative of certain implementations and are not intended to limit the disclosure.

FIG. 1A illustrates an example operator of a neural network, according to aspects of the disclosure.

FIG. 1B illustrates an example matrix computation, according to aspects of the disclosure.

FIG. 1C illustrates example matrix structures that can be utilized to integrate summation of matrix sum-products and addend matrices, according to aspects of the disclosure.

FIG. 2A illustrates an example computing system for performing matrix summation computations, according to aspects of the disclosure.

FIG. 2B illustrates an example integrated summation (ISUM) tensor computing system (TCS) to integrate summation of matrix sum-products and addend matrices, according to aspects of the disclosure.

FIG. 3A illustrates an example ISUM matrix compute unit (MCU), according to aspects of the disclosure.

FIG. 3B illustrates an example ISUM processing unit (ISUM PU), according to aspects of the disclosure.

FIG. 4A illustrates an example ISUM TCS utilizing a plurality of ISUM MCUs, according to aspects of the disclosure.

FIG. 4B illustrates an example ISUM PU utilizing a plurality of ISUM MCUs, according to aspects of the disclosure.

FIG. 5 illustrates an example method for an ISUM TCS to integrate summation of matrices with computation of sum-products, according to aspects of the disclosure.

FIG. 6 illustrates an alternative example method for an ISUM TCS to integrate summation of matrices with computation of sum-products, according to aspects of the disclosure.

FIG. 7A illustrates an example method for an ISUM TCS to compute sum-products of matrices by a plurality of matrix computation units, according to aspects of the disclosure.

FIG. 7B illustrates an example ISUM TCS utilizing a plurality of MCUs to compute sum-products of matrices, according to aspects of the disclosure.

FIG. 8A illustrates example ISUM computations utilizing a constant addend, according to aspects of the disclosure.

FIG. 8B illustrates example ISUM computations utilizing a matrix addend multiplied by a constant or matrix of constants, according to aspects of the disclosure.

FIG. 8C illustrates example ISUM computations utilizing a plurality of addend matrices multiplied by a constant, or matrix of constants, according to aspects of the disclosure.

FIG. 8D illustrates example ISUM computations utilizing a multi-column addend matrix multiplied by a constant, or matrix of constants, according to aspects of the disclosure.

FIG. 8E illustrates example ISUM computations utilizing a plurality of multi-column addend matrices multiplied by a constant, or matrices of constants, according to aspects of the disclosure.

FIG. 9A illustrates an example back propagation computation using an ISUM transpose-extended matrix, according to aspects of the disclosure.

FIG. 9B illustrates example ISUM transpose-extended matrices, according to aspects of the disclosure.

FIG. 9C illustrates an example method to generate an ISUM transpose-extended matrix, according to aspects of the disclosure.

FIG. 10 illustrates an example TCS for performing generating and using an ISUM transpose-extended matrix in back propagation computations, according to aspects of the disclosure.

FIG. 11 illustrates an example transpose arithmetic logic unit for generating an ISUM transpose-extended matrix with scalar injection, according to aspects of the disclosure.

### DETAILED DESCRIPTION

Aspects of the present disclosure (hereinafter, “the disclosure”) relate to methods of performing matrix sum-product computations in computing systems. More particular aspects relate to improving parallelism of matrix computations and reducing processing cycles times computing systems by means of integrating a matrix addend in an additional column of a multiplicand matrix and extending a row or column of another multiplicand matrix to include a constant. Implementations of the disclosure (hereinafter, “implementations”) can perform matrix summation computations, such as a sum of a matrix addend and the sum-product of multiplicand matrices (Σw a+b), by computing a sum-product of two integrated summation (ISUM) multiplicand matrices ((Σwb a) and omitting a separate addition of an addend to the sum-product of the multiplicand matrices.

Aspects of the disclosure can also particularly apply to processors of data parallel (DP) computing systems, such as Central Processing Unit (CPUs), Graphics Processing Units (GPUs), Field Programmable Gate Arrays (FPGAs), and Digital Signal Processors (DSPs). Certain aspects of the disclosure relate to performing tensor and/or matrix computations in computing systems utilizing reconfigurable processor architectures, such as computing systems utilizing Coarse-Grained Reconfigurable Architectures (CGRAs), and/or reconfigurable Application Specific Integrated Circuits (ASICs) or Application Specific Instruction-set Processors (ASIP).

Implementations that are not mutually exclusive are taught to be combinable. One or more features of an implementation can be combined with other implementations. The disclosure in some instances repeats references to these options. However, omission from some implementations of recitations that repeat these options should not be taken as limiting the combinations taught in the preceding sections—these recitations are hereby incorporated forward by reference into each of the following implementations.

Particular expressions of the disclosure will be understood to have the following operative meanings:
The phrases “at least one”; “one or more”; and “and/or” are to be understood as open-ended expressions that operate both conjunctively and disjunctively. For example, each of the expressions “at least one of A, B, and C”, “at least one of A, B, or C”, “one or more of A, B, and C”, “one or more of A, B, or C”, and “one or more of A, B, and/or C” means A alone, B alone, C alone, A and B together, A and C together, B and C together, or A, B, and C together.
The term “a” or “an” entity refers to one or more of that entity. As such, the terms “a”/“an”, “one or more”, and “at least one” can be used interchangeably herein.
The terms “comprising”, “including”, and “having” can be used interchangeably herein.

As used herein, “incorporated subject matter” refers, collectively, to subject matter disclosed, and/or otherwise encompassed, among the disclosures incorporated herein by reference. For purposes of illustrating the disclosure, but not intended to limit implementations, various terms of the disclosure are drawn from the incorporated subject matter. As used herein, unless expressly stated otherwise, such terms as may be found in the incorporated subject matter have the same meanings, herein, as their meanings in their respective incorporated disclosures.

Aspects of the disclosure can be appreciated through a discussion of example implementations and/or applications of methods and/or systems. However, such examples are for purposes of illustrating the disclosure. It should be understood that the intention is not to limit the disclosure to the example implementations described herein, but to encompass all modifications, equivalents, and alternatives falling within the spirit and scope of the disclosure. Thus, the disclosure is not intended to be limited to the implementations shown but is to be accorded the widest scope consistent with the principles and features disclosed herein. Various modifications to the disclosed examples will be readily appreciated by those of ordinary skill in the art, and the general principles defined herein may be applied to other implementations of the disclosure without departing from the spirit and scope of the disclosure.

Turning now to more particular aspects of the disclosure, some computing applications comprise computations that can be executed concurrently, in parallel among a plurality of computational elements, and/or by a pipeline of computational elements (processors and/or programs executing on processors, of a dataflow computing system). As the application data and computational results “flow” through successive processing elements of a dataflow computing system, such pipelined dataflow applications can be referred to also as “dataflow” application. Examples of such dataflow applications include machine learning (ML) and deep machine learning (DML) methods of Artificial Intelligence (AI) applications; image processing; stream processing (e.g., processing of streaming video and/or audio data); natural language processing (NLP); and/or recommendation engines.

Dataflow computing systems can comprise reconfigurable processing elements (reconfigurable processors, or “RPs”) particularly designed and/or configured to efficiently perform dataflow computing applications. Reconfigurable processors, such as field programmable gate arrays FPGAs and/or CGRA-based processors, can be configured to implement a variety of computational and/or data transfer functions more efficiently or faster than might be achieved using a general-purpose processor executing a computer program. Prabhakar, et al., “Plasticine: A Reconfigurable Architecture for Parallel Patterns,” ISCA '17, Jun. 24-28, 2017, Toronto, ON, Canada, (hereinafter, “Prabhakar”) describes example CGRAs and, systems utilizing such CGRAs, that can be particularly advantageous in dataflow computing system. Accordingly, aspects of the disclosure relate to methods and systems utilizing reconfigurable dataflow resources, such as resources of a CGRA. However, the disclosure is not necessarily limited to such applications and/or computing systems.

As used herein, the term “CGRA” refers interchangeably to a coarse grain reconfigurable architecture and a computing hardware implementation—such as an integrated circuit, chip, or module—based on, or incorporating, a coarse grain reconfigurable architecture. In implementations of the disclosure (hereinafter, “implementations”), systems based on, and/or incorporating, CGRAs, such as the example of Prabhakar, can be particularly adaptable to, and increasingly efficient in, performing dataflow and/or data parallel application processing. Hardware resources of a CGRA (e.g., PCUs, PMUs, tiles, networks, and/or network interfaces) can comprise one or more Integrated Circuits (ICs). As used herein, the term “chip” refers to an IC (or, combination of ICs) that can embody elements of a CGRA. A chip can typically be packaged in a chip module (e.g., a single chip module, “SCM” or, alternatively, a multi-chip module, “MCM”).

As used herein, the term “reconfigurable dataflow system (RDS)” refers to a computing system that is based on, and/or can utilize, reconfigurable dataflow resources, such as resources of CGRAs, to perform operations of dataflow applications. Owing to reconfigurability, reconfigurable dataflow systems can perform these operations more efficiently than systems comprising fixed or non-reconfigurable resources. As also used herein, the term “application” refers to any computing application (e.g., software program), and/or computing system, that utilizes an RDS, to perform algorithms and/or computations of the application. An application can execute, for example, on a processor included in, or coupled to, an RDS.

U.S. Nonprovisional patent application Ser. No. 16/239,252, “VIRTUALIZATION OF A RECONFIGURABLE DATA PROCESSOR”, to Grohoski, et al, (hereinafter, “Grohoski”), and U.S. Nonprovisional patent application Ser. No. 16/922,975, “RUNTIME VIRTUALIZATION OF RECONFIGURABLE DATA FLOW RESOURCES”, to Kumar, et al, (hereinafter, “Kumar”), both incorporated herein by reference, illustrate example implementations of a reconfigurable dataflow architecture and reconfigurable dataflow systems.

Kumar illustrates a dataflow system (e.g., an RDS) comprising user applications, programming libraries (e.g., deep learning frameworks), a software development kit, computation graphs associated with user applications, compilers, execution files that can specify operations of a user application to perform using resources (reconfigurable data flow resources) of the dataflow system, and host and runtime processors. User applications can comprise data parallel and/or dataflow applications. As illustrated by the examples of Kumar an RDS can comprise a plurality of physical racks each comprising one or more compute nodes (hereinafter, for brevity, “nodes”).

In the examples of Kumar a host and runtime processors can, for example, facilitate compiling a dataflow application, determining particular RDS resources to execute the application, and managing execution of the RDS resources in performing operations of the application. In the examples of Kumar a node can comprise a host processor, a runtime processor, and reconfigurable processors (“RPs”), and a runtime processor can include kernel drivers and/or a user space library (e.g., a library of programs a user can include, or can invoke, in a dataflow application and that can execute in a user space of a runtime processor).

In implementations, an RP can comprise reconfigurable processing elements with reconfigurable interconnections. In the examples of Grohoski and Kumar, reconfigurable processing elements of RPs can comprise one or more arrays (“tiles”) of configurable processors (pattern compute units, “PCUs”) and/or memory units (pattern memory units, “PMUs”). Within a tile the PCU processing and memory units can be interconnected by an ALN of switches. Tiles can be interconnected, such as via a TLN, to form RPs comprising multiple tiles. Thus, in the examples of Grohoski and Kumar, an RP can comprise a set of tiles and/or subarrays of a tile.

As illustrated by Kumar and Grohoski, a reconfigurable data-flow unit (RDU) of a dataflow system can comprise a dynamically reconfigurable hardware resource of the system that includes processing elements (e.g., RPs) to perform operations of dataflow applications. RDUs of a dataflow system can comprise (e.g., be based upon), for example, a CGRA. An RDU can comprise a set of processing elements (e.g., RPs), I/O interfaces to communicate among processors of differing RDUs, and, optionally, a memory. In the examples of Kumar and Grohoski an RDU can, comprise other than simply computational elements (e.g., processors, such as PCUs) and/or memories (e.g., PMUs), such as clock circuits, control circuits, switches and/or switching circuits, interconnection interface circuits (e.g., processor, memory, I/O bus, and/or network interface circuits, etc. Kumar also illustrates that an RDU can include virtualization logic and/or, RP configuration logic.

For purposes of illustrating the disclosure, but not intended to limit implementations, the disclosure occasionally refers to the example of an RDU comprising RPs of Kumar to illustrate a reconfigurable processing element for executing operations (e.g., computations and/or data transfer) of dataflow applications, such as matrix and tensor computations of dataflow applications. However, it would be appreciated by one of ordinary skill in the art that a processing element of a dataflow computing system can comprise any form of hardware processor, or combination of hardware processor, memories, interconnection, and/or ancillary circuits (e.g., clocks, control, interface, and/or status circuits), that can perform operations of dataflow applications. dataflow processing elements can comprise, for example, central processing units (CPUs); accelerator-class processors; matrix processing units (MCUs), intelligence processing units (IPUs), graphics processing units (GPUs); and/or, field programmable gate arrays (FPGAs) configured to perform particular dataflow application computations. According to examples of the incorporated references RPs can comprise (e.g., can be based upon), for example, a coarse-grained reconfigurable architecture (CGRA).

Many dataflow applications—such as machine learning, streams processing, image/video processing, and other complex computational applications—involve linear algebra computations over tensor data, such as matrix multiplication, transposition, and addition. Algorithms commonly employed in dataflow applications include algorithms such as linear regression and gradient descent over tensors and/or matrices of tensors. As used herein, “Tensor Computing Systems (TCS)” refers to a computing system configured to process tensors, such as dataflow computing systems, systems including neural networks, and any other computing system that includes hardware and/or software components for processing tensors.

A TCS can include general processors and can include specialized processors and/or computation units, such as accelerators, GPUs, FGPAs, CGRA accelerators, and other types of compute units. With reference to the examples of Grohoski and Kumar, processors and/or memories of a TCS can comprise processors and/or memories of RDUs and/or RPs of RDUs (e.g., tiles, PCUs, and/or PMUs). A TCS comprise programs executable on such processors. A TCS can comprise specialized programs for processing tensors, such as programs for compiling dataflow applications for execution on particular TCS processing elements, programs to configure particular TCS processing elements for executing dataflow applications (e.g., matrix computations of dataflow applications), and/or programs for executing dataflow applications on particular TCS processing elements.

Tensors can comprise matrices of varying dimensions and a variety of computing systems, including dataflow computing systems, can perform matrix computations, such as General Matrix Multiplication (GeMM), matrix summation, matrix transposition, gradient computations, and/or backpropagation of matrix computations, to process tensors in dataflow applications such as machine learning in neural networks. As used herein, brackets and a capital letter, such as [M], is used to refer to a matrix as a whole, while lowercase letters, such as m, are used to refer to an element, or set of elements, of a matrix [M]. For example, an expression such as (w×a) refers, herein, to a multiplication of a set of elements of matrices [W] and [A], such as elements of a row of matrix [W] multiplied by elements of a corresponding column of matrix [A]. The term “element”, in reference herein to a matrix, refers to the contents (e.g., a scalar value) of a row and column cell of the matrix.

A common computation for processing tensors in dataflow applications is a sum of products of two multiplicand matrices added to a matrix addend. The products comprise products of elements of a row of one multiplicand matrix multiplied by corresponding elements of a column of a second multiplicand matrix, where the row and column are the same (shared) matrix dimension. As used herein, the term “sum-product” refers to a sum of two or more products of elements of multiplicand matrices. An expression such as (Σw a) refers to a sum-product of elements w and a (e.g., a sum of products w×a for elements of a row of a matrix [W] multiplied by elements of a column of a matrix [A]). As an example, a sum-product of elements w₁₁ of matrix [W multiplied by a₁₁ of matrix [A], and w₁₁ multiplied by a₂₁ of matrix [A], is [w₁₁×a₁₁+w₁₁×a₂₁].

A “matrix summation” computation, as used herein, refers to a matrix computation in which a sum-product of two multiplicand matrices is added to a matrix addend. A matrix addend can comprise a constant or can comprise a matrix (which can itself be multiplied by a matrix multiplied by a constant) sharing a row dimension of the sum-product of two multiplicand matrices. A “weight-bias function”, y=Σw a+b, is one example of such a computation, in which a weights matrix [W] is multiplied by an activation matrix [A] and the sum-products, Σw a, for each row/column set of products, is added to elements of a bias matrix [B]. A more general form of a matrix summation computation can be expressed as y=Σw a+sb, where “s” is a constant, such as one or another constant. When “s” equals constant one, the more general matrix summation computation becomes the weights-bias function y=Σw a+b. Thus, while the examples of the disclosure frequently refer to an example weights-bias function in which “s”=1, it will be understood by one of ordinary skill in the art that “s” can equally have values other than “1” without materially altering the examples of the disclosure.

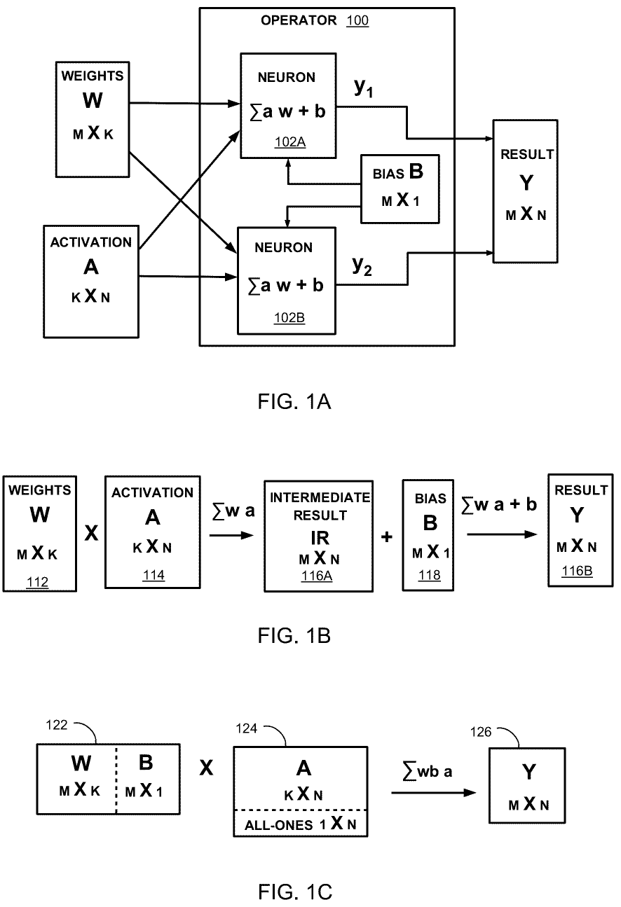

Tensor computing systems can utilize neural networks to execute dataflow application algorithms, and neurons in a neural network can process tensors (e.g., can perform matrix computations) of such algorithms. A combination of neurons in a layer of a neural network is often referred to as an “operator” and an operator can perform an activation function involving tensor computations. FIG. 1A illustrates an example operator of a neural network that can perform tensor computations.

In FIG. 1A operator 100 is shown comprising two artificial (computing) neurons, 102A and 102B (collectively, “neurons 102”). In dataflow computing systems tensor data can be organized as matrices and elements of the matrices can be inputs/outputs of operators, and/or neurons of operators. In neural networks, neurons can receive elements of input matrices, compute an “activation function” on the inputs, and output a result of the activation. Each of neurons 102 is shown in FIG. 1A to compute an activation function comprising Σw a+b on input matrices [W], [A], and [B] and output respective results y₁ and y₂ to output matrix [Y]. In addition or, alternative, to matrix [Y] the activation function output(s) of neurons can be input to other neurons in a successor (or, in a feedback network, a predecessor) operator, or set of operators, such that a network can comprise layers of predecessor and successor operators. Thus, result y₁ and/or y₂ in FIG. 1A can be an input to one or more successor operators (or, neurons of operators) in a neural network (not shown in FIG. 1A), and/or as shown in GIG. 1A, to an output matrix (M×N matrix [Y] in FIG. 1A).

FIG. 1A illustrates operator 100 computing an M×N weights-bias result matrix [Y] as (Σw a+b) over input matrices M×K weight matrix [W], K×N activation matrix [A], and M×1 bias matrix [B]. As used herein, the nomenclature “D₁×D₂” refers to a matrix of D₁ rows and D₂ columns. Thus, “M×K” refers to a matrix of M rows and K columns, and “K×N” refers to a matrix of K rows and N columns, “M×1” refers to a matrix of M rows and 1 column, and “M×N” refers to a matrix of M rows and N columns.

In FIG. 1A, each of neurons 102 receives elements of matrix [A], matrix [W] (e.g., row/column cells of matrices A and W) and matrix [B] (e.g., row elements of matrix [B]) as inputs. FIG. 1A depicts operator 100 outputting computation results y₁ and y₂ of (Σw a+b) to M×N matrix [Y]. As used herein the term “sum-product matrix”, refers to a matrix of sum-products, such as a matrix of sum-products (Σw a) of a matrix [W] and a matrix [A]. A sum-product matrix can be, for example, an M×N matrix of sum-products of Σw_{i,dim} a_{dim,j} for all values of dim from, 1 to K, for values of i from 1 to M, and for all values of j from 1 to N.

The term “Addend sum-product”, as used herein, refers to a sum yᵢⱼ=Σw_{i,dim} a_{dim,j}+b_{dim} computed for elements of row i of an M×K multiplicand matrix [W], column j of a K×N multiplicand matrix [A], and row_{dim} of an M×1 addend matrix [B] (or, a column of constant values) computed for some or all values of dim within 1 to K. Correspondingly, as used herein, the term “Addend Sum matrix” refers to an M×N matrix of Addend sum-product elements, y_{ij, computed} as yᵢⱼ=Σw_{i, dim} a_{dim,j}+b_{dim} for all values of i from 1 to M, all values of j from 1 to N, and all values of dim from 1 to K. As depicted In FIG. 1A, M×N weights-bias result matrix Y is an example of an Addend Sum matrix. such as matrix [Y] in FIG. 1A.

In an activation function such as a weight-bias computation a conventional TCS, as presently known in the art, commonly computes sum-products of two multiplicand matrices (e.g., [W] and [A]) and then adds an Addend matrix (e.g., [B]) as a separate and subsequent computation. That is, a conventional TCS commonly computes a complete M×N intermediate sum-product matrix of (Σw a) and subsequently adds all row elements, from 1 to M, of matrix [B], to all elements, from row 1 to M, of all columns, from 1 to N, of the intermediate results matrix.

Continuing the example of a weight-bias function, FIG. 1B illustrates an example of computing an Addend Sum matrix by a conventional TCS as a sequence of sum-product computations producing an intermediate, results sum-product matrix, followed (serially) by an addition of the intermediate matrix to the bias matrix, [B], to compute an Addend Sum matrix of (Σw a+b) over all of matrices [W], [A], and [B]. In the example of FIG. 1B matrix [W] 112 is an M×K matrix of weight elements, matrix [A] 114 is a K×N matrix of activation elements, and matrix [B] 118 is an M×1 matrix of bias elements. Matrix [IR] 116A is an M×N intermediate results matrix computed as a sum-product, (I w a), of weight matrix [W] 112 and activation matrix [A] 114. Results matrix [Y] 116B is then an M×N matrix computed as the sum of matrix [IR] 116A and bias matrix [B] 118. In the example of FIG. 1B, the TCS computes all elements of intermediate sum-product matrix [IR] 116A prior to adding all elements of bias matrix [B] 118 to matrix ‘[IR] 116A to produce the final Addend Sum matrix. matrix [Y] 116B as a subsequent addition of matrices [IR] 116A and [B] 118.

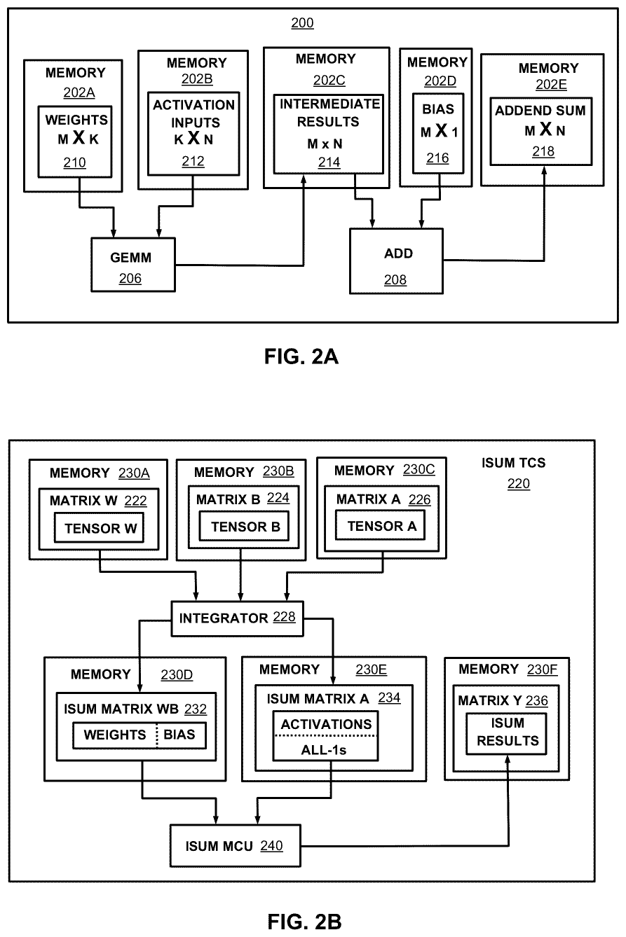

Turning briefly to FIG. 2A, computing system 200 illustrates an example conventional TCS that can compute an Addend Sum matrix of a weight-bias function in the manner of FIG. 1B. In FIG. 2A, computing system 200 includes GEMM 206 and adder 208. Memories 202A-202E (collectively, “memories 202”) contain respective M×K weights matrix 210, K×N activation matrix 212, M×N intermediate sum-product matrix 214, M×1 bias matrix 216, and M×N Addend Sum matrix 218.

GEMM 206 can perform general matrix multiplication of weights matrix 210 and activation matrix 212. GEMM 206 can comprise a matrix multiply processor and can receive elements of weights matrix 210 and activation matrix 212 from memories 202A and 202B, and can compute sum-products of the weights and activation elements. GEMM 206 can store the sum-product results in memory 202C as elements of intermediate sum-product matrix 214. Subsequently, adder 208 can retrieve elements of intermediate sum-product matrix 214 from memory 202C and elements of bias matrix 216 from memory 202D, can add these, and can store the Addend Sum (elements of the bias matrix plus the sum-product elements of intermediate results matrix) results in Addend Sum matrix 218 in memory 202E.

Performing tensor sum-product and addition computations as two separate and serial computations, such as in a conventional TCS, can add computational latency and can correspondingly limit, or reduce, computational performance of a dataflow computing system. For example, serial addition of multiplicand matrix sum-products and addend elements can include additional latency associated with transfer of intermediate sum-product results between memories of (or, accessible to) computational elements a TCS, such as one memory holding intermediate sum-products and a second memory holding resulting Addend Sum matrix elements.

Serial multiplicand sum-product and addend addition computations can require dedicated memories (e.g., scratch pad memories) and/or computation units (e.g., additional MCUs) to perform sum-product computations prior to, and separate from, addition of a matrix addend. Computational units of a TCS (e.g., a sum-product ALU and/or adder ALU) can be underutilized while awaiting other computational results. For example, an adder ALU, and/or related circuits or processors, can be idle and, correspondingly, underutilized to await results (and/or transfer of results) of sum-product computations stored in an intermediate memory. A sum-product ALU can be idle, or underutilized, for example, to await completion of addend addition utilizing an intermediate sum-product matrix or memory containing an intermediate sum-product matrix.

To improve matrix computational efficiency, reduce computational and/or memory transfer latencies, increase computational throughput, and/or reduce the number and/or type of computational units and/or memories, implementations can comprise an enhanced, “Integrated Summation (ISUM)” TCS. An ISUM TCS can generate two “ISUM matrices” from multiplicand and addend matrices of a matrix summation computation (e.g., [W], [A], and [B] in a weights-bias computation). Using the ISUM matrices an ISUM TCS can compute a sum-product of the two ISUM matrices that is equivalent to an Addend Sum matrix computed as an intermediate sum-product matrix of two multiplicand matrices subsequently added to a matrix addend.

An ISUM TCS can generate ISUM matrices that take advantage of a shared dimension of multiplicand and addend matrices. An ISUM TCS can integrate an added matrix that shares a row dimension with a multiplicand matrix to generate an ISUM “integrated matrix”. For example, an ISUM TCS can generate an M×(K+1) integrated matrix having, in columns 1 to K, columns to 1 to K of an M×K multiplicand matrix [W] and, in an additional (K+1) column of the ISUM integrated matrix, an M×1 addend matrix [B]). More generally, an ISUM TCS can generate an M×(K+P) ISUM integrated matrix comprising K number of multiplicand columns having, in columns 1 to K of the ISUM integrated matrix, corresponding columns of an M×K multiplicand matrix; and, comprising P number of “addend columns” having, in each of columns (K+1) to (K+P) of the ISUM integrated matrix, an “integrated addend”.

As used herein, the term “multiplicand column” refers to an M×1 column of an M×K multiplicand matrix, such as an M×K matrix [W], or a K×N matrix [A], in a weights-bias computation such as [Σw a+b] The term “integrated addend”, as used herein, refers to a single column of an addend matrix sharing the row dimension of a multiplicand matrix, such as an M×1 column of an addend matrix sharing row dimension M of an M×K multiplicand matrix.

Correspondingly, as used herein, the term “addend column” refers to a column of an ISUM integrated matrix comprising an integrated addend. In an M×(K+P) ISUM integrated matrix, each of the P number of addend columns of the ISUM integrated matrix can comprise an integrated addend of an addend matrix having row dimension M. In implementations, as just described an addend column of an ISUM integrated matrix can comprise elements of a column of an addend matrix (e.g., matrix [B] in computing [Σw a+b]) sharing the row dimension of a multiplicand matrix e.g., matrix [W] in computing [Σw a+b]). An addend column can comprise, alternatively, a value of a constant (e.g. constant value 1 or a value of another constant) in each row of the multiplicand column.

An ISUM TCS can generate a second ISUM multiplicand matrix based on a shared (or, partially shared) dimension of an ISUM integrated matrix and the second input multiplicand matrix, such as dimension K of an M×(K+P) ISUM integrated matrix and a K×N input multiplicand matrix. An ISUM multiplicand matrix can comprise, for example, a K×N input multiplicand matrix or, alternatively, can comprise a (K+P)×N “ISUM row-extended matrix” comprising the K×N input multiplicand matrix extended to have an additional (K+P) number of rows (or, K+P columns) of constants (e.g., a constant in each columns of the P rows of the ISUM row-extended matrix).

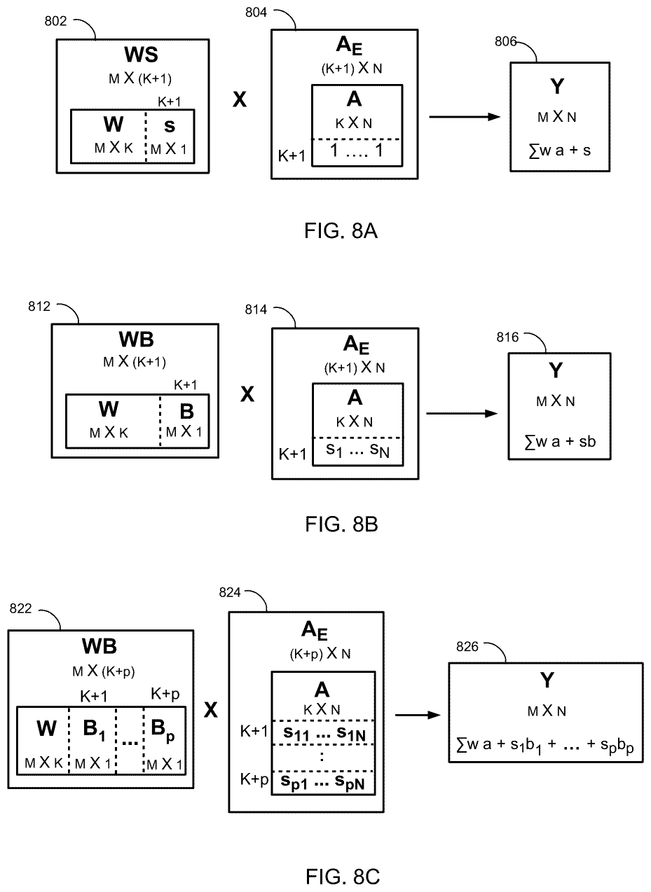

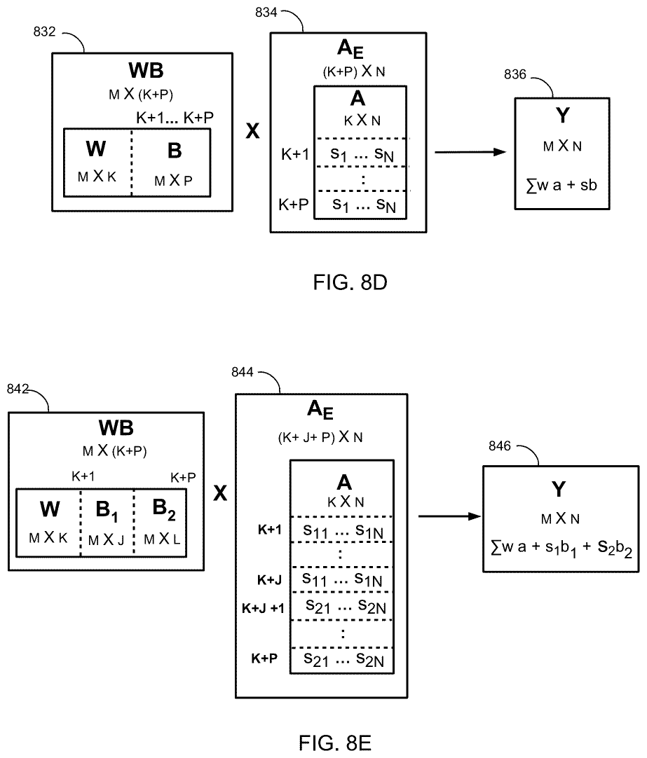

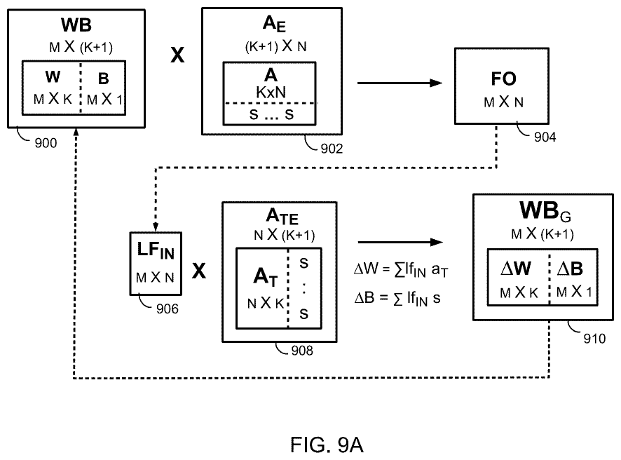

As used herein, the term “constant row” refers to a matrix having row dimension 1 and containing the same constant value in each column of the matrix. In an ISUM row-extended matrix, each row of the P rows of the ISUM row-extended matrix can comprise a constant row, and each constant row can comprise the same constant value, or can comprise different constants (e.g., values of a plurality of constant factors in a matrix summation computation such as will be seen in FIG. 8C).

As also used herein, the term “ISUM multiplicand matrix” refers to any input multiplicand matrix to be multiplied by an ISUM TCS (or, components thereof) to compute a sum-product of the ISUM multiplicand matrix and an ISUM integrated matrix. Thus, an ISUM multiplicand matrix can be an input multiplicand matrix as input (i.e., having only the elements of the input multiplicand matrix) or, alternatively, can be an ISUM row-extended matrix.

An ISUM TCS can compute an Integrated Sum matrix (or, elements thereof) equivalent to (Σw a+sb), where s is a constant, such as one, or another constant, by computing only sum-products of an ISUM integrated matrix and an ISUM multiplicand matrix. The ISUM TCS can compute the equivalent output matrix, [Y], without requiring, or utilizing, a separate and subsequent addition of the matrix addend to an intermediate sum-product matrix. An ISUM TCS can thereby improve overall TCS design and/or tensor computational performance, by simplifying TCS computations and eliminating latencies and/or under-utilization of TCS resources associated with storing intermediate sum-product matrices and performing serial sum-product and addend matrix addition computations.

Continuing with the example of a weight-bias function, FIG. 1C illustrates example ISUM matrices that an ISUM TCS can generate (or can utilize as inputs) along shared dimensions of input multiplicand and addend matrices. To generate an ISUM integrated matrix can ISUM TCS can append P number of M×1 integrated addends, of an M×P addend matrix, to an M×K multiplicand matrix in columns K+1 to K+P of the ISUM integrated matrix. An ISUM TCS can extend a K×N multiplicand matrix by adding P rows comprising constant rows as rows K+1 to K+P of the matrix addend.

To simplify the illustration of generating an ISUM integrated and row-extended matrix, and computing a matrix from these ISUM matrices, the description of FIGS. 1C through 7B use an example of an ISUM integrated matrix comprising an M×1 integrated addend, comprising an M×1 addend matrix, in column (K+1) of the ISUM integrated matrix. Similarly, the description of FIGS. 1C through 7B use an example of an ISUM row-extended matrix comprising a 1×N constant row, comprising a constant in each column element of the constant row, in row (K+1) of the ISUM integrated matrix. However, this is only to illustrate the disclosure and not intended to limit implementations. As previously described, an ISUM integrated matrix can have P columns each column comprising an integrated addend, and an ISUM row-extended matrix can have P rows each comprising a constant row. FIGS. 8A through 8E illustrate such alternative examples in which P, in a (K+P) dimension of an ISUM integrated and ISUM row-extended matrix is greater than one.

In FIG. 1C, ISUM matrix 122 is shown as an M×(K+1) matrix combining an M×K multiplicand matrix [W] (e.g., a weights matrix) and an integrated addend, in column (K+1) of ISUM matrix 122, comprising M×1 addend matrix [B] (e.g., a bias matrix). FIG. 1C further illustrates ISUM matrix 124 as a (K+1)×N ISUM row-extended matrix generated by appending a constant row, in row (K+1). Scalar constants included in the constant row of row (K_1) can have value 1 or can have another constant value. In the example of FIG. 1C, ISUM matrix 124 is an ISUM row-extended matrix that appends a constant row of scalar 1 values (e.g., Python “torch.ones”) to a K×N matrix, [A], as the (K+1) row of ISUM matrix 124.

As used herein, the term “integrated sum-product” refers to a sum of (all, or only some) products of elements of a row i of an M×(K+1) ISUM integrated matrix and respective elements of a column j of a (K+1)×N ISUM row-extended matrix, such as Σw_{i, dim} a_{dim,j} for values of dim within the range 1 to (K+1) for a given value of i and j. Correspondingly, as used herein, the term “Integrated Sum” refers to an integrated sum-product computed over all (K+1) elements of a row i of an ISUM integrated matrix and corresponding (K+1) or, alternately, K, elements of a column j of an ISUM multiplicand matrix, and “Integrated Sum Matrix” refers to a matrix comprising Integrated Sums. As will be seen through a discussion of the examples of the disclosure, an Integrated Sum is equivalent to an Addend Sum, and an Integrated Sum matrix equivalent to an Addend Sum matrix.

In computing an Integrated Sum equivalent to an Addend Sum, an ISUM TCS can omit a separate and subsequent addition of a matrix addend, such as bias matrix [B] 118 in FIG. 1B to a complete, intermediate sum-product matrix, such as intermediate result matrix 116A in FIG. 1B. That is, using only sum-product computations of M×(K+1) ISUM matrix 122 and (K+1)×N ISUM matrix 124 an ISUM TCS can compute M×N Integrated Sum matrix 126 in FIG. 1C having Integrated Sum output elements equivalent to Addend Sum elements computed as sum-products of matrix [W] and matrix [A], in respective ISUM matrices 122 and 124, subsequently added to elements of bias matrix [B] in ISUM matrix 122 (i.e., equivalent to (Σw a+b) computed as a sum-product matrix [Σw a] subsequently added to addend elements, b, of a matrix addend, matrix [B]).

While the example of FIG. 1C illustrates matrix 124 as a matrix of bias values, each of which can be different from the others, this is only to illustrate the example and not intended to limit implementations. In alternative implementations, an ISUM TCS can compute (Σw a+s), where “s” is a constant, in the same manner as computing (Σw a+b), where “b” is an M×1 matrix. For example, an ISUM TCS can generate ISUM matrix 122 to contain constant “s” in each element of column (K+1) of ISUM matrix 122.

FIG. 2B illustrates an example ISUM TCS that can generate ISUM matrices, such as in the example of matrix 122 and matrix 124 of FIG. 1C, and can compute multiplicand matrix sum-product and addend matrix addition using only sum-products of the ISUM matrices. As will be seen from the following discussion of FIG. 2B, an Integrated Sum matrix of a matrix summation computation, computed as integrated sum-products of an ISUM integrated matrix and an ISUM multiplicand matrix, is equivalent to an Addend Sum matrix of the matrix summation computation computed as a sum-product matrix of two multiplicand matrices added to a matrix addend as a second computation. For only purposes of illustrating an example ISUM TCS, but not intended to limit implementations, ISUM TCS 220 of FIG. 2B is described as performing matrix summation computations of a weights-bias function.

In FIG. 2B ISUM TCS 220 is shown comprising memories 230A-230F (collectively, “memories 230”), ISUM integrator 228 (hereinafter, “integrator 228”), and ISUM MCU 240. Memories among memories 230 can be any memory accessible to components of ISUM TCS 220, and can comprise separate memories, or can comprise a single memory. Referring to the examples of Grohoski and Kumar, and similar or equivalent dataflow computing systems and components, memories among memories 230 can comprise, for example, memories of a host or runtime processor, memories of an RDU, and/or PMUs of a tile.

In implementations, an ISUM TCS can comprise an ISUM matrix integrator (hereinafter, for brevity, “an integrator”), illustrated by the example of integrator 228 in FIG. 2B, that can generate an ISUM integrated matrix and/or an ISUM multiplicand matrix. In the example of FIG. 2B, integrator 228 can receive (or, otherwise access) input tensor elements from matrices [W] 222, [B] 224, and [A] 226 stored in respective memories 230A, 230B, and 230C. ISUM integrator 228, can alternatively, or additionally, receive input matrices (e.g., [W] 222, [B]224, and/or [A] 226) from a source other than a memory. While not shown in FIG. 2B, as previously described a TCS, such as ISUM TCS 220, can include processors, such as a neural network, a host processor, runtime processor, RDU and/or processors of RDUs, and/or accelerator processors (CGRAs, FPGAs, GPUs, etc.). TCS 220 can comprise ISUM programs, such as programs for generating ISUM integrated matrices and/or computing ISUM integrated sum-products and/or Integrated Sums, and the programs can execute on processors of the TCS.

An ISUM integrator can comprise processors and/or programs of an ISUM TCS (or, of one or more components of a TCS, such as a processing unit of an ISUM TCS), and/or can comprise logic circuits, configured to compute ISUM matrices. An ISUM integrator can comprise a processor of a TCS, such as a host or runtime processor of an RDS, or an RP of an RDU. An ISUM integrator can comprise a processor of a computer, or computing system, including or coupled to memories 230D and/or 230E, and/or can comprise a specialized logic circuit of a TCS, or of a component of a TCS.

While FIG. 2B illustrates ISUM integrator 228 as a component of ISUM TCS 220, this is for only purposes of illustrating the disclosure. In implementations, an ISUM integrator can comprise any component of, or coupled to, a TCS that is configured to generate ISUM integrated and/or extended matrices. For example, an ISUM integrator can be a component of a host or runtime processor of TCS. A compiler of a TCS (e.g., a compiler of a dataflow computing system) can include an ISUM integrator, or can operate as an ISUM integrator, to generate ISUM integrated and/or extended matrices.

An ISUM TCS can receive ISUM matrices (e.g., in a memory, or as an argument of an API) as inputs, and need not include a component to generate the ISUM matrices. Thus, while the examples of the disclosure refer to an ISUM integrator as a component of an ISUM TCS, it would be appreciated by one of ordinary skill in the art that an ISUM integrator can be any component of a dataflow system, or communicatively coupled to a dataflow system, that can generate ISUM matrices from input multiplicand and addend matrices.

Using the example of a weights-bias function, in FIG. 2B matrix W 222 can be an M×K matrix of a weights tensor, matrix A 226 can be a K×N matrix of an activation tensor, and matrix B 224 can be an M×1 matrix of a bias tensor. Integrator 228 can generate based on these inputs, ISUM matrix WB 232 (hereinafter, “matrix WB 232”) as an M×(K+1) ISUM integrated matrix combining weights of matrix W 222 and biases of matrix B 224, such as illustrated by the example of ISUM matrix 122 in FIG. 1C. In matrix WB 232, columns 1 through K can contain respective weights elements of columns 1 through K of weights matrix W 222 and column (K+1) can comprise an integrated addend containing bias elements of rows 1 through M of matrix B 224.

Integrator 228 can generate ISUM matrix A 234 (hereinafter, “matrix A 234”) as a (K+1)×N ISUM row-extended matrix containing rows 1 through K of K×N matrix A in rows 1 through K of matrix A 226, and a constant row in row (K+1), such as illustrated by the example of ISUM matrix 124 of FIG. 1C. Integrator 228 can store matrix WB 232 and/or matrix A 234 (or, portions thereof) in memories, such as in respective memories 230D and 230E as shown in FIG. 2B. Alternatively, or additionally, integrator 228 can store ISUM matrix WB 232 and/or ISUM matrix A 234 (or, portions thereof) in another component of, or operatively coupled to, ISUM TCS 220, not shown in FIG. 2B, such as a memory or hardware registers of ISUM MCU 240 and/or of another computing component communicatively coupled to ISUM TCS 220 of integrator 228 (e.g., memories of a host or runtime processor, or memories of an RDU).

In FIG. 2B, ISUM MCU 240 can input elements of ISUM matrix WB 232 and ISUM matrix A 234 (e.g., elements of a row of ISUM matrix WB 232 and elements of a column of ISUM matrix A 234), multiply the elements, and output the Integrated Sums to an ISUM integrated matrix, show in FIG. 2B as ISUM results in matrix Y 236 in memory 230F.

An ISUM TCS can compute an integrated sum-product, such as a sum of products of elements of a row i of matrix WB 232 and column j of matrix A 234, using a multiply-accumulate (MACC) computation, in which an accumulator stores a cumulative sum of products of elements of matrix WB 232 row i and matrix A 234 column j. As used herein, the term “MACC sum-product” refers to a sum of integrated sum-products computed as a sequence of MACC computations, and “MACC Sum” refers to a sum of MACC sum-products computed over all elements of a row i of an ISUM integrated matrix and a column j of an ISUM multiplicand matrix. Thus, an element, yᵢⱼ, of a matrix can comprise a MACC Sum, Σwb_{i,dim} a_{dim,j}, computed over all values of dim from 1 to (K+1) for a row i of an integrated matrix [WB] and column j of an ISUM multiplicand matrix [A]. An Integrated Sum matrix of MACC Sums is equivalent to an Addend Sum matrix computed as a sum of a sum-products intermediate matrix and a matrix addend.

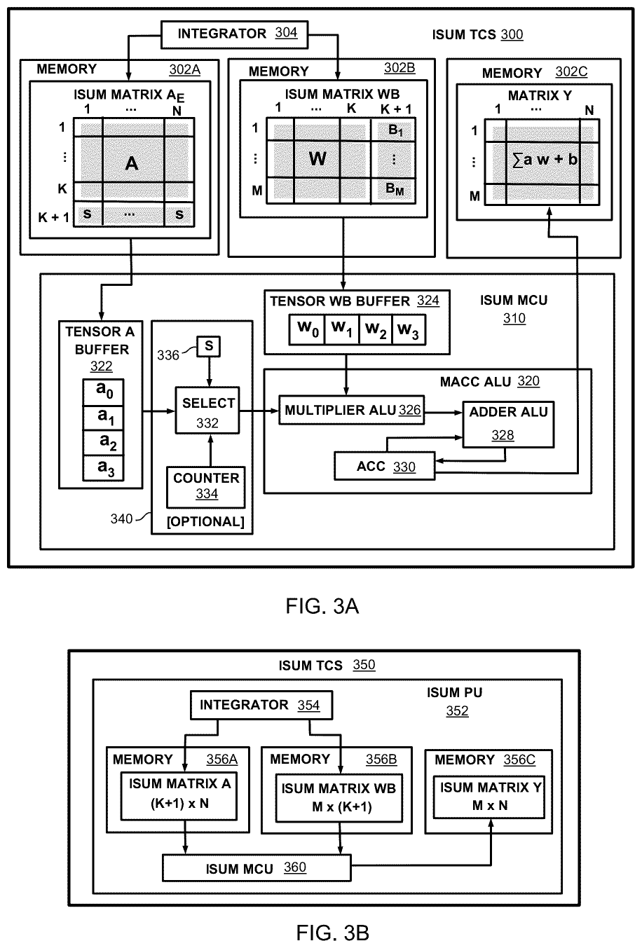

As shown by the example of TCS 220 in FIG. 2B, in implementations an ISUM TCS can include an ISUM MCU that can compute integrated sum-products and/or Integrated Sums. An ISUM MCU can perform MACC computations to compute integrated sum-products of ISUM integrated and ISUM multiplicand matrices. FIG. 3A illustrates an example implementation of an ISUM TCS comprising an ISUM MCU configured to compute integrated sum-products as MACC sum-products.

In FIG. 3A, ISUM TCS 300 is shown comprising memories 302A, 302B, and 302C (collectively, “memories 302”), integrator 304, and ISUM MCU 310. ISUM TCS 300 can comprise an ISUM TCS such as ISUM TCS 220 in FIG. 2B. While not shown in FIG. 3A, as previously described, a TCS such as ISUM TCS 300 can include processors, such as a neural network, a host processor, runtime processor, RDU and/or processors of RDUs, and/or accelerator processors (CGRAs, FPGAs, GPUs, etc.). TCS 300 can comprise ISUM programs, such as programs for generating ISUM integrated matrices and/or computing ISUM integrated sum-products and/or Integrated Sums, and the programs can execute on processors of the TCS.

Memories among memories 302 can be memories of components of a dataflow computing system, such as memories of an RDU, memories of a host and/or runtime processor, and/or memories of an ISUM TCS and/or ISUM MCU. FIG. 3A depicts memory 302A including (K+1)×N ISUM row-extended matrix [A_{E}] (hereinafter, “matrix 302A”), memory 302B including M×(K+1) ISUM integrated matrix [WB] (hereinafter, “matrix 302B”), and memory 302C containing M×N Integrated Sum matrix [Y] (hereinafter, “matrix 302C”).

Integrator 304 can be an ISUM matrix integrator, such as integrator 228 in FIG. 2B, and can generate matrix 302A from a K×N multiplicand matrix [A] and/or can generate matrix 302B from an M×K multiplicand matrix [W] and an M×1 addend matrix [B]. Matrix 302A is shown in FIG. 3A as (K+1)×N ISUM row-extended matrix having K×N multiplicand matrix A in rows 1 through K of matrix 302A and a constant row of constants, s, in row (K+1) of matrix 302A. Scalar s in matrix 302A can be scalar one or, as will be seen in other examples of the disclosure, can be another constant, such as in a computation of (Σw a+sb), where s is a constant multiplied by elements of a matrix addend, matrix [B]. Matrix 302B is shown in FIG. 3A as an M×(K+1) ISUM integrated matrix having M×K multiplicand matrix [W] in columns 1 through K of matrix 302B and an integrated addend, comprising elements B₁ through B_{M} of M×1 addend matrix [B], in column (K+1) of matrix 302B.

ISUM MCU 310 can compute, in an integrated MACC computation, an Integrated Sum matrix, shown in FIG. 3A as matrix 302C. ISUM MCU 310 can comprise, for example, one or more RDUs, one or more RPs of an RDU, and/or one or more tiles, PCUs and/or PMUs of an RP. An ISUM MCU can comprise, or be included in, a component of a neural network, such as a component of an operator and/or a neuron of a neural network. Referring again to FIG. 3B, ISUM MCU 240, of FIG. 2B, can comprise an ISUM MCU such as ISUM MCU 310.

ISUM MCU 310 is shown, in FIG. 3A, comprising tensor WB buffer 324, tensor A buffer 322, MACC ALU 320, and optional multiplier selection logic 340. FIG. 3A further depicts tensor A buffer 322 comprising four buffer elements, a₀-a₃, each of which can receive a respective element of matrix 302A from memory 302A. Similarly, tensor WB buffer 324 is shown comprising four buffer elements, w₀-w₃, each of which can receive a respective element of matrix 302B.

FIG. 3A depicts MACC ALU 320 comprising multiplier ALU 326, adder ALU 328, and ACC 330. In implementations, an ISUM MACC ALU, such as MACC ALU 320, can compute MACC sum-products of ISUM integrated and extended matrices to output an element of an matrix comprising an Integrated Sum of all K+1 products of elements of the i^{th} row of an M×(K+1) ISUM integrated matrix (e.g., matrix 302B) multiplied by corresponding elements of the j^{th} column of a (K+1)×N ISUM row-extended matrix (e.g., matrix [A_{E}] in memory 302A) or, alternatively, a K×N ISUM multiplicand matrix (e.g., a matrix in memory 302A, shown explicitly in FIG. 3A, comprising only K×N matrix [A]).

ISUM TCS 300 (or, ISUM MCU 310 of ISUM TCS 300) can perform MACC computations cyclically to compute an element of an Integrated Sum matrix. An ISUM MACC computation cycle (hereinafter, for brevity, simply “MACC cycle”) can comprise MACC computations that compute one Integrated Sum element of an Integrated Sum matrix. For example, in FIG. 3A a MACC cycle of ISUM MCU 310 can comprise one or more buffer load cycles, to load elements of matrix 302B and matrix 302A in respective buffer elements of tensor WB buffer 324 and tensor A buffer 322, and corresponding MACC computations to compute a sum-product of (Σwᵢ aᵢ) for elements 0 to 3 of tensor WB buffer 324 and tensor A buffer 322.

In a buffer load cycle, as shown in FIG. 3A ISUM MCU 310 can receive from 1 to 4 elements of matrix 302A, and/or from 1 to 4 elements of matrix 302B, and can store these in buffer elements, a₀-a₃ of tensor A buffer 322 and buffer elements w₀-w₃ of tensor WB buffer 324, respectively. Concurrent with, or following, the load cycle(s), ISUM MCU 310 can perform one or more MACC cycles over the contents of tensor A buffer 322 and tensor WB buffer 324 to compute a MACC sum-product (Σwᵢ aᵢ) of elements in each of tensor A buffer 322 and tensor WB buffer 324.

In FIG. 3A optional multiplier selection logic 340 can operate to select an input to multiplier ALU 326 from among elements of tensor A buffer 322 or a constant, shown in FIG. 3A as constant input element 336 (having constant value “s”, such as value “1”, for example). In the absence of optional multiplier selection logic 340, outputs of tensor A buffer 322 can be directly input to MACC ALU 320.

A constant input element, such as 336, can comprise, for example, a single instance of constant value s. Elements of an addend matrix can have a particular data size, such as 8 or 16 bits. A constant input element can, then, have a data size corresponding to the data size (e.g., a respective 8 or 16 bits) of elements of the addend matrix. A constant input element can comprise a scalar value stored in a location in a memory of a TCS or ISUM MCU, a register of an ISUM MCU, and/or a hard-wired input element having constant value s conforming to a data size of the elements of the addend matrix.

ACC 330 can comprise an accumulator to accumulate sums of matrix products. Prior to performing a sequence of ISUM MACC cycles, MACC ALU 320 can initialize ACC 330 to zero. In a MACC cycle ISUM MCU 310 can multiply pairs of tensor A buffer 322 and tensor WB buffer 324 elements and output the products to adder ALU 328 and adder ALU 328 can add the products to a value stored in ACC 330. Adder ALU 328 can store the sum-product result in ACC 330 to compute, in successive buffer load and MACC cycles, an Integrated Sum, yᵢⱼ, over all (K+1) elements of row i of matrix 302B and column j of matrix 302A.

As multiplier ALU 326 outputs tensor A buffer 322 and tensor WB buffer 324 element products, adder ALU 328 can add each product to ACC 330. For example, as multiplier ALU 326 generates a product of (a₀×w₀), adder 326 can add that product to the current value of ACC 330. Similarly, as multiplier ALU 328 generates a product of (a₁×w₁), adder ALU 328 can add that product to the current value of ACC 330 such that the accumulator now has the value of (a₀×w₀)+(a₁×w₁) added to a preceding value of ACC 330. Multiplier ALU 326 and adder ALU 328 can repeat MACC cycles to compute the sum product of all 4 elements of tensor A buffer 322 and tensor WB buffer 324.

Adder ALU 328 can receive each product and can serially (e.g., in each computation cycle of multiplier ALU 326) add it to a value stored in ACC 330. Alternatively, multiplier ALU 326 can compute some or all of tensor A buffer 322 times tensor WB buffer 324 products concurrently, adder ALU 328 can receive more than one product output from multiplier ALU 326 concurrently, and adder ALU 328 can add those products to the value of accumulator ACC 330. Adder ALU 328 and ACC 330 can thereby compute a sum of products output from multiplier ALU 330 over a sequence of MACC ALU 320 computation cycles. An ISUM TCS (and/or, an ISUM MCU of an ISUM TCS) can store computed MACC Sum elements in a memory. As shown in FIG. 3A, ISUM MCU 310 can store computed MACC Sum elements as elements of matrix 302C in memory 302C.

As previously described with reference to FIG. 1B, in computing an integrated sum-product, such as in a weight-bias function, to compute an Addend Sum matrix (Σa w+b) a conventional TCS first computes a sum-products matrix comprising results of all (Σa w) computations over all rows and columns of two multiplicand matrices (e.g., weight matrix [W] and activation matrix [A]). The TCS then adds the elements of the matrix addend (e.g., elements of bias matrix [B]) to each Sum-products element as a set of subsequent add cycles. In implementations, by executing K+1 MACC computations for elements of each column j of an ISUM integrated matrix multiplied by elements of each row i of an ISUM row-extended matrix, an ISUM MCU (or, an ISUM TCS) can compute an Integrated Sum matrix of input matrices (e.g., matrices W, A, and B in a weights-bias function) using only MACC computations, without requiring subsequent addition of an intermediate sum-products matrix to a matrix addend.

To illustrate in more detail, consider that in FIG. 3A dimensions K and N of matrix A in matrix 302A are both 4, dimension M in M×K matrix W, in memory 302B, is also 4, and addend matrix [B], as included in column (K+1) of matrix 302B, is an M×1 matrix. In this case, matrix 302A is then a 5×4 ISUM row-extended matrix having a constant in each column of row 5, shown in FIG. 3A, for purposes of illustration only, as a constant having value 1. Matrix 302B is correspondingly a 4×5 ISUM integrated matrix having elements B₁ to B_{M} of matrix [B] in column 5 of matrix 302B.

In a buffer load cycle, ISUM MCU 310 can load elements a₁₁, a₂₁, a₃₁, and a₄₁ of matrix 302A (e.g., the first 4 elements of column 1 of ISUM matrix [A]), from memory 302A into tensor A buffer 322, and can load elements w₁₁, w₁₂, w₁₃, and w₁₄ of matrix 302B (e.g., the first 4 elements of row 1 of ISUM matrix [A]) from memory 302B into tensor WB buffer 324. MACC compute cycles of MACC ALU 320 can then compute [a₁₁×w₁₁+a₂₁×w₁₂+a₃₁×w₁₃+a₄₁×w₁₄] for the four (i.e., “K”) elements of row 1 of matrix 302B and column 1 of matrix 302A.

In computing element K+1, element K+1 of matrix 302A column 1 comprises scalar 1, and element K+1 of matrix 302B comprises element 1 of column 1 of addend matrix [B]. Thus, the product (a₅₁×w₁₅) is computed as (1×b₁) and the sum-product of all K+1 products [a₁₁×w₁₁+a₂₁×w₁₂+a₃₁×w₁₃+a₄₁×w₁₄+a_{5,1}×w₁₅] is equivalent to [a₁₁× w₁₁+a₂₁×w₁₂+a₃₁×w₁₃+a₄₁×w₁₄+₁×b₁]. Thus, by computing K+1 products of an ISUM integrated matrix and an ISUM multiplicand matrix (in the example just described, an ISUM row-extended matrix), MACC ALU 320 can compute an Integrated Sum, equivalent to an Addend Sum, utilizing only sum-product (e.g., MACC) computations, without performing a subsequent addition of a sum-product matrix and a matrix addend.

In implementations, a multiplier ALU, such as multiplier ALU 326, and an adder ALU and accumulator, such as adder ALU 328 and ACC 330, can perform multiplication and addition computations concurrently (in parallel). For example, multiplier ALU 326 can compute a subset of tensor A buffer 322 and tensor WB buffer 324 products and output these to adder ALU 328 to add and accumulate to prior products. Concurrent with adder ALU 328 adding the output products to current values of ACC 330, multiplier ALU 326 can continue to compute additional (new) products of tensor A buffer 322 and tensor WB buffer 324 elements. Likewise, concurrent with multiplier ALU 326 computing additional (new) products of tensor A buffer 322 and tensor WB buffer 324 elements, adder ALU 328 can compute an accumulated sum of previous products received from multiplier ALU 326.

In implementations an ISUM MCU can, optionally, include multiplier selection logic, shown as selection logic 340 in FIG. 3A. As previously described, multiplier selection logic can operate to select inputs to an ISUM ALU (e.g., a multiplier ALU of an ISUM ALU, such as MACC ALU 320) from among elements of an input ISUM multiplicand matrix and a constant. FIG. 3A depicts multiplier selection logic 340 comprising select 332, constant input element 336, and counter 334. Constant input 336 can comprise, for example, a hardware input element, such as a register or hard-wired output circuit, that can input a constant (e.g., a constant, such as a constant value of 1) to select 332.

During a MACC cycle select 332 can receive outputs of tensor A buffer 322 and constant input element 336 and can output to multiplier ALU 326 either an input received from tensor A buffer 322 or constant input element 336 for multiplier ALU 326 to compute a product of the output of select 332 and an element of tensor WB buffer 324. In computing a product of an element column (K+1) of matrix 302B (elements B₁ to B_{N} of addend matrix [B]) and a constant in row (K+1) of matrix 302A, on a (K+1) MACC cycle select 332 can output constant s of constant input element 336 to multiplier ALU 326, as an alternative to outputting an element of a row (K+1) of matrix 302A. For example, prior to computing a MACC Sum of a row of matrix 302B and a column of matrix 302A, ISUM MCU 310 can set the value of counter 334 to “1”. After computing a sum-product of each element of the row of matrix 302B and column of matrix 302A, MCU 310 can increment counter 334.

For values of counter 334 from 1 to K, counter 334 can configure select 332 to output elements received from tensor A buffer 322. When the value of counter 334 reaches (K+1), the counter can configure select 332 to output the value, “s”, of constant input element 336 as a multiplicand of a (K+1) element of matrix 302B received from tensor WB buffer 324. If the value of “s” is 1, for example, the (K+1) product computation of the column (K+1) element of matrix 302B, which is an element b of addend matrix [B], is then (1×b) and the MACC Sum of that row (e.g., row i) of matrix 302B and column (e.g., column j) of matrix 302A for dim=1 to (K+1) is [w_{i,1}×a_{1,j}+w_{i,2}×a_{2,j}+ . . . +w_{i,k}×a_{k,j}+₁×w_{i,k+1}] in which w_{i,k+1} is bᵢ of addend matrix [B]. As can be seen in this example, by select 332 selecting constant input element 336 on the (K+1) MACC cycle, matrix 302A can be a K×N ISUM multiplicand matrix, omitting the (K+1) row of constants (value “s” of constant input element 336, for example).

In implementations, an ISUM MCU, such as ISUM MCU 310 in FIG. 3A, can comprise ISUM programs (or, ISUM program instructions) executable by processors of an ISUM TCS and/or processors of an ISUM MCU (both not shown in FIG. 3A). Additionally, or alternatively, a MACC ALU such as MACC ALU 320 in FIG. 3A, can comprise programs (and/or, program instructions) executable by processors of an ISUM TCS and/or ISUM MCU. A MACC ALU of an ISUM MCU, such as MACC ALU 320, can comprise ISUM programs and.ir program instructions executable by processors of an ISUM TCS and/or ISUM MCU. Processors executing the programs, and/or logic circuits, individually or in combination, can compute an ISUM integrated sum-products of ISUM integrated and ISUM multiplicand matrices. Additionally, or alternatively, an ISUM TCS and/or ISUM MCU can comprise logic circuits configured to compute MACC sum-products of ISUM integrated and ISUM multiplicand matrices.

The example of FIG. 3A illustrates MACC ALU 320 injecting a constant via multiplier selection logic 340; however, this is only to illustrate the example and not intended to limit implementations. It would be appreciated by one of ordinary skill in the art that another component of an ISUM MCU, or another component of an ISUM TCS, can inject a constant into an Integrated Sum computation, using logic, circuits, and/or combinations of logic and circuits, alternative to that of multiplier selection logic 340. Further, while FIG. 3A depicts multiplier selection logic 340 as a component of ISUM MCU 310, this is also only to illustrate the example of FIG. 3A and not intended to limit implementations. In an alternative implementation, for example, multiplier selection logic similar or equivalent to multiplier selection logic 340 can be a component of a TCS separate from and coupled to an MCU.

While not shown in FIG. 3A, in addition to, or alternative to, a MACC ALU, such as illustrated by ISUM MCU 310 in FIG. 3A, an ISUM MCU can comprise processors, programs, and/or memories. Programs of an ISUM MCU can comprise programs executable on a process of an ISUM MCU to performs operations of an ISUM integrator, to generate ISUM integrated and/or multiplicand matrices. Programs of an ISUM MCU can comprise programs to compute products of ISUM matrix elements, and/or sum-products of ISUM matrix elements, and can compute the sum-products using MACC computations. Programs of an ISUM MCU can comprise programs to program multiplier selection logic. Memories of an ISUM MCU can contain program instructions of programs of an ISUM MCU; can comprise matrix element buffers, such as tensor A buffer 322 and/or tensor WB buffer 324 in FIG. 3A; can comprise products and/or sum-products computed by the MCU; and/or can contain an accumulator to accumulate sums of products of elements of ISUM matrices.

In implementations, an ISUM TCS can comprise one or more ISUM Processing Units (ISUM PUs). ISUM PUs can comprise, for example, components for generating ISUM matrices, memories to contain ISUM matrices, and/or MCUs (or, components of ISUM MCUs, such as MACC ALUs, etc.). FIG. 3B illustrates an ISUM TCS including an example ISUM PU. In FIG. 3B, ISUM TCS 350 is shown comprising example ISUM PU 352, and ISUM PU 352 is further shown comprising memories 356A, 356B, and 356C (collectively, “memories 356”), integrator 354, and ISUM MCU 360. Memories among memories 356 can be memories of ISUM PU 352, as shown in FIG. 3B, or can be, alternatively, memories of TCS 350.

Integrator 354 can be an ISUM matrix integrator, such as the example of integrator 228 in FIG. 2B, and can generate ISUM (extended) matrix ISUM matrix [A] in memory 356A (hereinafter, “matrix 356A”), and/or ISUM (integrated) matrix [WB] in memory 356B (hereinafter, “matrix 356B”). Integrator 354 can be a component of ISUM PU 352, as shown in FIG. 3B, or can, alternatively, be a component of ISUM TCS 350 (or, of a component of ISUM TCS 350 other than ISUM PU 352). Similarly, ISUM MCU 360 can be an ISUM MCU such as the example of ISUM MCU 310 in FIG. 3A.

ISUM PU 352 (or, ISUM MCU 360 of ISUM PU 352) can compute ISUM integrated sum-products, and/or an Integrated Sum, such as (Σwb a_{E}) over matrix 356A and matrix 356B. An ISUM PU (or, an ISUM MCU of an ISUM PU) can perform K+P computation cycles to compute an Integrated Sum of a row of an M×(K+P) ISUM integrated matrix and a (K+P)×N, or K×N, ISUM multiplicand matrix.

While not shown explicitly in FIG. 3B, MCU 360, or ISUM PU 352, can include multiplier selection logic, such as multiplier selection logic 340 in FIG. 3A, to input a constant (e.g., constant “1”) into a multiplier ALU of the MCU(s) in computing a K+1 product of an element of a column of matrix 356A and a corresponding element of a row of matrix 356B. MCU 360, or ISUM PU 352, can include a counter, such as counter 334 of multiplier selection logic 340 in FIG. 3A, to count sum-product computations (or, computation cycles) and to indicate a K+1 computation of a product of matrix 356A and matrix 356B. Alternatively, multiplier selection logic of MCU 360, or of ISUM PU 352, can omit a counter, such as 334 and can, instead, receive an output of a counter of TCS 350 to indicate a K+1 computation of a product of matrix 356A and matrix 356B.

Also while not shown explicitly in FIG. 3B, as previously described, a TCS such as ISUM TCS 350, and/or an ISUM PU, such as 352, can include processors, such as a neural network, a host processor, runtime processor, RDU and/or processors of RDUs, and/or accelerator processors (CGRAs, FPGAs, GPUs, etc.). TCS 350 and/or ISUM PU 352 can comprise ISUM programs, such as programs for generating ISUM integrated matrices and/or computing ISUM integrated sum-products and/or Integrated Sums, and the programs can execute on processors of the TCS. Additionally, in implementations a matrix addend need not be limited to a matrix of constants, such as a bias matrix, but can comprise, for example, a matrix of outputs of other tensor computations, such as outputs of other operators, or of neurons of other operators.

While not shown in FIG. 3B, in addition to, or alternative to, MCUs, such as illustrated by ISUM MCU 360 in FIG. 3B, an ISUM PU can comprise processors, programs, and/or memories. Additionally, or alternatively, an ISUM PU can comprise logic circuits configured to compute products and/or sum-products of ISUM integrated and ISUM multiplicand matrices. Processors executing the programs, and/or logic circuits, individually or in combination, can compute an ISUM integrated sum-products of ISUM integrated and ISUM multiplicand matrices, such as by using MACC computations of the ISUM matrices.

Programs of an ISUM PU can comprise programs executable on a process of an ISUM PU (and/or an ISUM MCU of an ISUM PU) to performs operations of an ISUM integrator, to generate ISUM integrated and/or multiplicand matrices. Programs of an ISUM PU can comprise programs to compute products of ISUM matrix elements, and/or sum-products of ISUM matrix elements, and can compute the sum-products using MACC computations. Programs of an ISUM PU can comprise programs to program multiplier selection logic. Memories of an ISUM PU can contain program instructions of programs of an ISUM PU; can comprise matrix element buffers, such as tensor A buffer 322 and/or tensor WB buffer 324 in FIG. 3A; can comprise products and/or sum-products computed by the ISUM PU; and/or can contain an accumulator to accumulate sums of products of elements of ISUM matrices.

While FIGS. 3A and 3B illustrate examples of a single ISUM PU, comprising a single ISUM MCU, computing an integrated sum-product, this is not intended to limit implementations. In alternative implementations an ISUM TCS can comprise a plurality of ISUM PUs and/or ISUM MCUs, an ISUM PU can comprise a plurality of ISUM MCUs, and/or an ISUM MCU can comprise a plurality of ISUM ALUs (e.g., ISUM MACC ALUs, multiplier ALUs, and/or adder ALUs). Each of the ISUM PUs, MCUs, and/or ALUs can operate on (e.g., in parallel) on a portion of ISUM matrices. An accumulator of an ISUM PU, MCU, or ALU can accumulate product outputs of multiple ISUM ALUs to generate Integrated sum-products of ISUM multiplicand matrices. The plurality of ISUM PUs, MCUs, and/or ALUs can operate on in parallel on respective portions of ISUM matrices.

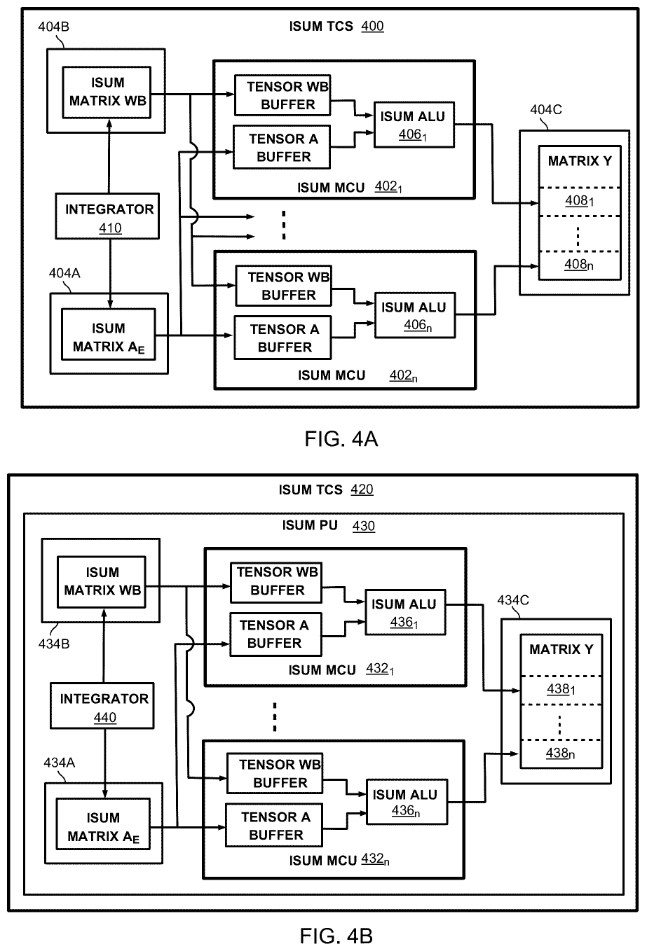

FIG. 4A illustrates an example ISUM TCS comprising a plurality of ISUM MCUs that can collectively compute an Integrated Sum matrix of ISUM matrices. In FIG. 4A. ISUM TCS 400 is shown comprising “n” number of ISUM MCUs, ISUM MCU 402₁ through ISUM MCU 402. (with ISUM MCUs 402₂ through 402ₙ₋₁ not shown explicitly in FIG. 4A). In implementations, ISUM MCUs 402₁ through ISUM MCU 402. (collectively, “MCUs 402”) can be ISUM MCUs similar or equivalent to ISUM MCU 310 of FIG. 3A. MCUs among MCUs 402 can include ISUM ALUs, shown in FIG. 4A as ISUM ALUs 406₁ through 406ₙ of respective ISUM MCUs 402₁ through 402ₙ, such as MACC ALU 320 of FIG. 3A or ALU components thereof.

ISUM TCS 400 is further shown comprising integrator 410 and memories 404A, 404B, and 404C (collectively, “memories 404”). FIG. 4B depicts memory 404B containing ISUM matrix [WB] (hereinafter, “matrix 404B”) and memory 404A containing ISUM multiplicand matrix [A_{E}] (hereinafter, “matrix 404A”). Matrix 404B can be an ISUM integrated matrix, such as matrix 302B of FIG. 3A, and matrix 404A can be an ISUM multiplicand matrix, such as matrix 302A of FIG. 3A, which can comprise a (K+1)N ISUM row-extended matrix or, alternatively, can comprise a K×N ISUM multiplicand matrix. In implementations, integrator 410 can be an ISUM matrix integrator similar or equivalent to integrator 228 in FIG. 2B, for example, and can generate matrix 404A as an ISUM integrated matrix and/or matrix 404B as an ISUM multiplicand matrix. Memory 404C is shown containing Integrated Sum matrix [Y](hereinafter, “matrix 402C”), which can be a matrix of sum-products output from MCUs 402 as a result of MCUs 402 computing sum-products of ISUM matrices 402A and 402B.

In FIG. 4A, each of MCUs 402 can receive a subset (e.g., a 1/n subset; although, not necessarily limited to equal subsets among all of MCUs 402) of the elements of matrix 404B, and a corresponding subset of elements of matrix 404A, and can compute integrated sum-products (e.g., MACC sum-products and/or MACC Sums) of these elements in a manner such as previously described with respect to the example of FIG. 3A. In one example, MCUs among MCUs 402 can compute Integrated sum-products and/or Integrated Sums of a single row, or of a set of particular rows, of matrix 404B. The number, “n”, of MCUs among MCUs 402 can be equal to the number of rows, M, of matrix 404B, for example, and each of MCUs 402 can compute Integrated Sums of one particular row of matrix 404B.

In another example, the number, “n”, of MCUs among MCUs 402 can be larger than the number of rows, M, of matrix 404B. A TCS can comprise many thousands of MCUs (e.g., in the example of Grohoski and Kumar, an RDS can comprise many thousands of PCUs and/or PMUs) such that the number, “n”, of MCUs 402 can be many thousands and MCUs among MCUs 402 can compute a subset of products, and/or sum-products, of matrices 404B and 404A and can thereby greatly increase parallel computations of Integrated Sums of matrices 404B and 404A.

Based on respective subset elements received from matrices 404A and 404B, each of MCUs 402 can compute a corresponding subset, shown in FIG. 4A as subsets 408₁ through 408ₙ, of the sum-products of matrix 402C. The individual ISUM MCUs among MCUs 402 can compute respective sum-products among sum-products of subsets 408₁ through 408ₙ, and/or can output (e.g., as outputs of respective ISUM ALUs 406₁ to 406ₙ) individual sum-products to subsets 408₁ through 408ₙ, in any combination and/or sequence.

MCUs among MCUs 402 can include multiplier selection logic (not shown explicitly in FIG. 4A) such as multiplier selection logic 340 in FIG. 3A. In computing a K+1 product of an element of a row of matrix 404B and an element of a column of matrix 404A, multiplier selection logic among MCUs 402 can input a constant (e.g., constant 1) into a multiplier ALU of the MCU(s). ISUM TCS 400 can include a counter (also not shown in FIG. 4A), such as counter 334 of multiplier selection logic 340 in FIG. 3A, to count product computations of elements of a row of matrix 404B and corresponding elements of a column of matrix 404B. The counter can cause a n MCU among MCUs 402 to compute a product of matrix 404B and 404A for K elements of a row of matrix 404B and column of matrix 404A and, on a (K+1) product computation, to compute a product of the constant and element (K+1) of the row of matrix 404B.

ISUM TCS 400, and/or ISUM MCUs among MCUs 402, can include processors, such as a neural network, a host processor, runtime processor, RDU and/or processors of RDUs, and/or accelerator processors (CGRAs, FPGAs, GPUs, etc.). TCS 400 and/or ISUM MCUs among MCUs 402 can comprise ISUM programs, such as programs for generating ISUM integrated matrices and/or computing ISUM integrated sum-products and/or Integrated Sums, and the programs can execute on processors of the TCS and/or MCUs.

As previously described, an ISUM TCS can comprise a ISUM PU. FIG. 4B illustrates another example of an ISUM TCS in which the ICS includes an ISUM PU. In FIG. 4B, ISUM TCS 420 is shown comprising example ISUM PU 430, and ISUM PU 430 is shown comprising integrator 440, memories 434A, 434B, and 434C (collectively, “memories 434”), and “n” number of ISUM MCUs, 432ᵢ to 432ₙ (collectively, “MCUs 432”). Integrator 440 can be an ISUM matrix integrator, such as the example of integrator 228 in FIG. 2B. While shown as a component of ISUM PU 430, integrator 440 can be a component of TCS 420 in addition to, or alternative to, a component of ISUM PU 430. While FIG. 4B depicts MCUs 432 as included in a single ISUM PU (430), this is only to illustrate the example and not intended to limit implementations. In alternative implementations, MCUs among MCUs 432 can be included in a plurality of ISUM PUs.

Integrator 440 can be a component of ISUM PU 430, as shown in FIG. 4B, or can, alternatively, be a component of ISUM TCS 420. Memories among memories 434 can be memories of ISUM PU 430, as shown in FIG. 4B, or can be, alternatively, memories of TCS 420. Integrator 440 can generate ISUM multiplicand matrix [A_{E}] in memory 434A (hereinafter, “matrix 434A”), and/or ISUM integrated matrix [WB] (hereinafter, “matrix 434B”) in memory 434B. Matrix 434A can be an ISUM multiplicand matrix similar to matrix 404A of FIG. 4A, and matrix 434B can be an ISUM integrated matrix similar to matrix 404B in FIG. 4A.

In FIG. 4B MCUs among MCUs 432 can be similar to the example of MCUs 402 in in FIG. 4A. FIG. 4B further depicts MCUs 432₁ through 432ₙ including respective ISUM ALUs 436₁ through 436ₙ of ISUM MCUs, which can be ISUM ALUs such as the example of MACC ALU 320, in FIG. 3A. While not shown in FIG. 4B, ISUM TCS 420 can include processors, such as a neural network, a host processor, runtime processor, RDU and/or processors of RDUs, and/or accelerator processors (CGRAs, FPGAs, GPUs, etc.). TCS 420 can comprise ISUM programs, such as programs for generating ISUM integrated matrices and/or computing ISUM integrated sum-products and/or Integrated Sums, and the programs can execute on processors of TCS 420.

Similar to the example of FIG. 4A, in FIG. 4B each of MCUs 432 can receive a subset (e.g., a 1/n subset) of the elements of matrix 404B and a corresponding subset of elements of matrix 404A and can compute integrated sum-products (e.g., MACC sum-products and/or MACC Sums) of these elements in a manner such as previously described with respect to the example of FIGS. 3A and 4A. Each of MCUs 432 can compute a subset of the sum-products of matrix Y, shown in FIG. 4B as sum-products 438₁ through 438ₙ of matrix [Y] in memory 434C. The individual ISUM MCUs among MCUs 432 can compute respective subset integrated sum-products among sum-products 438₁ through 438ₙ, and/or can output (e.g., as outputs of respective ISUM ALUs 436₁ to 436ₙ) individual sum-products, among sum-products 438₁ through 438ₙ, in any combination and/or sequence.

Also similar to the example of FIG. 4A, ISUM PU 430, and/or MCUs among MCUs 432, can include multiplier selection logic, such as multiplier selection logic 340 in FIG. 3A, to input a constant into a multiplier ALU of the MCU(s) in computing a K+1 product of an element of a row of matrix 434B and an element of a column of matrix 434A. In FIG. 4B, ISUM PU 430/MCUs 432 can include a counter (not shown explicitly in FIG. 4B), such as counter 334 of multiplier selection logic 340 in FIG. 3A, to count product computations of a row of matrix 434B and column of matrix 434A. The counter can cause a n MCU among MCUs 432 to compute a product of matrix 434B and 434A for K elements of a row of matrix 434B and column of matrix 434A and, on a (K+1) product computation, to compute a product of the constant and element (K+1) of the row of matrix 434B.

As previously described with respect to FIGS. 3A and 3B, FIGS. 4A and 4B illustrate examples of a single ISUM PU and a plurality of ISUM MCUs computing respective portions of an Integrated Sum, this is also not intended to limit implementations. It would be understood by one of ordinary skill in the art that, in alternative implementations, an ISUM TCS can comprise a plurality of ISUM PUs, such as the examples of FIGS. 4A and 4B, and the ISUM PUs can comprise one or more ISUM MCUs. The ISUM PUs and/or MCUs can operate on (e.g., in parallel) on individual portions of ISUM matrices.

For example, in one implementation an ISUM TCS can utilize K number of ISUM MCUs in which each ISUM MCU computes a sum-product of one row of an ISUM integrated matrix and one column of an ISUM multiplicand matrix, and one of the ISUM MCUs computes an Integrated sum of the sum-products of all of the ISUM MCUs over the row of the ISUM integrated matrix and column of the ISUM multiplicand matrix. In another example, an ISUM MCU can utilize K number of ISUM ALUs in which each ISUM ALU computes a sum-product of one row of an ISUM integrated matrix and one column of an ISUM multiplicand matrix, and one of the ISUM ALUs computes an Integrated sum of the sum-products of all of the ISUM ALUs over the row of the ISUM integrated matrix and column of the ISUM multiplicand matrix. It would be appreciated by one of ordinary skill in the art that an ISUM TCS can employ any combination of individual ISUM PUs, ISUM MCUs, and/or ISUM ALUs to compute any individual product and/or subset of sum-products of ISUM matrices.

As described in reference to TCS 400, in FIG. 4A, ISUM PUs/MCUs among a plurality of ISUM PUs/MCUs of an ISUM TCS can compute Integrated sum-products and/or Integrated Sums of a single row, or of a set of particular rows, of an ISUM integrated matrix, such as matrix 434B in FIG. 4B. The number of ISUM PUs/MCUs of the TCS can be much larger than the number of rows, M, of an ISUM integrated matrix, such as 434B. The number of ISUM PUs/MCUs of the TCS can be many thousands and the ISUM PUs/MCUs can each compute a subset of products, and/or sum-products, of matrices such as 434B and 434A and can thereby greatly increase parallel computations of Integrated Sums of such matrices.

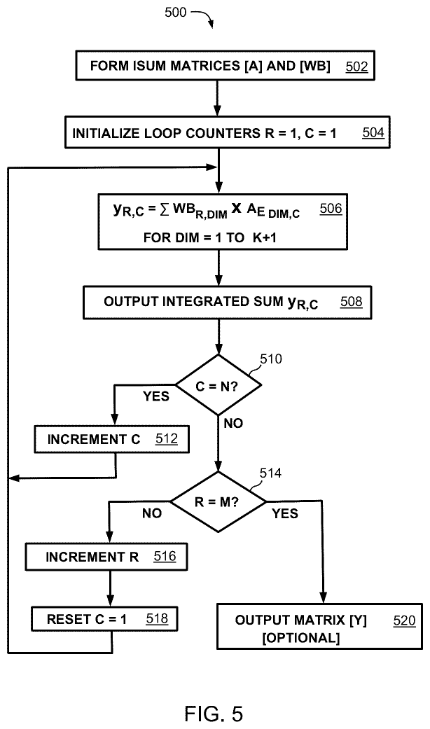

FIGS. 5, 6, and 7A illustrate methods for performing integrated summation of multiplicand and addend matrices (or, alternatively, a product of an addend matrix and a constant, or a matrix of products of two or more addend matrices). For purposes of illustrating the methods, but not intended to limit implementations, the methods are described as performed by an ISUM TCS (hereinafter, in reference to methods 5, 6, and 7A, “the TCS”), similar or equivalent example ISUM TCS 220, ISUM TCS 300, and ISUM TCS 400 in respective FIGS. 2B-4B. Thus, in reference to FIGS. 5, 6, and 7A, “the TCS”, is understood to be an ISUM TCS according to aspects of the broader disclosure. In implementations, processors, programs, ISUM PUs, and/or ISUM MCUs of the TCS can perform methods, and/or operations of methods, such as the example methods of FIGS. 5, 6, and 7A.

FIG. 5 illustrates example method 500 for the TCS to compute an Integrated Sum matrix utilizing only sum-product (e.g., MACC Sum) computations over ISUM integrated and ISUM multiplicand matrices, such as illustrated by the example of ISUM matrix 122 and ISUM matrix 124 in FIG. 1C. For only purposes of illustrating the method, but not intended to limit implementations, the method is described as the TCS computing a weights-bias function of an input K×N multiplicand matrix, [A] (e.g., a K×N activation matrix), input M×K multiplicand matrix, [W] (e.g., an M×K weights matrix), and an M×1 input addend matrix, [B] (e.g., a M×1 bias matrix), to compute an M×N Integrated Sum matrix, [Y]. Also, for only purpose of illustrating the method, the method is described as computing an Integrated Sum of elements (K+1) of an ISUM integrated multiplicand matrix, ISUM matrix [WB] with reference to method 500, and elements (K+1) of an ISUM extended multiplicand matrix, ISUM matrix [A_{E}] with reference to method 500, using constant “1” to form row (K+1) of ISUM matrix [A_{E}].

In operation 502 of method 500, the TCS receives, or otherwise accesses, input matrices [A], [W], and [B] and generates ISUM matrix [A_{E}] as a (K+1)×N ISUM row-extended matrix, having rows 1-K of input matrix [A] in rows 1-K of ISUM matrix [A_{E}] and a constant row having constant s in row (K+1) of ISUM matrix [A_{E}]. In operation 502, the TCS can, additionally or alternatively, generate ISUM matrix [WB] as an M×(K+1) ISUM integrated matrix, having columns 1-K of input matrix [W] in columns 1-K of ISUM matrix [WB] and M×1 addend matrix [B], as an integrated addend, in column K+1 of ISUM matrix [WB].

In implementations, the TCS can include an integrator, such as integrator 228 in FIG. 2, to generate ISUM matrices [A_{E}] and [WB]. Alternatively, the TCS can, in operation 502, receive ISUM matrix [A_{E}] and/or [WB] already generated (e.g., by another component of an RDS that includes, or is communicatively coupled to, the TCS). In operation 502 the TCS can generate, or can receive, ISUM matrices [A_{E}] and/or [WB] in a memory, or can receive ISUM matrices [A_{E}] and/or [WB] via a communications interface.

In operation 504 the TCS initializes loop counters R and C, which can be counters corresponding to respective rows and columns of ISUM matrices [WB] and [A_{E}] in computing sum-products of ISUM matrices [WB] and [A_{E}]. Counter R can correspond, for example, to a row index of ISUM matrix [WB] and C can correspond, for example, to a column index of ISUM matrix [A_{E}].

In operation 506, for a particular value of R and C, the TCS (e.g., an ISUM MCU of the TCS) computes an Integrated Sum (y_{R,C}=Σwb_{R,DIM} a_{E DIM, C}) for a particular row R of ISUM matrix [WB] and column C of ISUM matrix [A_{E}]. In operation 506 the TCS can utilize a counter, dim, to count products of [wb_{R,DIM}×a_{DIM, C}], for values of dim from 1 to (K+1), to compute and sum (K+1) products of elements of row R of ISUM matrix [WB] and column C of ISUM matrix [A_{E}]. Thus, in operation 506 the TCS computes, y_{R,C} over all (K+1) elements of row R of ISUM matrix [WB] and column C of ISUM matrix [A_{E}] utilizing only sum-product computations (e.g., MACC computations). In operation 506 the TCS can compute (Σwb_{R,DIM} a_{E DIM,C}) utilizing an ISUM MCU, such as example ISUM MCU 310 in FIG. 3A or MCUs 402 in FIG. 4A, and the MCU can accumulate, in an accumulator similar or equivalent to ACC 330 of FIG. 3A, an Integrated Sum (Σwb_{R,DIM} a_{E DIM,C}) for row R of ISUM matrix [WB] and column C of ISUM matrix [A_{E}].

In operation 508 the TCS outputs the Integrated Sum y_{R,C} computed in operation 506. In operation 508 the TCS can output y_{R,C} to, for example, an Integrated Sum matrix stored in a memory, such as matrix [Y] in memory 302C of FIG. 3A. Additionally, or alternatively, the TCS can output y_{R,C} to one or more hardware elements of the TCS, such as registers or memories of an ISUM PU and/or ISUM MCU of the TCS, and/or can output y_{R,C} to a system communicatively coupled to the TCS. For example, in operation 508 the TCS can output y_{R,C} to one or ISUM PUs and/or ISUM MCUs, or memories of one or more ISUM PU and/or ISUM MCU of the TCS to perform back propagation computations, such as in a gradient descent computation, utilizing an Integrated Sum (or, alternatively, a partial sum-product of an Integrated Sum) computed in operation 506.

In operation 510 the TCS determines if loop counter C equals the value of N, corresponding to column dimension N of ISUM matrix [A_{E}] and indicating operation 506 has computed an Integrated Sums y_{R,C} for all columns of ISUM matrix [A] multiplied by all (K+1) elements of column R of ISUM matrix [WB]. If C does not equal N, in operation 512 the TCS increments C and repeats operations 506-512 until these operations have iterated over all N columns of ISUM matrix [A_{E}].

If, in operation 510, the TCS determines that C has incremented to value N, in operation 514 the TCS determines if R has reached a value of M, corresponding to dimension M of ISUM matrix [WB] and indicating that operation 506 has computed an Integrated Sum, y_{R,C}, for all M rows of ISUM matrix [WB] multiplied by all (K+1) elements of all N columns of ISUM matrix [A_{E}]. If C does not equal M, in operation 516 the TCS increments R and, in operation 518 the TCS resets counter C to 1 (to compute an Integrated Sum for the next row of ISUM matrix [WB] and all N columns of ISUM matrix [A_{E}]. The TCS repeats operations 506-518 until these operations have iterated over all M rows of ISUM matrix [WB] computed with all N columns ISUM matrix [A_{E}] to compute a complete M×N Integrated Sum matrix [Y].

Alternatively, if in operation 514 the TCS determines that C has reached a value of M, in operation 520 the TCS can, optionally, output a complete Integrated Sum matrix computed over all M rows of ISUM matrix [WB] and all N columns of ISUM matrix [A_{E}]. For example, if the TCS output Integrated Sums y_{R},C to an Integrated Sum matrix [Y] in a memory, in operation 520 the TCS can output Integrated Sum matrix, [Y], and/or sum-products included in Integrated Sum matrix [Y], to one or more alternative memories (e.g., memories other than the memory used, in operation 508, to store Integrated Sums y_{R,C}), and/or to one or more ISUM PUs and/or ISUM MCUs of the TCS for the TCS to perform back propagation computations, such as in a gradient descent computation, utilizing an Integrated Sum (or, alternatively, a partial sum-product of an Integrated Sum) computed in operation 506.

Method 500 illustrates an example of ISUM Integrated Sum computations using an ISUM row-extended matrix (ISUM matrix [A_{E}] in the example of method 500) having a row of constants, S, such as scalar 1 or other constants. However, as illustrated with the example of optional multiplier selection logic 340 and the example of ISUM MCU 310 in FIG. 3A, an ISUM TCS can include multiplier selection logic that can select elements of an ISUM row-extended matrix or, alternatively, can select an alternative constant (e.g., constant S as illustrated in multiplier selection logic 340 of FIG. 3A) as a (K+1) input to an ISUM ALU (e.g., an input to a multiplier ALU of an ISUM ALU).

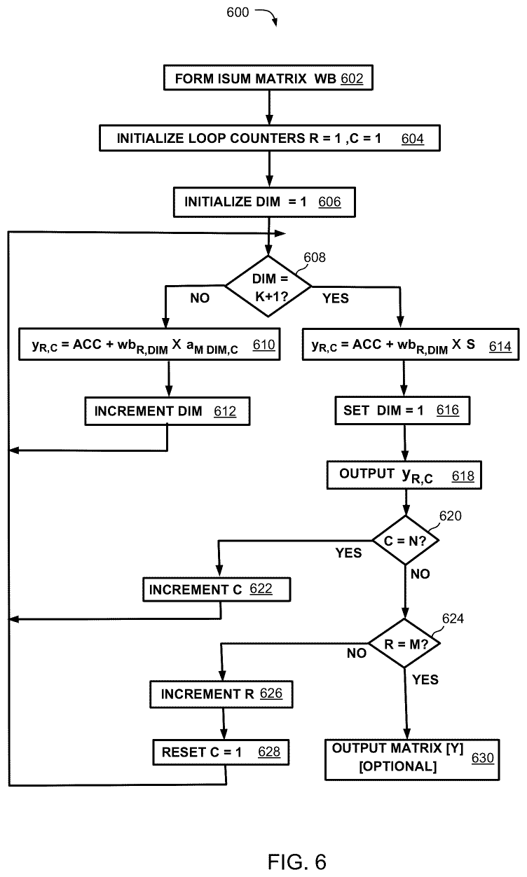

FIG. 6 illustrates example method 600 to compute an Integrated Sum utilizing multiplier selection logic to input constants in lieu of elements of a row of constants of an ISUM row-extended matrix. As will be seen in the description of method 600 to follow, method 600 is similar to method 500 of FIG. 5, except in regard to operations 602 and 608-612, which utilize a constant as a (K+1) multiplicand to multiply with a (K+1) multiplicand element of a row of an ISUM integrated matrix in computing an Integrated Sum of a row of the ISUM integrated matrix.

Similar to the description of method 500 in FIG. 5, for purposes of illustrating method 600, but not intended to limit implementations, the method is described as computing an M×N Integrated Sum matrix, [Y], comprising sum-products of a K×N input multiplicand matrix [A], an M×K input multiplicand matrix [W], added to an Mxl addend matrix [B].

As in operation 502 of method 500, in operation 602 of method 600 the TCS can generate an M×(K+1) ISUM matrix [WB] that integrates multiplicand matrix [W], in columns 1-K and row 1 through M of ISUM matrix [WB], and addend matrix [B], as an integrated addend, in column K+1 of ISUM matrix [WB]. The TCS can then compute an Integrated Sum of matrix [WB] and an ISUM multiplicand matrix [A_{M}] comprising input matrix [A]. In operation 602 the TCS can, optionally, generate matrix [A_{M}] as a (K+1)×N ISUM integrated matrix, with a (K+1) row of constants.

However, as illustrated in the example of ISUM MCU 310 in FIG. 3A, an ISUM MCU (and/or, an ISUM PU) can include multiplier selection logic such as multiplier selection logic 340 in FIG. 3A. In computing a (K+1) product of ISUM matrix [WB] and ISUM matrix [A_{M}], in lieu of a scalar element of row (K+1) of an ISUM row-extended matrix, the multiplier selection logic can input a constant to an ISUM ALU (e.g., a multiplier ALU of an ISUM ALU) of the TCS. Thus, in operation 602 the TCS need not necessarily generate matrix [A_{M}] as an ISUM row-extended matrix, and can instead generate matrix [A_{M}] comprising only matrix [A] or, alternatively, can multiply ISUM matrix [WB] by input multiplicand matrix [A] alone, without necessarily generating an ISUM multiplicand matrix of matrix [A].

In operation 602 of method 600, the MCU receives, or otherwise accesses, input multiplicand matrices [A] and [W], and input addend matrix [B], to generate ISUM matrix [WB] and (optionally) ISUM matrix [A_{M}]. The TCS can include an integrator, such as integrator 228 in FIG. 2, to generate ISUM matrix [WB] and/or [A_{M}] in operation 602. Alternatively, the TCS can, in operation 602, receive ISUM matrix [WB] and/or [A_{M}] already generated (e.g., by another component of an RDS that includes, or is communicatively coupled to, the TCS). In operation 602 the TCS can generate, or can receive, ISUM matrix [WB] and/or [A_{M}] in a memory, or via a communications interface.

Similar to operation 504 of method 500, in operation 604 the TCS initializes loop counters R and C, which can correspond, respectively, to a row R of ISUM matrix [WB] and a column C of matrix [A_{M}] in computing an Integrated Sum of ISUM matrix [WB] and matrix [A_{M}].

In operation 606 of method 600, the TCS initializes a counter, DIM, to count sum-product computations within column R of matrix [A_{M}] and row C of ISUM matrix [WB]. Counter DIM can serve to select elements of matrix [A_{M}] and ISUM matrix [WB] to compute sum-product y_{R,C}=[Σwb_{R,DIM} a_{M DIM, C}] for row R and column C for all (K+1) elements of a row, R, of ISUM matrix [WB]. The TCS (or, a ISUM PU or MCU of the TCS), can include multiplier selection logic, such as multiplier selection logic 340 in FIG. 3A and counter DIM can be, for example, a counter of the multiplier selection logic.

In operation 608, the TCS (e.g., a ISUM PU or MCU of the TCS) determines if DIM has reached a value of K+1, indicating that the TCS has computed a sum-product of all K elements of row R of matrix [WB] and all K elements of column C of matrix [A_{M}]. If not, in operation 610 the TCS computes a current value of y_{R,C} as the product (wb_{R,DIM}×a_{DIM, C}) of elements DIM of the row R and column C of respective matrices [WB] and [A_{M}] added to an accumulated sum (e.g., a value of an accumulator, such as ACC 330 of FIG. 3A) of products of elements of the row R and column C of respective matrices [WB] and [A_{M}] for values of DIM less than (K+1). In operation 608 (or, alternatively, operation 610), multiplier selection logic of the TCS can, for example, set an input gate, such as input select 332 in FIG. 3A, to pass elements of matrix [A_{M}], as a multiplicand of wb_{R,K+1}, into a multiplier ALU of the ISUM TCS, such into multiplier ALU 326 in FIG. 3A

If the TCS determines in operation 608 that DIM has reached a value of K+1, in operation 614 the TCS computes the product (wb_{R},K+1×s), where “s” is a constant multiplied by column element (K+1) of row R, which in matrix [WB] is element b_{R} of addend matrix [B]. In operation 608 (or, alternatively, operation 614) multiplier selection logic of the TCS can, for example, set an input gate, such as input select 332 in FIG. 3A, to select constant “s” as a multiplicand of wb_{R,K+1} to pass scalar “s” into a multiplier ALU of the ISUM TCS as a multiplicand of wb_{R,K+1}.

In operation 616 the TCS resets the value of DIM to 1 and, in operation 618, the TCS outputs the Integrated Sum y_{R,C} computed in operations 606-614. In operation 618 the TCS can output Integrated Sum y_{R,C} to, for example, an Integrated Sum matrix [Y] stored in a memory, such as matrix [Y] in memory 302C of FIG. 3A. Additionally, or alternatively, the TCS can output Integrated Sum y_{R,C} (and/or, partial sum-products of Integrated Sum y_{R,C}) to one or more hardware elements, such as registers or memories of another component of the TCS (e.g., an ISUM PU and/or ISUM MCU of the TCS), and/or to a system communicatively coupled to the TCS. In operation 618, The TCS can, output Integrated Sum y_{R,C} (and/or, partial sum-products of Integrated Sum y_{R,C}) to one or more ISUM PUs and/or ISUM MCUs, such as to perform back propagation in a gradient descent computation utilizing Integrated Sum y_{R,C} or, partial sum-products of Integrated Sum y_{R,C}, computed in operations 608-616.

In operations 620 and 622 the TCS can increment counter C and, in operations 624-628, can increment loop counter R and reset counter C to 1 (to compute sum-products with the next column of matrix [A_{M}]) to repeat operations 608-626 over all M rows of matrix [WB] and all N columns of matrix [A_{M}].

Upon determining, in operation 624, that counter C has reached a value of M, similar to operation 520 of method 500 in operation 624 the TCS can determine that the TCS has computed all Integrated Sums to generate an M×N Integrated Sum matrix [Y] and, in operation 630, the TCS can output Integrated Sum matrix [Y]. In operation 624 the TCS can output Integrated Sum matrix [Y] to, for example, one or more memories (e.g., memories other than a memory used, in operation 618, to store a sum-product computed in operations 608-614), and/or to ISUM PUs and/or MCUs of the TCS, to perform back propagation of Integrated Sum matrix [Y] elements, such as in a gradient descent computation utilizing sum-products included in Integrated Sum matrix [Y].

FIGS. 4A and 4B illustrate example implementations of an ISUM TCS utilizing multiple ISUM MCUs (and/or ISUM PUs) to compute portions of an Integrated Sum matrix over portions of ISUM matrices [A_{E}] and [WB]. These examples illustrate that a plurality of ISUM PUs and/or ISUM MCUs can operate on subsets of ISUM matrices to compute respective elements of an Integrated Sum matrix. However, in an alternative method of computing an Integrated Sum matrix, multiple ISUM PUs/MCUs can compute subsets of the sum-products, Σwb a_{M}, of respective ISUM integrated and multiplicand matrices [WB] and [A_{M}], and one of the ISUM PUs/MCUs can compute a sum of the subset sum-products.

For example, in performing a method such as method 500 of FIG. 5, each MCU of a number, “n”, of MCUs can compute sum-products (e.g., MACC Sums) for a subset of elements (e.g., a K/n subset) of a given row and column of respective ISUM integrated and multiplicand matrices [WB] and [A_{M}]. One of the MCUs can also compute a sum-product that includes the product of the (K+1) elements of row R of matrix [WB] and column C of matrix [A_{M}]. That MCU or, alternatively, another, of the MCUs, can add the subset sum-products together to compute an Integrated Sum of row R of matrix [WB] and column C of matrix [A_{M}]. Similarly, in performing a method such as method 500 of FIG. 5, each of the n MCUs can compute Integrated Sums for a subset of the rows and/or columns (such as M/n rows, and/or N/n columns) of ISUM matrices [WB] and [A_{M}].

In another example, in performing a method such as method 600 of FIG. 6, a first MCU can compute sum-products for elements 1 to K/2 of a row R and column C of respective ISUM matrices [WB] and [A_{M}]. A second MCU can compute, for example, sum-products for elements (K/2+1) to K of a row R and column C of respective ISUM matrices [WB] and [A_{M}]. One of the first and second MCUs or, alternatively, a third MCU, can compute (wb_{K+1}×s) for the K+1 element of matrix [WB] row R. One of the n MCUs can add the partial sum-products and the (K+1) product to compute a complete Integrated Sum of elements 1 to K+1 of row R and column C of respective ISUM [WB] and [A_{M}]. Similarly, in performing a method such as method 600 of FIG. 6, each of the n MCUs can compute sum-products for a subset of the rows and/or columns (such as N/n rows, and/or M/n columns) of ISUM [WB] and [A_{M}].

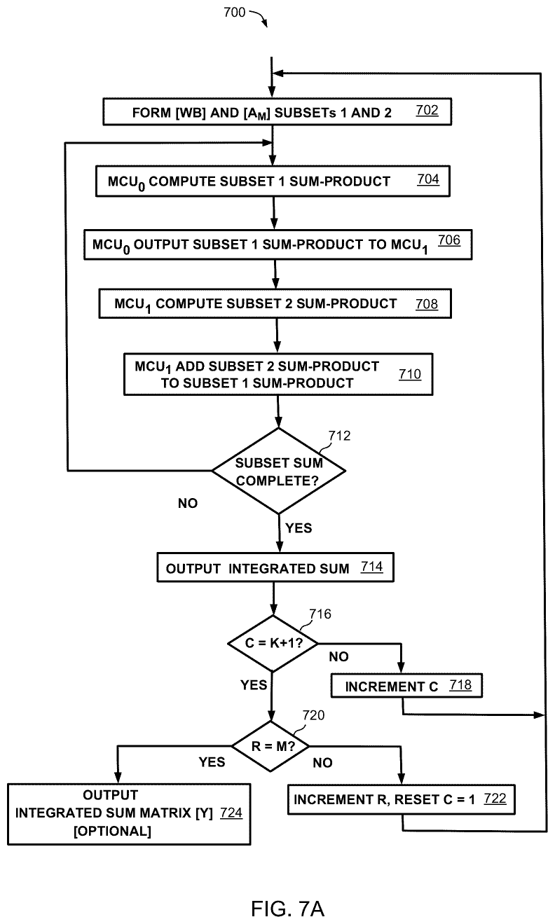

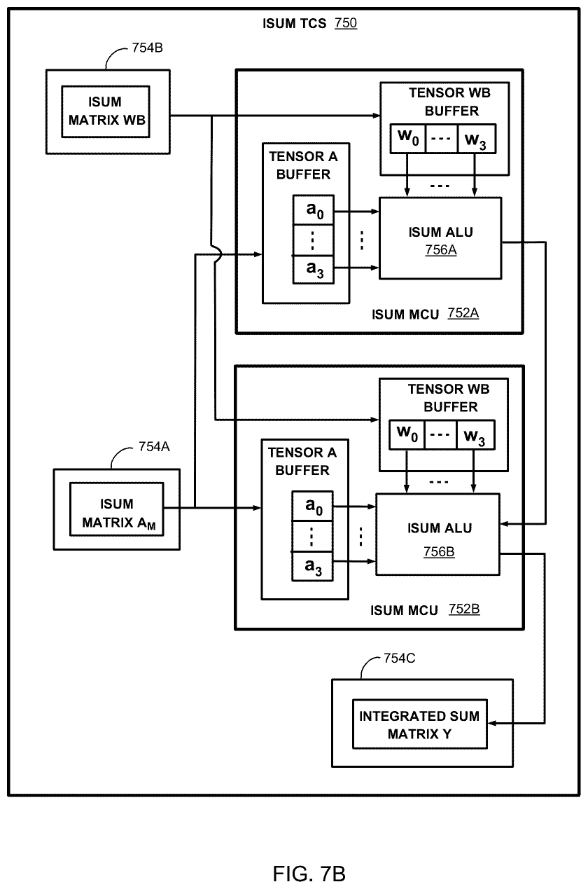

FIG. 7A illustrates an example method utilizing two MCUs to compute Integrated Sums over subsets of elements of an ISUM integrated matrix [WB] and an ISUM multiplicand matrix [A_{M}]. For only purposes of illustrating the method, but not intended to limit implementations, the method is described as computing Integrated Sums of an M×(K+1) ISUM integrated matrix [WB], generated from an input M×K multiplicand matrix [W] and an M×1 input addend matrix [B], and a (K+1)×N (or, alternatively, K×N) ISUM multiplicand matrix, [A_{M}], generated from a K×N input multiplicand matrix [A]. Matrix A can comprise, for example, a matrix of activation inputs, matrix [W] can comprise a matrix of weights, and matrix [B] can comprise a matrix of biases, of a machine learning training model utilizing weights-bias functions.

Method 700 can be performed by a TCS (hereinafter, with reference to FIG. 7A, “the TCS”) comprising a plurality of MCUs operating on subsets of ISUM matrices [WB] and [A_{M}]. The TCS can be an ISUM TCS similar or equivalent to the examples of FIGS. 3A-4B.

In operation 702 of method 700 the TCS (e.g., an integrator of the TCS) generates subsets of a row R of ISUM matrix [WB] and column C of ISUM matrix [A_{M}] to compute an Integrated Sum of elements of the row R and column C. The TCS can generate subsets of the K+1 elements of row R of matrix [WB] and K+1 elements of column C of matrix [A_{M}] (or, alternatively, subsets of K elements of column C, if the TCS utilizes multiplier selection logic to input a constant as a K+1 multiplicand of [WB_{R,K+1}]). The TCS can generate a subset 1 to include, for example, elements 1 to n of each of row R of matrix [WB] and column C of matrix [A], and a subset 2 to include elements (n+1) to (K+1) of row R of matrix [WB] and elements (n+1) to K+1 (or, n+1 to K) column C of matrix [A_{M}]. The TCS can determine the size of the subsets (e.g., the value of “n”) based on factors such as, for example, sizes, performance, and/or design characteristics of computation units (e.g., ISUM PUs/MCUs of the TCS) and/or memories to store elements of ISUM matrices [WB] and/or [A_{M}], and/or to store MACC Sum outputs.

For purposes of illustrating method 700, the TCS can compute the Integrated Sum as an ISUM MACC sum computed by a combination of two MCUs of the TCS, MCU₀ and MCU₁ (hereinafter, with reference to method 700, collectively “the MCUs”). MCU₀ and/or MCU₁ can be, for example, an MCU similar or equivalent to ISUM MCU 310 of FIG. 3A and the MCUs can compute Integrated Sums and sum-products of ISUM matrices [WB] and [A_{M}] utilizing methods such as methods 500 and 600, or operations thereof, in respective FIGS. 5 and 6. However, this is for only purposes of illustrating the disclosure, and not intended to limit implementations. A TCS can employ any variety of software and/or hardware computational components to compute Integrated Sums and/or MACC sums of the elements of the subsets.

In operation 704 MCU₀ computes products and/or MACC sum-products over elements of subset 1 and, in operation 706, MCU₀ outputs the products/sum-products to MCU₁. In operation 708 MCU₁ computes products and/or MACC sum-products over elements of subset 2 and, in operation 710, MCU₁ adds products/sum-products output by MCU₀ to products or, alternatively, to sum-products, computed by MCU₁.

In operation 704 MCU₀ can compute only products of elements of subset 1 and can output the products to MCU₁. Alternatively, in operation 704 MCU₀ can compute a complete sum-product, or can compute partial sum-products, of all elements of subset 1 and can, in operation 706, output the sum-product(s) to MCU₁. Similarly, in operation 708 MCU₁ can compute products of elements of subset 2 and, or, alternatively, can compute a complete sum-product, or can compute partial sum-products, of all elements of subset 2.

In operation 710, MCU₁ can add the products/sum-products computed in operation 708 to products/sum-products output, in operation 706, from MCU₀. In operation 710 MCU₁ can add outputs of MCU₀ to products or, alternatively, to sum-products, computed by MCU₁ as a MACC sum, adding the products/sum-products output by MCU0 to an accumulator of MCU₁, for example.

In operation 712 the MCUs determine if they have computed all of their respective products/sum-products such that, in combination, they have computed an Integrated Sum of all (K+1) computations of subsets 1 and 2 elements. If not, the MCUs repeat operations 704-710 until all each of MCU₀ and MCU₁ have computed products/sum-products over all of the elements in their respective subsets 1 and 2.

If, in operation 712, the MCUs determine that they have computed an Integrated Sum of all (K+1) computations of subsets 1 and 2 elements, in operation 714 MCU₁ outputs the complete Integrated Sum of row R of matrix [WB} and column C of matrix [A_{M}]. In operation 712 MCU₁ can output the Integrated Sum to a memory (e.g., to a memory containing an Integrated Sum matrix of sum-products of matrices [WB} and [A_{M}]), and/or to other computational elements of the TCS, such as other ISUM PUs/MCUs configured to compute functions utilizing Integrated Sums, or sum-products of Integrated Sums computed by MCU₀ and MCU₁. For example, in operation 714 MCU₁ can output an Integrated Sums, or sum-products of an Integrated Sum, to a forward operator of a neural network, or other computing model, or in a backpropagation computation (e.g., a gradient computation), to a backward operator of a neural network, or other computing model. Similarly, while not shown in FIG. 7A as an explicit operation, in operation 704 MCU₀ can, additionally, output products/sum-products to other computational elements of the TCS, and/or in operation 708 (or, in an additional operation of method 700 not explicitly shown in FIG. 7A) MCU₁ can output products/sum-products to other computational elements of the TCS.

In operation 716, the TCS (or, one of the MCUs) determine if the MCUs have computed an Integrated Sum for all N columns of ISUM matrix [A_{M}]. If not, in operation 718 the MCUs increment column counter, C, and the TCS and MCUs repeat operations 702 through 718. In operation 720, the TCS (or, one of the MCUs) determine if the MCUs have computed an Integrated Sum for all M rows of ISUM matrix [WB]. If not, in operation 722 the MCUs increment row counter, R, reset column counter C to 1, and the TCS and MCUs repeat operations 702 through 720 for the next row R of ISUM matrix [WB] multiplied by all N columns of matrix [A_{M}].

If, in operation 720, the TCS (or, one of the MCUs) determines that the MCUs have computed an Integrated Sum for all M rows of ISUM matrix [WB] (and, by implication, for each row of matrix [WB], for all N columns of matrix [A_{M}]), in operation 724 the TCS (or, one or both of MCU₀ and MCU₁), optionally, output an Integrated Sum matrix, [Y], comprising the Integrated Sums of all rows/columns of matrices [WB} and {A_{M}], which corresponds to an Addend Sum matrix of (Σw a+sb) where s is a constant multiplied by elements of addend matrix [B]. In operation 720, the TCS/MCUs can output the Integrated Sum matrix [Y] to a memory and/or to other computational units of the TCS, such as forward and/or backward operator computational units of the TCS.

While the disclosure illustrates method 700, in FIG. 7A, using the example of two MCUs computing subset products and/or MACC sum-products, and adding the subset products/sum-products to compute a MACC Sum, this is not intended to limit implementations. It would be appreciated by one of ordinary skill in the art to apply method 700, and/or operations of method 700, in alternative implementations to compute products/sum-products of more than 2 subsets of ISUM multiplicand matrix elements, and/or utilizing more than two MCUs to compute products/sum-products of a plurality of subsets more than two subsets.

FIG. 7B illustrates an example implementation of an ISUM TCS that can perform a method such as method 700, utilizing two MCUs such as described in operations of method 700. In FIG. 7B, ISUM TCS 750 comprises ISUM MCUs 752A and 752B (hereinafter, collectively “MCUs 752”) and memories 754A, 754B, and 754C (hereinafter, collectively, “memories 754”). ISUM TCS 750 can be, for example, an ISUM TCS similar to the examples of FIGS. 2B-4BA. MCUs 752A and 752B are shown in FIG. 7B comprising respective ISUM ALUs 756A and 756B. ISUM ALUs 756A and/or 756B can be ISUM ALUs similar or equivalent to MACC ALU 320 in FIG. 3A, and/or can comprise components capable of performing operations of the methods of the disclosure, and/or operations of MACC ALU 320.

While not shown in FIG. 7B, as previously described, ISUM TCS 750 can include processors, such as a neural network, a host processor, runtime processor, RDU and/or processors of RDUs, and/or accelerator processors (CGRAs, FPGAs, GPUs, etc.), and/or ISUM PUs. MCUs 752 can be components of ISUM PUs (not shown in FIG. 7B). TCS 750 can comprise ISUM programs, such as programs for generating ISUM integrated matrices and/or computing ISUM integrated sum-products and/or Integrated Sums, and the programs can execute on processors of the TCS.

In FIG. 7B each of ALUs 756A and/or 756B is shown including a respective tensor WB buffer and tensor A buffer that can input elements of ISUM matrix WB in memory 754B (hereinafter, “matrix 754B”), and ISUM matrix A_{M} in memory 754A (hereinafter, “matrix 754A”). Matrix 754B can comprise an ISUM integrated matrix, and matrix 754A can comprise an ISUM multiplicand matrix. While not shown in FIG. 7B, ISUM TCS 750 can include an integrator component that can generate matrices 754B and/or 754A. In implementations, MCUs 752 can perform a method, or operations thereof, similar or equivalent to methods 500 of FIG. 5, and/or method 600 of FIG. 6, to compute sum-products, such as MACC Sums, of matrices 754B and/or 754A.

In FIG. 7B, ISUM ALU 756A is shown configured to output computations of ALU 756A to ISUM ALU 756B. ISUM MCUs 752A and/or 752B can perform a method, such as 700 in FIG. 7A, or operations thereof, to compute products, and/or sum-products, of a subset of elements of matrices 754B and 754A. For example, ISUM MCU 752A can compute products, and/or sum-products (e.g., MACC sum-products), over one subset of K+1 elements of a particular row of matrix 754B and column of matrix 754A. ISUM MCU 752A can output the subset products and/or sum-products to ISUM MCU 752B. ISUM MCU 752B can compute a complementary subset of products and/or MACC sum-products over that row of matrix 754B and column of matrix 754A. In a sum-product (e.g., MACC) computation, MCU 752B can add the ISUM MCU 752A subset products/sum-products to products/sum-products of the complementary subset, computed by MCU 752B, to compute an Integrated Sum of all K+1 elements of a row of matrix 754B and column of matrix 754A.

While not shown explicitly in FIG. 7B, MCU 752A and/or 752B can include multiplier selection logic, such as multiplier selection logic 340 in FIG. 3A, to input a constant, S, into a multiplier ALU of MCU 752A and/or 752B in computing a (K+1) product of an element of a row of matrix 754B and the constant, in lieu of generating row (K+1) of matrix 754A to include a row of constants having value S. While also not shown in FIG. 7B, ISUM TCS 750 can include a counter, such as counter 334 of multiplier selection logic 340 in FIG. 3A, to count product computations of a row of matrix 754B and column of matrix 754A in FIG. 7B. Multiplier selection logic of MCUs 752A and/or 752B can omit a counter, such as 334 and, alternatively, can receive an output of a counter of TCS 750 to indicate a K+1 computation of a product of elements of matrix 754B and matrix 754A.

As described in reference to TCS 400, in FIG. 4A, and ISUM TCS 420, in FIG. 4B, ISUM PUs/MCUs among a plurality of ISUM PUs/MCUs of an ISUM TCS can compute Integrated sum-products and/or Integrated Sums of a single row, or of a set of particular rows, of an ISUM integrated matrix, such as matrix 754B in FIG. 7B. The number of ISUM PUs/MCUs of the TCS can be many thousands and the ISUM PUs/MCUs can each compute a subset of products, and/or sum-products, of matrices such as 754B and 754A and can thereby greatly increase parallel computations of Integrated Sums of such matrices.

The examples of FIGS. 1C and 2B-7B illustrate example implementations utilizing an ISUM integrated matrix comprising an input multiplicand matrix and a matrix addend and an ISUM multiplicand matrix that can comprise an ISUM row-extended matrix having a row of constants to extend a second input multiplicand matrix. However, computing ISUM Integrated Sums need not necessarily be limited to multiplying a K+1 column of an ISUM integrated matrix, by a K+1 row of constants, or multiplying a K+1 column of an ISUM integrated matrix by a constant output from a constant input element. FIGS. 8A through 8E illustrate multiple alternative ISUM integrated and multiplicand matrices that can be multiplicands in an Integrated Sum computation (e.g., a MACC computation of an Integrated Sum).

In implementations, a matrix addend can comprise a constant. For example, in a function such as (Σw a+s), addend s can be a constant added to each sum-product of Σw a. In another example, an Integrated Sum addend can be a product of a scalar and elements of a matrix addend, such as (Σw a+sb), where s is a constant multiplied by elements of a matrix addend [B]. FIG. 8A illustrates the example of computing a function such as (Σw a+s) as an Integrated Sum computation.

An ISUM integrator can combine M×K multiplicand matrix [W] with a “constant integrated addend” to generate M×(K+1) ISUM integrated matrix WS 802. As used herein, “constant integrated addend” refers to an integrated addend having the same constant in each row element of the matrix. In FIG. 8A, column (K+1) of matrix WS 802 can comprise a constant integrated addend having constant value s in each row of the matrix. An ISUM integrator can generate a (K+1)×N ISUM row-extended matrix, shown as matrix A_{E} 804 in FIG. 8A, having a constant row in row (K+1) of the ISUM row-extended matrix. In FIG. 8A matrix A_{E} 804 is shown comprising K×N multiplicand matrix [A] extended with a constant row having all ones in each column of row (K+1) of matrix A_{E} 804. ISUM PUs and/or MCUs, for example, can perform a method, or operations of a method, such as the example methods of FIGS. 5, 6, and 7A, to compute an Integrated Sum of matrix WS 802 and matrix A_{E} 804, Σws a_{E}, to produce Integrated Sum elements of M×N Integrated Sum matrix Y 806 in FIG. 8A. The Integrated Sum elements can be equivalent to an Addend sum computed as (Σw a+s).

Alternatively, as illustrated in the example of method 600 of FIG. 6, an ISUM integrator can generate matrix A_{E} 804 to comprise only K×N input multiplicand matrix [A]. An ISUM PU, or ISUM MCU, of an ISUM TCS can include multiplier selection logic such as illustrated in the example of ISUM 310 of ISUM TCS 300, in FIG. 3A. ISUM PUs and/or MCUs of the TCS can compute a (K+1) product comprising constant s multiplied by 1, to add constant s to the sum-product of a row of matrix WS 802 and column of matrix A_{E} 804. In implementations, multiplier selection logic need not comprise a constant value of s equal to 1, and can, instead, have another constant value, such as value of another scalar constant, c, such as in (Σw a+sc) where the matrix addend to Σw a is a product of two constants (e.g., one or both constants output by a constant input element, or by a computation element, such as another ISUM PU or MCU, of a TCS).

FIG. 8B illustrates a second example, in which an ISUM TCS can compute an ISUM Integrated Sum Σwb a_{E}, equivalent to (Σw a+sb), where s is a constant multiplied by elements of a matrix addend, matrix [B]. An ISUM integrator can combine an M×K multiplicand matrix [W] and an M×1 addend matrix [B], to generate M×(K+1) ISUM integrated matrix WB 812, in FIG. 8B, having an integrated addend comprising addend matrix [B] in column (K+1) of matrix WB 812. An ISUM integrator can generate (K+1)×N matrix A_{E} 814, having a constant row comprising constant s in each element of row (K+1) of matrix A_{E} 814. ISUM PUs and/or MCUs can perform a method, or operations of methods, such as the example methods of FIGS. 5, 6, and/or 7A to compute products of column elements of a row of matrix WB 812 and row elements of a column of matrix A_{E} 814 to produce Integrated Sum elements of M×N Integrated Sum matrix Y 816 in FIG. 8B. The Integrated Sum elements can be equivalent to an Addend sum computed as (Σw a+sb).

Similar to the example of FIG. 8A, an implementation can include multiplier selection logic comprising a constant input element having a value of s in (Σw a+sb). An ISUM integrator can generate ISUM multiplicand matrix A_{E} 814 to omit row (K+1), and ISUM PUs and/or MCUs, for example, can perform operations of method 600, such as operations 606 through 616, utilizing the multiplier selection logic to input constant s to a multiplier ALU in a K+1 product computation of (Σwb a_{E}).

Implementations are also not necessarily limited to computing Integrated Sums for functions having a single addend matrix. For example, using ISUM integrated and/or ISUM extended matrices, an ISUM TCS can compute (Σw a+s₁b₁+s₂ b₂+ . . . sₚbₚ) for P number of addend matrices, [B₁] to [Bₚ], and in which each of the matrix addend matrices can be multiplied by a constant, respectively s₁ through sₚ. FIG. 8C illustrates such an example. As shown in the example of FIG. 8C, an ISUM TCS integrator can combine an M×K matrix [W] and P number of integrated addends, in which each integrated addend comprises one of P number of M×l matrices, [B₁] to [Bₚ], to generate an M×(K+P) ISUM integrated matrix WB 822. The ISUM integrator can place an integrated addend comprising matrix [B₁] in column (K+1) of matrix WB 822, an integrated addend comprising matrix [B₂] in column (K+1) of matrix WB 822, and so on, placing an integrated addend of each of matrices [B₁] to [Bₚ] in respective multiplicand columns among columns (K+1) to (K+P) of matrix WB 822.

Correspondingly, an ISUM integrator can generate a (K+P)×N ISUM row-extended matrix, shown in FIG. 8C as matrix A_{E} 824, by adding (K+P) rows of constant rows, having respective constants s₁ to sₚ, to a K×N multiplicand matrix [A]. ISUM PUs and/or MCUs can perform a method, or operations of methods, such as the example methods of FIGS. 5, 6, and/or 7A to produce Integrated Sum elements of M×N Integrated Sum matric Y 826 in FIG. 8C, which are equivalent to Added Sums, (Σw a+s₁b₁+s₂ b₂+ . . . sₚbₚ), computed as a sum of an intermediate matrix of Σw a subsequently added to addend P number of products of matrices [B₁] to [Bₚ] multiplied by respective constants s₁ to sₚ.

As in the examples of FIGS. 8A and 8B, an ISUM TCS can include multiplier selection logic having one or more constant input elements (e.g., elements having values among constants s₁ to sₚ) to output scalars among constants s₁ to sₚ. In such a case, an ISUM integrator can generate matrix A_{E} 824 as a K×N ISUM multiplicand matrix comprising only K×N multiplicand matrix [A] and can omit rows (K+1) to (K+P), or omit rows among rows (K+1) to (K+P), of matrix A_{E} 824 shown in FIG. 8C. The TCS can, alternatively, inject scalars among constants s₁ to sₚ into rows (K+1) to (K+P) of the ISUM row-extended matrix.

The example of FIG. 8C illustrates a matrix summation adding P number of addend matrices, each multiplied by a constant. However, this is only to illustrate one implementation and not intended to be limiting to implementations. It would be appreciated by one of ordinary skill in the art, for example, that an ISUM computing system can use integrated summation MACC computations, such as described in the example of FIG. 8C, to compute a matrix summation (Σw a+s₁+s₂+ . . . sₚ), in which each of s₁ to sₚ is a constant added to (Σw a), and that the example of FIG. 8C need not comprise addend matrices multiplied by the constants. In such an example, each of the integrated addends (K+1) to (K+1) can comprise a respective integrated addend comprising a constant among constants s₁ to sₚ.

The examples of FIGS. 8A-8C illustrate generating an ISUM integrated matrix utilizing P number of M×1 integrated addends and generating an ISUM row-extended matrix having corresponding P number of rows of constants (or, alternatively, multiplied by a scalar constant output by multiplier selection logic). However, implementations need not necessarily be limited to single column addend matrices such as in these examples. However, an ISUM TCS can also compute ISUM Integrated Sums for functions comprising a more general, M×P addend matrix [B]. FIG. 8D illustrates an example of computation such as (Σw a+sb), where s is a constant and b is an element of an M×P addend matrix [B].

As shown in FIG. 8D, an ISUM integrator can combine an M×K multiplicand matrix [W] with P number of addend columns of addend matrix [B] to generate M×(K+P) ISUM integrated matrix WB 832. In FIG. 8D matrix WB 832 is shown comprising an M×K multiplicand matrix, [W], in columns 1 to K of matrix WB 832, integrated with an M×P addend matrix, [B], in columns (K+1) to (K+P) of matrix WB 832. Each of columns (K+1) to (K+P) of matrix WB 832 can comprise an integrated addend that is a corresponding multiplicand column of the P columns of addend matrix [B].

Correspondingly, an ISUM integrator can generate (K+P)×N ISUM row-extended matrix A_{E} 834, in FIG. 8D, comprising a K×N multiplicand matrix [A] extended with P number of constant rows having constant s in all columns of each of rows (K+1) to (K+P) of matrix A_{E} 834. As previously described, s can be a constant having value 1 or can be a constant having a value other than 1. ISUM PUs and/or MCUs can perform a method, or operations of a method, such as the example methods of FIGS. 5, 6, and 7A, to produce Integrated Sum elements of M×N matrix Y 836 in FIG. 8D. The Integrated Sum elements can be equivalent to an Addend sum computed as a sum of products of [Σw a], of a matrix [W] and a matrix [A], subsequently added to products of a matrix [B] multiplied by a vector of constants s₁ to s_{N}.

As in the examples of FIGS. 8A-8C, an ISUM TCS can include multiplier selection logic having constant s as an output of a constant input element. An ISUM integrator can generate matrix A_{E} 834 as a K×N ISUM multiplicand matrix comprising only K×N multiplicand matrix [A] and can omit rows (K+1) to (K+P) of matrix A_{E} 834 shown in FIG. 8D. Using a method similar to method 600 of FIG. 6, for example, the ISUM PUs/MCUs can select the input scalar element to input constant s as a multiplicand of elements of columns (K+1) to (K+P) of matrix WB 832 in an Integrated Sum computation.

An ISUM TCS can combine computations of the examples of FIGS. 8C and 8D to compute an ISUM Integrated Sum (Σwb a) of a plurality of addend matrices, each having a common row dimension, D1, but that can have differing column dimensions, D2. FIG. 8E illustrates an example of such a case using two such matrices, B₁ and B₂, in which B₁ and B₂ share a row dimension but have differing column dimensions. FIG. 8E illustrates an example of such a computation, (Σw a+s₁b₁+s₂b₂), where b₁ and b₂ are elements of respective addend matrices B₁ and B₂, and s₁ and s₂ are constants (which can be the same or can be different from each other).

As illustrated in FIG. 8E, an ISUM integrator can combine an M×K multiplicand matrix [W], an M×J addend matrix [B₁], and an M×L addend matrix [B₂], to generate M×(K+P) ISUM integrated matrix WB 842, where P=K+J+L. Columns (K+1) to (K+J) of matrix WB 842 can comprise integrated addends in which each integrated addend comprises one of columns 1 to J of addend matrix [B₁], and columns (K+J+1) to (K+P) of matrix WB 842 can comprise integrated addends in which each integrated addend comprises one of columns 1 to L of addend matrix [B₂].

Correspondingly, an ISUM integrator can generate (K+P)×N ISUM row-extended matrix A_{E} 844, in FIG. 8E, by extending an input multiplicand matrix [A] with (K+P) rows of constant rows. Rows (K+1) to (K+J) of matrix A_{E} 844 can comprise constant rows having constants s₁₁ to s_{1N}, and rows (K+J+1) to (K+P) of matrix A_{E} 844 can comprise constant rows having constants s₂₁ to s_{2N}. ISUM PUs and/or MCUs can perform a method, or operations of a method, such as the example methods of FIGS. 5, 6, and 7A, to produce Integrated Sum of M×N Integrated Sum elements of matrix Y846 in FIG. 8E. The Integrated Sum elements can be equivalent to an Addend Sum computed as (Σw a+s₁b₁+s₂b₂). While FIG. 8E illustrates computing an Integrated Sum of only two addend matrices, each having an arbitrary column dimension (J and P, in the example of FIG. 8E), this is not intended to limit implementations and it would be understood that ISUM PUs/MCUs can compute Integrated Sums, such as illustrated by the examples of FIGS. 2B through 8E, comprising an arbitrary number of addend matrices, more than 2, each comprising an arbitrary number of columns.

As described with reference to FIGS. 8A-8D, an ISUM TCS can include multiplier selection logic, sch as 340 in FIG. 3A, having a constant input element to output constants s i and/or s₂. In such a case, an ISUM integrator can generate matrix A_{E} 844 as K×N ISUM multiplicand matrix comprising K×N multiplicand matrix [A] and omitting some or all of rows (K+1) to (K+P) of matrix A_{E} 844 shown in FIG. 8E. The ISUM PUs/MCUs can perform a method similar to method 600 of FIG. 6, for example, to compute products of s₁₁ to s_{1N} in rows (K+1) to (K+J) of matrix A_{E} 844, and elements b₁ to b_{J} of matrix [B₁], in columns (K+1) to (K+J) of matrix WB 842. The ISUM PUs/MCUs can similarly perform a method similar to method 600 of FIG. 6 to compute products of s₂₁ to s_{2N}, in rows (K+J+1) to (K+P) of matrix A_{E} 844, and elements b₁ to b_{L} of matrix [B₂] in columns (K+J+1) to (K+P) of matrix WB 842.

As previously described an ISUM TCS can comprise a plurality, possibly many thousands, of ISUM PUs/MCUs and the plurality of ISUM PUs/MCUs can compute Integrated sum-products and/or Integrated Sums of a single row, or of a set of particular rows, of an ISUM integrated matrix, such as in the examples of FIGS. 8A-8E. The plurality of ISUM PUs/MCUs can each compute a subset of products, and/or sum-products, of matrices such as in the examples of FIGS. 8A-8E, and can thereby greatly increase parallel computations of Integrated Sums of such matrices.

Components of an ISUM TCS, such as ISUM matrix integrators, ISUM PUs, and ISUM MCUs can perform any or all of the methods of the disclosure, and/or any or all of the operations of the methods of the disclosure, in any particular combination and/or order of the methods or operations thereof. ISUM components of a TCS, such as ISUM matrix integrators, ISUM PUs, and ISUM MCUs can be combined and/or subdivided in any particular arrangement suitable to perform ISUM matrix integration and computations, such as sum-product and/or transposition computations used to illustrate the disclosure (but, not limited to only these example computations and matrix operations).

As illustrated in the examples of the disclosure, an ISUM TCS, ISUM PU, and/or ISUM MCU can compute Integrated Sums of an ISUM integrated matrix, comprising a multiplicand and one or more addend matrices, and an ISUM row or column row-extended matrix, and/or can compute Integrated Sums of an ISUM integrated matrix and an ISUM multiplicand matrix, using only MACC computations. The resulting MACC sum Integrated Sums are equivalent to a computation of a sum-product of two multiplicand matrices added, as a subsequent matrix computation, to an added matrix, and/or a product of a scalar and a matrix addend. The ISUM integrated matrices can comprise a plurality of addend matrices, and addend matrices, integrated into an ISUM integrated matrix, can comprise column dimensions of an arbitrary size greater than 1.

Computing applications, such as machine learning and applications utilizing neural networks, can utilize a “backpropagation” algorithm to tune results of tensor computations (e.g., to achieve closer agreement of machine learning and/or data analysis with predicted, or known, results). In a backpropagation algorithm, computational results output from a “forward” computational element can be used to adjust parameters of tensor computations, such as weights and/or bias values in a weights-bias function. A tensor computation system, and/or tensor computing application, can use a “loss function” to optimize tensor computations to achieve closer agreement with predicted, or known, results of an application, such as machine learning or data analysis applications.

For example, in a weights-bias function, a forward ISUM TPU/MCU can compute sum-products of input multiplicand and addend matrices, such as (Σwb a_{E}). The forward TPU/MCU can output a resulting Integrated Sum matrix (or, can output integrated sum-products to an Integrated Sum matrix), and the Integrated Sum matrix can be input to a TPU/MCU to compute a loss function over the Integrated Sum matrix. The loss function TPU/MCU can use a loss function to compute adjusted weight and bias values of weights-bias computations. For example, a loss function TPU/MCU can utilize a gradient descent algorithm to compute gradients of elements of a weights and/or bias matrix. The loss function TPU/MCU can output weight and/or bias gradient values to matrices of adjusted weights and biases, such as to a weights matrix [W] and/or a bias matrix [B]. In a backpropagation algorithm, the loss function TPU/MCU can feed the adjusted weights-bias matrices “backward” to an ISUM TCU/MCU to repeat weights-bias computations using the adjusted (gradient) weights and/or bias values.

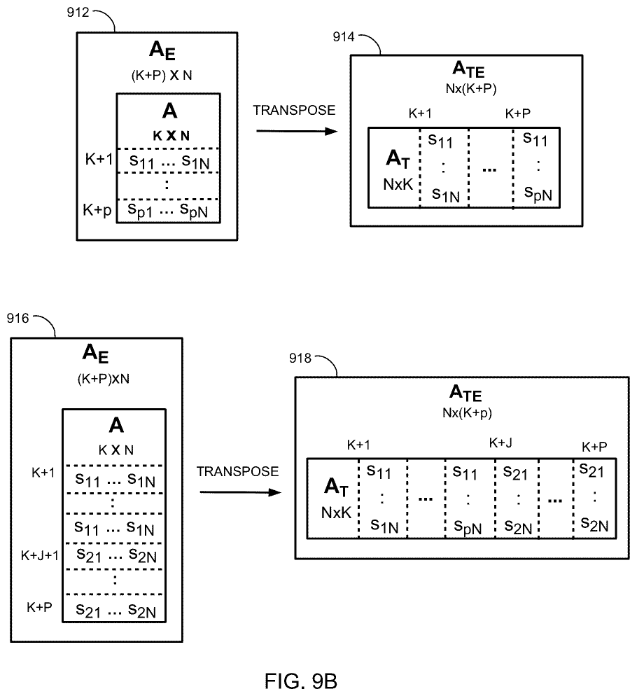

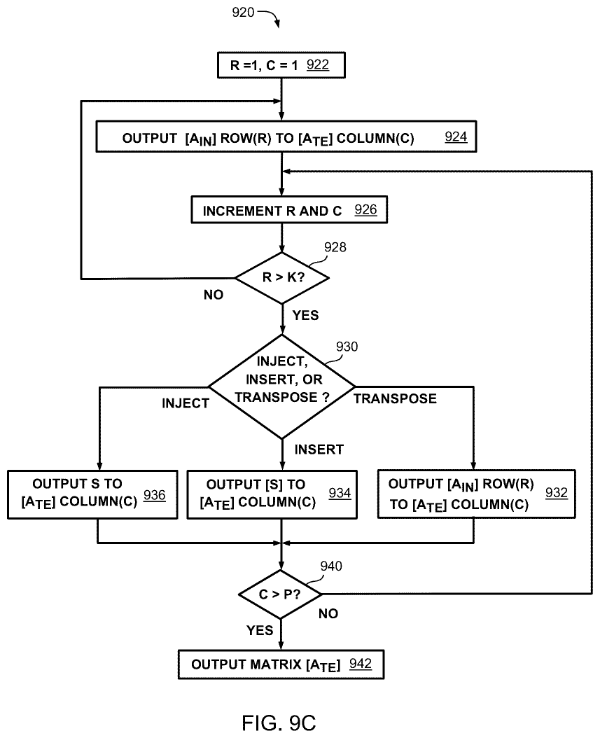

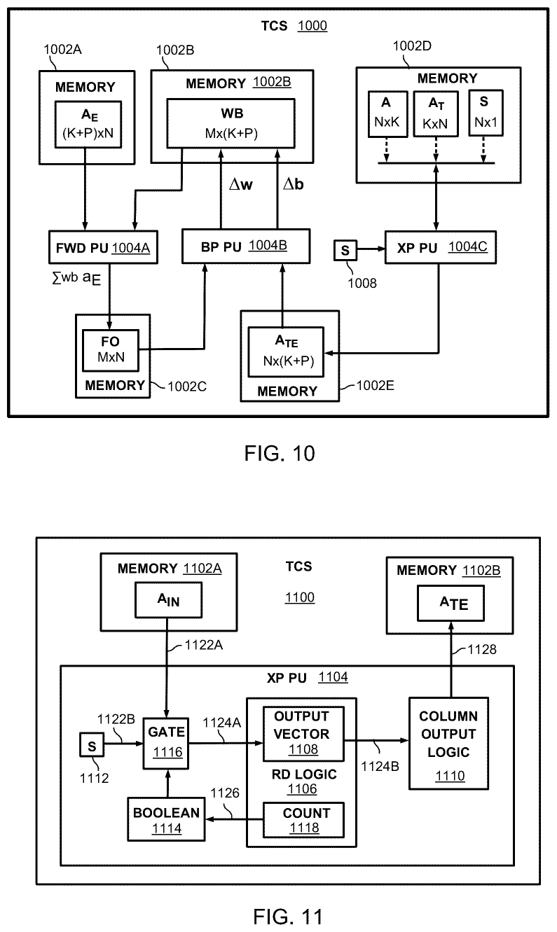

An ISUM TCS can generate ISUM integrated and, optionally, ISUM extended matrices and can compute a loss function Integrated Sum matrix as an integrated summation computation, such as in the foregoing examples of the disclosure. FIG. 9A an illustrates an example of ISM loss function computations in a backpropagation algorithm. FIG. 10 illustrates an example of an ISUM PU configured to perform ISUM loss function computations such as illustrated in the example of FIG. 9A.

For purposes of illustrating the example, but not intended to limit implementations, the description of FIG. 9A refers to a “forward PU” (with reference to FIG. 9A, “the forward PU”) computing a forward-output matrix. The forward PU can comprise one or more matrix computational PUs, and/or one or more MCUs, of a TCS. The forward PU can, but need not necessarily comprise an ISUM PU and/or ISUM MCU, for example. For further purposes of illustrating the example, but also not intended to limit implementations, the description of FIG. 9A further refers to an “transposer (XP) PU” (hereinafter, with reference to FIG. 9A, “the XP PU”) that can generate an ISUM transpose-extended matrix and refers to an ISUM “BP PU” (hereinafter, with reference to FIG. 9A, “the BP PU”) of an ISUM TCS (“the TCS” with reference to FIG. 9A) using the ISUM transpose-extended matrix to compute gradients of weights and biases of a weights-bias function in a backpropagation algorithm of an application.

However, this is not intended to limit implementations; any variety of alternative processors and/or combinations of processors processing elements of a TCS, such as RDUs, MCUs, tiles and/or processors of tiles of an RDU, can generate an ISUM transpose-extended matrix can compute a forward output matrix, generate an ISUM transpose-extended matrix, and/or compute gradients (or, other sum-products of an application) using an ISUM transpose-extended matrix. It will be further appreciated by one of ordinary skill in the art that a forward PU, XP PU, and/or a BP PU, such as used to illustrate the examples of FIG. 9A, can be the same PU (or, can comprise the same processing elements, such as MCUs, of an ISUM PU). Through an understanding of the disclosure, one of ordinary skill in the art will also see that aspects of the example of FIG. 9A are applicable to matrix computations involving loss functions, and/or other function computations, other than weights-bias functions.

FIG. 9A depicts matrix WB 900, matrix A_{E} 902, and matrix FO 904. Matrix WB 900 is shown in FIG. 9A comprising an M×(K+1) ISUM integrated matrix that integrates, in columns 1 to K of matrix WB900, M×K multiplicand matrix W (hereinafter, with reference to FIG. 9A, “matrix W 900”) and, in column (K+1) of matrix WB 900, M×1 addend matrix [B] (hereinafter, with reference to FIG. 9A, “matrix B 900”). Matrix A_{E} 902 in FIG. 9A is shown as a (K+1) ISUM row-extended matrix, such as in the example of matrix 302A in FIG. 3A, that comprises, in rows 1 to K of Matrix A_{E} 902, K×N multiplicand matrix [A] (hereinafter, with reference to FIG. 9A, “matrix A 902”) and, in row (K+1) of matrix A_{E} 902, a constant row comprising constant value S in each element of row (K+1). An ISUM matrix integrator of a TCS, such as previously described, can generate matrix A_{E} 902.

The forward PU can compute an Integrated Sum (e.g., MACC sum-products) matrix of matrix WB 900 and matrix A_{E} 902 to compute, for example, a weights-bias function. Matrix FO 904, as shown, in FIG. 9A, is an M×N forward output matrix of a weights-bias function of multiplicand matrices [W] and [A], and addend matrix [B] multiplied by constant s[Σw a+sb], that can be computed as an ISUM sum-product [Σwb a_{E}], such as by systems and/or techniques of the disclosure. Matrix FO 904 need not necessarily, however, be an output of an ISUM computation of matrices WB 900 and A_{E} 902. Alternatively, matrix FO 904 is simply an output of a weights-bias computation and need not necessarily be computed as Integrated Sums. Similarly, the forward PU need not comprise an ISUM PU or ISUM MCU and can, alternatively compute matrix FO 904 as two computations to first compute sum-product and, subsequently, add the sum-product to an addend matrix in a computation of [Σw a+b] to generate matrix FO 904.

In backpropagation algorithms, one method to compute a weight gradient is to compute a sum-product of a row of a loss function input matrix (e.g., a row of an Integrated Sum matrix) multiplied by a column of a transposed multiplicand matrix. For example, the BP PU can compute a weights gradient, [Δw=Σlf_{IN} a_{T}], as a sum-product of each of the N column elements of a row of a loss function input matrix, [LF_{IN}], multiplied by an element of a corresponding row element among the N rows of an N×K transposition of a K×N matrix [A], denoted as matrix [A_{T}].

One method of computing a bias gradient in a backpropagation algorithm is to compute a sum-product of a row of a loss function input matrix multiplied by a multiplicand column comprising a scalar const in each element of the multiplicand column or, alternatively, a column of a multiplicand matrix having a row dimension (e.g., “N” of an N×K multiplicand matrix) shared with the column dimension of a loss function matrix (e.g., “N” in an M×N loss function matrix). For example, the BP PU can compute a bias gradient of an M×N loss function input matrix, [LF_{IN}], as a sum-product of a row of the matrix [LF_{IN}] multiplied by an N×1 multiplicand column, [Δb=Σlf_{IN} s], where s comprises N number of elements of the multiplicand column.

In a case in which the multiplicand column comprises constant value 1, a bias gradient [Δb=Σlf_{IN} s] is computed as [Δb=Σlf_{IN} 1], which computes the sum of all elements of a row of matrix [LF_{IN}]. In an alternative case in which the multiplicand column comprises elements of a column of a multiplicand matrix, bias gradient [Δb=Σlf_{IN} s] is computed as a sum-product of a row of matrix [LF_{IN}] multiplied by a multiplicand column of a constant s or, alternatively a multiplicand column of a multiplicand matrix having (in this example) row dimension M.

In the example of FIG. 9A, Matrix FO 904 can be a loss function input matrix, shown as matrix LF_{IN} 906. The BP PU can use matrix LF_{IN} 906 to compute gradients Δw and/or Δb of respective matrices WB 900 and A_{E} 902 in a loss function computation. The BP PU can output (gradient) adjusted weights and/or biases to an ISUM integrated matrix, such as matrix WB 900, and/or to updated instances of matrices W 900 and/or B 900 not included in matrix WB 900. In implementations, matrix LF_{IN} 906 and matrix FO 904 can be the same (e.g., matrix FO 904 can be directly input to BP PU as matrix LF_{IN} 906) or, alternatively, matrix LF_{IN} 906 can be a copy of matrix FO 904, such as a copy of matrix FO 904 in a memory (e.g., a memory of, or used by, the BP TPU) different from a memory containing matrix FO 904.

A conventional computation of a weights gradient and bias gradients (e.g., to compute a gradient-adjusted weights and/or bias matrix) computes the weights and bias gradients as two separate sum-product computation, one to compute Σlf_{IN} a_{T} and another to compute Σlf_{IN} s. This can require either dedicating additional compute resources of a TCS (e.g., a set of MCUs to compute the weight gradients and additional MCUs to compute the bias gradients), or can serialize the computations within a set of MCUS configured to compute both gradients.

However, an XP PU can generate an N×(K+P) ISUM “transpose-extended” as a multiplicand matrix of a loss function input matrix to compute weights and/r bias gradients using the foregoing equations. As used herein, the term “transpose-extended matrix” refers to an N×(K+P) ISUM matrix that extends an N×K matrix transposition of a K×N matrix to have P number of N×1 multiplicand columns in each of columns (K+1) to (K+P) of the transpose-extended matrix. The XP PU can transpose an N×K multiplicand matrix to generate, in columns 1 to K of the ISUM transpose-extended matrix, corresponding rows 1 to K of the loss function input matrix. The XP PU can generate columns (K+1) to (K+P) of the ISUM transpose-extended matrix to comprise columns of scalar constants, and/or columns of one or more multiplicand matrices having row dimension N.

Similar to the manner of computing an Integrated Sum by means of sum-product computations of an ISUM integrated matrix and an ISUM multiplicand matrix, the BP PU can compute weights gradients and bias gradients as sum-products (e.g., MACC sum-products) of a loss function input matrix and an ISUM transpose-extended matrix. As will be seen from further discussion of FIG. 9A, an ISUM BP PU can compute sum-products of a loss function input matrix [LF_{IN}] and an ISUM transpose-extended matrix [A_{TE}] as a single sequence of integrated sum-product computations, Σlf_{IN} a_{TE}.

By executing a single sequence of integrated sum-product computations, an ISUM PU can avoid computing each of the weights and bias gradients as separate computations. Further, computing each of the weights and bias gradients as separate computations can require computing each gradient using different MCUs. By executing a single sequence of integrated sum-product computations, an ISUM PU can, alternatively, compute the gradients using a single MCU configured to compute the sum-products of the loss function input matrix and an ISUM transpose-extended matrix. Additionally, as will be seen in the examples of FIG. 9B, an ISUM PU can generate an ISUM transpose-extended matrix as a transposition of an ISUM (row) row-extended matrix, such as in the examples of FIGS. 1C and 8A-8E.

To illustrate, FIG. 9A further depicts ISUM transpose-extended matrix A_{TE} 908 comprising, in columns 1 to K of matrix A_{TE} 908, matrix A_{T} (hereinafter, with reference to FIG. 9A, “matrix A_{T} 908”), which is shown to be a transposed matrix of K×N matrix A 902. FIG. 9A further depicts ISUM transpose-extended matrix A_{TE} 908 comprising, in column (K+1) of matrix A_{TE} 908, a multiplicand column having all constants (constant value s). Alternatively, column (K+1) of matrix A_{TE} 908 can comprise an N×1 multiplicand matrix.

The XP PU can generate matrix A_{TE} 908 as a transposition of matrix A 902 (although, not necessarily as extracted from matrix A_{E} 902 itself) and can append column (K+1) of matrix A_{TE} 908 as a multiplicand column. The XP PU can generate matrix A_{TE} 908 as a transposition of matrix A_{E} 902. In this example, the XP PU can generate columns 1 to (K+1) of matrix A_{TE} 908 as a transposition of matrix A_{E} 902. In this case, column (K+1) of matrix A_{TE} 908 comprises row (K+1) of matrix A_{E} 902 transposed. Alternatively, the XP PU can generate columns 1 to K of matrix A_{TE} 908 as a transposition of matrix A 902. In this case, the XP PU can generate column (K+1) of matrix A_{TE} 908 to comprise a column of scalar constants or, alternatively, an N×1 multiplicand matrix.

The example of FIG. 9A illustrates that the BP PU can compute weights gradients of a matrix such as matrix W 900 or matrix WB 900, as sum-products of rows 1 though M of matrix LF_{IN} 906 and columns 1 through K of matrix A_{TE} 908. In the example of FIG. 9A, the BP PU can compute bias gradients as sum-products of rows 1 though M of matrix LF_{IN} 906 and column (K+1) of matrix A_{TE} 908. The BP PU can output the gradients to an M×(K+1) gradient-adjusted matrix, depicted in FIG. 9A as M×(K+1) matrix W_{BG} 910. In FIG. 9A matrix W_{BG} 910 comprises weight gradients Δw in columns 1 through K of matrix W_{BG} 910 and bias gradients Δb in column (K+1) of matrix W_{BG} 910. Matrix W_{BG} 910 (or, elements of matrix W_{BG} 910) can be an input ISUM integrated matrix to a forward operator computing Σwb a using the (backpropagated) gradients-adjusted weights and biases of matrix WB_{G} 910. Matrix W_{BG} 910 can be identically matrix WB 900, such that matrix WB 900 can be used, with adjusted gradients, to recompute matrix FO 904.

While FIG. 9A illustrates the BP PU outputting gradients Δw and Δb to matrix WB_{G}910, this is only to illustrate an example of generating a transpose-extended matrix and computing gradients as sum-products of the transpose-extended matrix and a loss function input matrix. However, this not intended to limit implementations and the BP PU can, alternatively, output gradients Δw and/or Ab to individual matrices (e.g., an M×K matrix of gradient-adjusted weights, or an M×l matrix of gradient-adjusted biases), and/or to a PU or MCU of a TCS, such as for use in additional weights-bias function computations (e.g., a back-propagated weights and/or bias matrix for recomputing FO 904 using gradients-adjusted weights and/or biases).

The example of FIG. 9A also illustrates matrix A_{TE} having a single, (K+1) multiplicand column. However, in implementations an ISUM transpose-extended matrix can comprise an arbitrary number (“P” number) of multiplicand columns. Discussion of FIG. 9B refers to the examples of FIGS. 8C-8E to illustrate examples of ISUM transpose-extended matrices having P number of multiplicand columns added to a transposed multiplicand matrix. For purposes of illustrating the example, but not intended to limit implementations, the description of FIG. 9B continues the example of the XP PU, as described with reference to in FIG. 9A, generating ISUM transpose-extended matrices.

FIG. 9B illustrates matrix A_{E} 912 as a (K+P)×N matrix comprising K×N matrix [A], in rows 1 to K of matrix A_{E} 912, and P number of additional rows comprising scalar constants. Matrix A_{E} 912 can be a matrix similar, for example, to matrix A_{E} 824 of FIG. 8C, matrix A_{E} 834 of FIG. 8D, or matrix A_{E} 844 of FIG. 8E. An XP PU can transpose matrix A_{E} 912 to generate N×(K+P) matrix A_{TE} 914 in FIG. 9B. Alternatively, an XP PU can transpose matrix [A] of matrix A_{E} 912 to form column 1 through K of matrix A_{TE} 914, and can generate each of columns (K+1) to (K+P) of matrix A_{TE} 914 to comprise a multiplicand column. The multiplicand columns can comprise scalar constants and/or N×l matrices.

FIG. 9B further illustrates (K+P)×N matrix A_{E} 916 comprising K×N matrix [A] in rows 1 to K of matrix A_{E} 912, and P number of additional constant rows, similar to the example of matrix A_{E} 844 of FIG. 8E. The XP PU can transpose (K+P)×N matrix A_{E} 916 to generate matrix A_{TE} 918 in FIG. 9B. Alternatively, to generate matrix A_{TE} 918 the XP PU can transpose matrix [A] of matrix A_{E} 912 to form column 1 through K of matrix A_{TE} 914, and can generate each of multiplicand columns (K+1) to (K+J+P) of matrix A_{TE} 914 to contain a an M×1 multiplicand column. The multiplicand columns can comprise scalar constants or elements of M×1 multiplicand matrix.

FIG. 9C illustrates example method 920 to generate a transpose-extended matrix, such as in the examples of FIGS. 9A and 9B. As illustrated in the examples of FIGS. 9A and 9B, the resulting ISUM transpose-extended matrix can be used, for example, to compute weights and or bias gradients of a weights-bias function in a backpropagation computation. For purposes of illustrating the method, method 920 is described as performed by an XP PU such as described in reference to FIGS. 9A and 9B (“the XP PU” with reference to method 920). However, this is not intended to limit implementations; any variety of alternative processors and/or combinations of processors processing elements of a TCS, such as RDUs, MCUs, tiles and/or processors of tiles of an RDU, can generate an ISUM transpose-extended matrix.

By performing method 920, or a method similar or equivalent to method 920, the XP PU can generate an N×(K+P) transpose-extended matrix, [A_{TE}], having rows 1 to K of a K×N input matrix, [A], in columns 1 to K of matrix [A_{TE}] and having, in columns (K+1) to (K+P) of matrix [A_{TE}], multiplicand columns comprising constants or N×l matrices. The XP PU can generate columns 1 to K of matrix [A_{TE}] from an N×K matrix, [A_{T}], transposed from K×N matrix [A]. Alternatively, the XP PU can generate columns 1 to K of matrix [A_{TE}] by transposing the matrix [A] or, alternatively, by transposing rows 1 to K of a (K+P)×N ISUM extended matrix [A_{E}]. Accordingly, in describing method 920, matrix [A_{IN}] represents any one of matrix [A], matrix [A_{T}], or matrix [A_{E}] used to generate columns 1 to K of matrix [A_{TE}].

To perform the method, the XP PU can utilize a row counter, R, and a column counter, C, corresponding to row R of the matrix [A_{IN}] to be transposed to column C of matrix [A_{TE}]. In operation 922 of method 920, the XP PU initializes counters R and C to 1, corresponding initially to row 1 of the matrix [A_{IN}] to be transposed to column 1 of matrix [A_{TE}]. In operation 924, the XP PU outputs row R of matrix [A_{IN}] to column C of matrix [A_{TE}]. In operation 926 the XP PU increments R and C to indicate the next successive row of matrix [A_{IN}] and next successive column of matrix [A_{TE}]. In implementations, counter R and/or counter C can comprise a simple integer counter or, alternatively, can comprise, for example, an address of elements of respective matrices [A_{IN}] and [A_{TE}] in a memory of the TCS.

In operation 928 the XP PU determines if counter R is greater than dimension K, indicating that rows 1 to K of matrix [A_{IN}] have been transposed to corresponding columns 1 to K of matrix [A_{TE}]. If not, the XP PU repeats operations 924-926. If, on the other hand, the XP PU determines, in operation 928, that counter R is greater than dimension K, in operation 930 the XP PU determines if columns (K+1) to (K+P) of matrix [A_{TE}] are to be generated as a transposition of an ISUM row-extended matrix; generated by insertion of an M×1 multiplicand matrix [S]; or, generated by the XP PU injecting a column of constants (e.g., constant value 1 or another constant value).

In operation 930 the XP PU can determine to generate columns (K+1) to (K+P) of matrix [A_{TE}] as a transposition of an ISUM row-extended matrix based on, for example, that matrix [A_{IN}] is a (K+P)×N ISUM extended matrix, [A_{E}]. As seen in the foregoing examples of the disclosure, rows (K+1) to (K+P) of matrix [A_{E}] can comprise constant rows such that transposing rows (K+1) to (K+P) of matrix [A_{E}] generates columns (K+1) to (K+P) of matrix [A_{TE}] comprising the constants of respective rows (K+1) to (K+P) of matrix [A_{E}].

The XP PU can, alternatively, determine in operation 930 that columns (K+1) to (K+P) of matrix [A_{TE}] are to be generated by insertion of an M×1 multiplicand matrix [S] or by injecting a column of constants. The XP PU can make this determination based on, for example, that matrix [A_{IN}] comprises matrix [A] or the transposed matrix [A_{T}] of matrix [A].

If, in operation 930, the XP PU determines that columns (K+1) to (K+P) of matrix [A_{TE}] are to be generated as a transposition of matrix [A_{E}], in operation 932 the XP PU outputs row R of the matrix [A_{E}] to column C of matrix [A_{TE}].

If the XP PU determines, in operation 930, that columns (K+1) to (K+P) of matrix [A_{TE}] are to be generated inserting a multiplicand matrix [S], in operation 934 the XP PU outputs matrix [S] to column C of matrix [A_{TE}]. As previously described, matrix [S] can comprise, for example, a matrix of constants, or of differing scalar values.

If the XP PU determines, in operation 930, that columns (K+1) to (K+P) of matrix [A_{TE}] are to be generated injecting a column of constants, in operation 936 the XP PU outputs to column C of matrix [A_{TE}] an N×1 multiplicand column having constant s in each element of the multiplicand column. To output a column of matrix [A_{TE}] as a column of constants, in operation 936, the XP PU can include a constant input element similar, for example, to constant input element 336 of FIG. 3A. Similar to constant input element 336 of FIG. 3A, elements of matrix [A_{IN}] can have a particular data size, such as 8 or 16 bits. A constant input element to generate a column of constants in matrix [A_{TE}] can have a data size corresponding to the data size (e.g., 8 or 16 bits) of elements of matrix [A_{IN}]. A constant input element can comprise a constant stored in a location in a memory, stored in a register of an ISUM MCU, and/or output from hard-wired input element.

To inject constant s from a constant input element, in operation 936 the XP PU can output constant s from the constant input element into each row element of column C of matrix [A_{TE}]. For example, the XP PU can perform N number of output cycles that each output an instance of constant S into each of rows 1 to N of column C of matrix [A_{TE}]. In another example, the XP PU can have (or, have access to) a scratchpad column stored in a register, or a memory and can output the N instances of constant s into row elements of the scratchpad column. Upon completing the N output cycles, in operation 936 the XP PU can output the scratchpad column to column C of matrix [A_{TE}]. In a third example, a constant input element can comprise an N×1 constant matrix having constant s in each row of the constant matrix, and in operation 936 the XP PU can output the constant matrix to column C of matrix [A_{TE}].

In operation 940 the XP PU determines if C is greater than P, indicating that the XP PU has generated all (K+P) columns of matrix [A_{TE}]. If not, the XP PU repeats operations 926 through 940 to generate the remaining columns among columns (K+1) to (K+P) of matrix [A_{TE}]. If, alternatively, the XP PU determines in operation 940 that counter C is greater than P, in operation 942 the XP PU outputs matrix [A_{TE}]. In operation 942 the XP PU can output matrix [A_{TE}] to, for example, a memory, and/or to a BP PU, such that matrix [A_{TE}] can be utilized to compute weights and bias gradients as in the example of FIG. 9A.

In implementations, an ISUM PU, ISUM MCU, or an ISUM matrix integrator can perform a method such as method 920 to generate an ISUM transpose-extended matrix, and/or to compute gradients of a loss function input matrix using a transpose-extended matrix. FIG. 10 illustrates example TCS 1000 configured to perform loss function computations, such as illustrated in the example of FIG. 9A, using an ISUM transpose-extended matrix in integrated summation computations (e.g., MACC sum-product computations). TCS 1000 can, for example, perform method 920 of FIG. 9C (or, operations of method 920), or can perform a method similar or equivalent to method 920, to perform loss function computations using an ISUM transpose-extended matrix. For purposes of illustrating the example of FIG. 10, but not intended to limit implementations, FIG. 10 continues the example of generating an N×(K+P) ISUM transpose-extended matrix and computing weights gradients Δw, and/or bias gradients Δb, as sum-products of a loss function input matrix and the ISUM transpose-extended matrix.

In FIG. 10, example TCS 1000 is shown memories 1002A through 1002F (collectively, “memories 1002”) and further comprising FDW PU 1004A, BP PU 1004B, and XP PU 1006C (collectively, “PUs 1004”). In implementations TCS 1000 can be an ISUM TCS, such as illustrated in the foregoing examples of the disclosure, and memories among memories 1002 can be, or can comprise, memories of a host and/or runtime processor of TCS 1000 and/or memories of PUs among PUs 1004, for example.

In FIG. 10, memory 1002A is shown including (K+1)×N ISUM row-extended matrix A_{E} (hereinafter, “matrix A_{E} 1002”) and memory 1002B is shown including M×(K+1) ISUM integrated matrix [WB], (hereinafter, “matrix WB 1002”). Matrix A_{E} 1002 can be an ISUM row-extended matrix, such as in the examples of FIGS. 1C and 8A-8E. Matrix A_{E} 1002 can include, in rows 1 to K of matrix A_{E} 1002, a K×N matrix [A] (hereinafter, “matrix A 1002”), shown in FIG. 10 as included in memory 1002D, Matrix A_{E} 1002 can include, in each of rows (K+1) to (K+P) of matrix A_{E} 1002, a constant row.

Matrix WB 1002 can be an ISUM integrated matrix, such as in the examples of FIGS. 1C and 8A-8E, and can comprise an M×K matrix [W] (not shown explicitly in FIG. 10), in columns 1 to K of matrix WB 1002, and in each of columns (K+1) to (K+P), can comprise an M×1 addend column (also not shown explicitly in FIG. 10), such as columns of one or more addend matrices having row dimension M. While not shown in FIG. 10, TCS 1000 can include an ISUM matrix integrator, and the integrator can generate matrix A_{E} 1002 and/or matrix WB 1002.

PUs among PUs 1004 can comprise ISUM PUs and/or ISUM MCUs such as illustrated in the foregoing examples of the disclosure. PUs among PUs 1004 can comprise hardware circuits and/or include programs executable on processors of TCS. PUs 1004 can comprise, for example, RDUs, and/or tiles of RDUs, that can be included (but not shown explicitly in FIG. 10) in PUs among PUs 1004. Hardware circuits, processors, and programs, of TCS 1000, and/or PUs 1004 can, individually or in combination, perform techniques of the disclosure, such as illustrated in the example methods, systems, and apparati of the disclosure.

FWD PU 1004A can compute a forward Integrated Sum matrix (e.g., a matrix of MACC sum-products, Σwb a_{E}) of matrix A_{E} 1002 and matrix WB 1002, shown in FIG. 10 as M×N [forward output] matrix FO (hereinafter, “matrix FO 1002”) in memory 1002C. FWD PU 1004A can output matrix FO 1002 (or, sum-products thereof) to memory 1002C, and matrix FO 1002 can be a loss function input matrix to computations of weights and/or bias gradients such as in the example of FIG. 9A.

FIG. 10 shows memory 1002E as including (K+P)×N ISUM transpose-extended matrix [A_{TE}] (hereinafter, “matrix A_{TE} 1002”), such as in the examples of FIGS. 9A and 9B. Matrix A_{TE} 1002 can comprise, in columns 1 to K of matrix A_{TE} 1002, matrix A 1002 transposed, and can comprise, in each of columns (K+1) to (K+P) a column of constants or an N×1 matrix. FIG. 10 further depicts memory 1002D as also including N×K matrix [A_{T}] (hereinafter, “matrix A_{T} 1002”), which can be a transposition of matrix A 1002, and N×1 matrix [S] (hereinafter, “matrix S 1002”, not shown in FIG. 10). XP PU 1004C, or an alternative PU of TCS 1000, can generate matrix A_{T} 1002 and/or matrix A_{E} 1002 from matrix A 1002 (which need not necessarily be included in memory 1002D to generate matrix A_{T} 1002 and/or matrix A_{E} 1002).

XP PU 1004C can be configured to generate matrix A_{TE} 1002 from matrix A 1002, from matrix A_{T} 1002, or, from matrix A_{E} 1002; and, can be configured to, optionally, generate columns among columns (K+1) to (K+P) of matrix A_{TE} 1002 to include matrix [S]. XP PU 1004C can, for example, input matrix A 1002 to generate matrix A_{T} 1002 and/or matrix A_{E} 1002, and can store one or both matrices in memory 1002E. XP PU 1004C can input matrix A 1002, matrix A_{T} 1002, or matrix A_{E} 1002 to generate matrix A_{TE} 1002 in memory 1002E. XP PU 1004C can input matrix A 1002, matrix A_{T} 1002, or matrix A_{E} 1002 to generate columns 1 to K of matrix A_{TE} 1002. XP PU 1004C can input rows (K+1) to (K+P) of matrix A_{E} 1002 or, optionally, matrix [S] 1002, and/or a constant input element, such as constant input element 1008 in FIG. 10, to generate columns (K+1) to (K+P) of matrix A_{E} 1002. XP PU 1004C can, for example, perform method 920 in FIG. 9C to generate matrix A_{TE} 1002 and store elements of matrix A_{TE} 1002 in memory 1002E.

In FIG. 10, BP PU 1004B can be configured to compute weights and bias gradients as ISUM sum-products of M×N matrix FO 1002 and (K+P)×N matrix A_{TE} 1002, such as previously described with reference to FIGS. 9A-9C. BP PU 1004B can, for example, compute a weights gradient, Δw, as a sum-product (e.g., MACC sum-products) of elements 1 to N of a row of matrix FO 1002 multiplied by corresponding elements of a column among columns 1 to K of matrix A_{TE} 1002. BP PU 1004B can, for example, compute a bias gradient, Δb, as a sum-product (e.g., MACC sum-products) of elements 1 to N of a row of matrix FO 1002 multiplied by corresponding elements of a column among columns (K+1) to (K+P) of matrix A_{TE} 1002.

FIG. 10 illustrates BP PU 1004B inputting matrix FO 1002 and matrix A_{TE} 1002 (i.e., rows or elements of these matrices) from respective memories 1002C and 1002D, and outputting ISUM sum-product gradient results Aw and Ab to matrix WB 1002 in memory 1002B. In a backpropagation computation, FWD PU 1004A can comprise a forward PU and can use the gradient-adjusted weights and/or biases in matrix WB 1002 to recompute Σwb a_{E} based on the gradient-adjusted weight and bias elements of WB 1002.

While FIG. 10 illustrates three matrix PUs (1004A, 1004B, and 1004C) to generate an ISUM transpose-extended matrix and to compute gradients for a backpropagation algorithm, this is only to illustrate the example and not intended to limit implementations. For example, a TCS can employ more or, alternatively, fewer ISUM and/or other PUs that as illustrated in FIG. 10. A plurality of PUs, such as illustrated in the examples of FIGS. 4A, 4B, and 7B, can perform subsets of operations to generate elements of matrix A_{T} 1002, matrix A_{E} 1002, and/or matrix A_{TE}1002. The PUs can comprise ISUM MCUs and/or ISUM ALUs such as in the examples of the disclosure, and/or alternative processors and/or processing elements of a TCS.

Considering again operation 936 of method 920 in FIG. 9C, a transposition PU can inject a constant, s, into each row element of a multiplicand column of an ISUM transpose-extended matrix. As described in reference to operation 936, a transposition PU can include a constant input element and logic to selectively steer elements of an input matrix, such as an N×K matrix [A] or a K×N transposition matrix [A_{T}] of matrix [A], and can output a constant value of the constant input element to elements of a column, among columns (K+1) to (K+P) of an N×(K+P) ISUM transpose-extended matrix.

FIG. 11 illustrates an example XP PU that includes a constant input element and logic to selectively output elements of a multiplicand matrix (or, a transposition of a multiplicand matrix) and a constant value of the constant input element. In FIG. 11 TCS 1100 is shown comprising memories 1102A and 1102B (collectively, “memories 1102”) and XP PU 1104. which can comprise an ISUM transposition PU XP PU 1104. In implementations, memories among memories 1102 can be memories of TCS 1100 (as shown in FIG. 11), memories of XP PU 1104 (not shown explicitly in FIG. 11), and/or, can be memories of other ISUM PUs/MCUs of TCS 1100 (not shown in FIG. 11).

In FIG. 11 memory 1102A is shown including matrix [A_{IN}] (hereinafter, “matrix A_{IN}1102”) and memory 1102B is shown including N×(K+P) matrix [A_{TE}] (hereinafter, “matrix A_{TE}1102”). In implementations, matrix A_{IN} 1102 can be a K×N matrix [A] or, alternatively, can be an N×K transposition matrix, matrix [A_{T}], of K×N matrix [A]. Matrix A_{TE} 1102 can be an ISUM transpose-extended matrix that includes, in columns 1 to K of matrix A_{TE} 1102, transposed rows of matrix A_{IN} 1102, in the case the matrix A_{IN} 1102 comprises K×N matrix [A], or columns of matrix A_{IN} 1102 in the case that matrix A_{IN} 1102 comprises N×K transposition matrix [A_{T}]. Matrix A_{TE} 1102 can further include a constant in multiplicand columns (K+1) to (K+P) of matrix A_{TE} 1102. A BP PU of TCS 1100 (not shown in FIG. 11) can, for example, multiply matrix A_{TE} 1102 by a loss function input matrix, such as in the example of FIG. 9A. XP PU 1104 can perform operations of a method such as method 920 of FIG. 9C to generate an ISUM transpose-extended matrix from matrix A_{IN} 1102.

FIG. 11 depicts XP PU 1004 comprising read logic RD logic 1106, constant input element S 1112, boolean 1114, gate 1116, and column output logic 1110. In implementations XP PU 1104 can comprise PUs, MCUs, and/or other processing elements of TCS 1000 such as previously described. Thus, while not shown explicitly in FIG. 11, XP PU 1104 can comprise components such as shown included in ISUM MCU 310 in FIG. 3A.

XP PU 1104 can execute a (K+P) number of transposition cycles to generate matrix A_{TE} 1102. In transposition cycles 1 to K, XP PU 1004 can input (e.g., read from memory 1102A) elements of matrix A_{IN} 1102 for output to columns 1 to K of matrix A_{TE} 1102. In transposition cycles (K+1) to (K+P) XP PU 1004 can input a value of constant s from constant input element S 1112 (e.g., overriding a read operation from memory 1102A) to output to columns (K+1) to (K+P) of matrix A_{TE} 1102.

In FIG. 11 RD logic 1106 is shown comprising output vector 1108 and count 1118. Output vector 1108 can comprise, for example, a single element (e.g., a single element of a row of matrix A_{IN} 1102 or a single constant element) or, can comprise multiple elements (e.g., multiple elements of a row of matrix A_{IN} 1102 or multiple f constant elements), for output to a column of matrix A_{TE} 1102.

Count 1118 can comprise, for example, a count of transposition cycles, from 1 to (K+P). In each of the (K+P) transposition cycles XP PU 1004 can input to output vector 1108, via input 1124A, an output of gate 1116. In a transposition cycle, boolean 1114 can operate to selectively output from gate 1116 either data read from matrix A_{IN} 1102, via input 1122A to gate 1116 or, via input 1122B to gate 1116, value s of constant input element 1112 input. Gate 1116 can output the selected input to output vector 1108. Correspondingly, in each transposition cycle column output logic 1110 can receive from output vector 1108 one or more elements of matrix A_{IN} 1102, or one or more instances of constant value s, to output, via input 1128 to memory 1102B, to a column of matrix A_{TE} 1102.

To illustrate in more detail, boolean 1114 can be hardwired, and/or can be programmable, to evaluate a boolean expression and, in a transposition cycle, based on a result of the evaluation, can select among input 1122A (i.e., a row of matrix A_{IN} 1102) and input 1122B (i.e., constant input element S 1112) for output from gate 1116 to output vector 1108 via input 1124A. For example, boolean 1114 can evaluate a boolean expression such as [C>K] (or, [C<K+1], for example), where C is a value of count 1118 input to boolean 1114 via input 1126. In cycles 1 to K of the (K+P) transposition cycles, RD logic 1106 can read, via input 1122A, from memory 1102A, elements of matrix A_{IN} 1102 (where matrix A_{IN} is un-transposed matrix [A], elements of a row of matrix A_{IN} 1102 or, alternatively, where matrix A_{IN} is transposition matrix [A_{T}] elements of a column of matrix A_{IN} 1102). Boolean 1114 can evaluate [C>K] as FALSE and, in response, can configure gate 1116 to output to output vector 1108, during that transposition cycle, elements of matrix A_{IN} 1102 read on input 1122A. Alternatively, in cycles (K+1) to (K+P) of the (K+P) transposition cycles, boolean 1114 can evaluate [C>K] as TRUE. In response boolean can configure gate 1116 to output to output vector 1108, during that transposition cycle, constant s from constant input element s.

As described in reference to BP PU 1004B of FIG. 10, constant input element S 1112 can comprise a constant having a size (e.g., number of bits or bytes) corresponding to a size of elements of matrix A_{IN} 1102. In an alternative example, constant input element S 1112 can comprise a single instance of constant value s (e.g., a single register, hard-wired input to gate 1116, or memory location having a number of bits of bytes corresponding to the size of elements of matrix A_{IN} 1102.

Output vector 1108 can comprise a number of storage elements to store elements of matrix A_{IN} 1102 or instances of constant s for output to column output logic 1110. For example, output vector 1108 can comprise a memory location or register to input one element of matrix A_{IN} 1102, or to input one instance of constant s. In a transposition cycle, RD logic 1106 can, accordingly, perform N number of read cycles to read N elements of matrix A_{IN} 1102, or N instances of constant s, and output each element of instance of constant s, via input 1124B, to column output logic 1110. Column output logic 1110 can generate a column of matrix A_{TE} 1102 from outputs of output vector 1108.

Alternatively, output vector 1108 can comprise multiple memory locations or registers to input some or all elements of a row (where matrix A_{IN} is un-transposed matrix [A]) or column (where matrix A_{IN} is transposition matrix [A_{T}]) of matrix A_{IN} 1102, or multiple instances of constant s. In this case, RD logic 1106 can generate a column of matrix A_{TE} 1102 in a single, or fewer than N, input cycles to input output vector 1108.

While XP PU 1104 in FIG. 11 is shown in FIG. 11 as comprising RD logic 1106, this is to illustrate an example XP PU and not intended to limit implementations. For example, in an alternative implementation, components of RD logic 1106 (e.g., output vector 1108 and/or count 1118), and/or functions of RD logic 1106, can be components and/or functions of column output logic 1110. It would be further appreciated by one of ordinary skill in the art that functions of an XP PU to read rows of an input matrix, transpose the rows to column data of an output ISUM transposed-extended matrix, and selectively include a constant in columns (K+1) to (K+P) of the output ISUM transposed-extended matrix, can be performed using components of an XP PU other than as illustrated in the example of FIG. 11.

Components of a TCS, such as ISUM matrix integrators, ISUM TPUs, and ISUM MCUs can perform techniques of the disclosure, and/or any or all of the operations of the methods of the disclosure, in any particular combination and/or order. Components of a TCS, such as ISUM matrix integrators, ISUM PUs, and ISUM MCUs can be combined and/or subdivided in any particular arrangement suitable to perform ISUM matrix integration and computations, such as sum-product, transposition, and/or backpropagation computations used to illustrate the disclosure (but, not limited to only these example computations and matrix operations).

Implementations can comprise a computer program product and can include a computer readable storage medium (or media) having computer readable program instructions of the computer program product incorporated therein. It will be understood by one of ordinary skill in the art that computer readable program instructions can implement each or any combination of operations and/or structure of the disclosure, such as illustrated by the drawings and described herein.

The computer readable program instructions can be provided to one or more processors, and/or other elements, of a computing system or apparatus to produce a machine which can execute, via the processor(s), to implement operations and/or actions similar or equivalent to those of the disclosure. The computer readable program instructions can be stored in a computer readable storage medium that can direct one or more processors, and/or other elements, of a computing system or apparatus to function in a particular manner, such that the computer readable storage medium comprises an article of manufacture including instructions to implement operations and/or structures similar or equivalent to those of the disclosure.

The computer readable program instructions of the computer program product can cause one or more processors to perform operations of the disclosure. A sequence of program instructions, and/or an assembly of one or more interrelated programming modules, of the computer program product can direct one or more one or more processors and/or computing elements of a computing system to implement the elements and/or operations of the disclosure including, but not limited to, the structures and operations illustrated and/or described in the present disclosure.

A computer readable storage medium can comprise any tangible (e.g., hardware) device, or combination of tangible devices, that can store instructions of the computer program product and that can be read by a computing element to download the instructions for use by a processor. A computer readable storage medium can comprise, but is not limited to, electronic, magnetic, optical, electromagnetic, and/or semiconductor storage devices, or any combination of these. A computer readable storage medium can comprise a portable storage medium, such as a magnetic disk/diskette, optical disk (CD or DVD); a volatile and/or non-volatile memory; a memory stick, a mechanically encoded device, and any combination of these. A computer readable storage medium, as used herein, is not to be construed as being transitory signals per se, such as electrical signals transmitted through a wire, radio waves or other freely propagating electromagnetic waves, or electromagnetic waves propagating through a wave transmission medium (e.g., a wave guide or fiber-optic cable).

The computer readable program instructions can be communicated from the computer readable storage medium to the one or more computing/processing devices, via a programming API of a computing system, and/or a communications interface of a computing system, having access to the computer readable storage medium, and/or a programming API of a computing system, and/or a communications interface of the one or more computing/processing devices. The API(s) and/or communications interface(s) can couple communicatively and/or operatively to a network, such as the Internet, a local area network, a wide area network, and/or a wireless network. The API(s) and/or communications interface(s) can receive the computer readable program instructions read from computer readable storage medium and can forward the computer readable program instructions to the one or more computing/processing devices via the API(s), communications interface(s), and/or network.

In implementations, the computer readable program instructions of the computer program product can comprise machine language and/or assembly language instructions, instruction-set-architecture (ISA) instructions, microcode and/or firmware instructions, state-setting data, configuration data for integrated circuitry, source code, and/or object code. The instructions and/or data can be written in any combination of one or more programming languages.

The computer readable program instructions can execute entirely, or in part, on a user's computer, as a stand-alone software package; partly on a user's computer and partly on a remote computer; or, entirely on a remote computer. A remote computer can be connected to a user's computer through any type of network, including a local area network (LAN) or a wide area network (WAN). In implementations, electronic circuitry including, for example, FPGA, PLAs, and or CGRAs can execute the computer readable program instructions by utilizing state information of the computer readable program instructions to configure the electronic circuitry to perform operations or elements of the disclosure, such as illustrated by the drawings and described herein.

In implementations, computer readable program instructions can also be loaded onto a computing system, or component(s) thereof, to cause the computing system and/or component(s) thereof to perform a series of operational steps to produce a computer implemented process, such that the instructions which execute on the computing system, or component(s) thereof, implement the operations or elements of the disclosure, such as illustrated by the drawings and described herein.

The flowcharts and block diagrams in the Drawings and Incorporations illustrate the architecture, functionality, and operation of possible implementations of systems, methods, and computer program products according to various implementations of the present invention. Individual elements illustrated in the Figures—such as individual operations illustrated in the flowcharts or individual blocks of block diagrams—may represent a module, segment, or portion of executable instructions for implementing the disclosed function(s). In various alternative implementations, particular operations may occur in an order differing from that illustrated in the examples of the drawings. For example, two operations shown in succession in a diagram of the disclosure may, in a particular implementation, be executed substantially concurrently, or may sometimes be executed in a reverse order, depending upon the functionality involved. It will be further noted that particular blocks of the block diagrams, operations of the flowchart illustrations, and/or combinations of blocks in the block diagrams and/or flowcharts illustrations, can be implemented using special purpose hardware and/or systems that, individually or in combination, perform the specified functions, acts, and/or computer instructions.

Terminology used herein, and the examples disclosed, are chosen to illustrate the principles of the implementations, the practical application or technical improvement over alternative technologies, and to enable others of ordinary skill in the art to understand the implementations disclosed herein. The disclosure illustrates various example implementations, and the examples are intended to illustrate principles and aspects of the disclosure, but are not intended to limit implementations, nor intended to be exhaustive of implementations that may be conceived within the scope of the disclosure. It would be appreciated by one of ordinary skill in the art that alternative implementations can comprise modifications and combinations within the spirit of the disclosure and the scope of the claims.

As can be seen in the foregoing examples, features of the disclosure can comprise methods and apparati of computing systems. A summary of example implementations of such features includes:

### Example Implementation 1

A computer-implemented comprises: generating, by a computing system, an Integrated Summation (ISUM) integrated matrix comprising number K of multiplicand columns and number P of addend columns, wherein each of columns 1 though the number K of multiplicand columns comprises respective columns 1 through the number K of a first multiplicand matrix having the number K of columns, and wherein each of the number P of addend columns comprises an integrated addend; generating, by the computing system, an ISUM row-extended matrix comprising the number K of multiplicand rows and the number P of extended rows, wherein rows 1 through the number K of the multiplicand rows comprise respective rows 1 though the number K of a second multiplicand matrix having the number K of rows, and wherein each extended row, among the number P of extended rows, comprises a constant row; computing, by the computing system, (K+P) number of products, the (K+P) number of products comprising each column element of columns 1 through (K+P) of a row of the ISUM integrated matrix, multiplied by a corresponding row element, among rows 1 through (K+P), of a column of the ISUM row-extended matrix; and, computing, by the computing system, an Integrated Sum comprising a sum of the (K+P) number of products.

### Example Implementation 2

The example of implementation 1, wherein the method of the computing system computing the Integrated Sum comprising the sum of the (K+P) number of products comprises computing, by the computing system, the Integrated sum as a multiply-accumulate computation of each column element of the columns 1 through (K+P) of the row of the ISUM integrated matrix multiplied by the corresponding row element, among rows 1 through (K+P), of the column of the ISUM row-extended matrix.

### Example Implementation 3

The example of implementation 1, wherein the method further comprises outputting, by the computing system, the Integrated Sum to an element of an Integrated Sum Matrix, the element of the Integrated Sum matrix included in a row element of the Integrated Sum matrix corresponding to the row of the ISUM integrated matrix and included in a column element of the Integrated Sum matrix corresponding to the column of the ISUM row-extended matrix.

### Example Implementation 4

The example of implementation 1, wherein an integrated addend, among the number P of addend columns included in the ISUM integrated matrix, is selected from a group consisting of: a column of a first addend matrix and a column of a second addend matrix comprising products of a constant multiplied by each element of a column of a third addend matrix.

### Example Implementation 5

The example of implementation 1, wherein column element of an extended row, among the number P of extended rows, is a constant.

### Example Implementation 6

The example of implementation 1, wherein the computing system comprises a plurality of matrix computation units (MCUs); and, wherein the method of the computing system computing the Integrated Sum comprises: computing, by a first MCU among the plurality of MCUs, a first sum-product, the first sum-product comprising a sum of a first subset of the (K+P) number of products; computing, by a second MCU among the plurality of MCUs, a second sum-product, the second sum-product comprising a sum of a second subset of the (K+P) number of products; and adding, by a third MCU among the plurality of MCUs, the first sum-product and the second sum-product.

### Example Implementation 7

The example of implementation 6, wherein the method of the first MCU computing the first sum-product and the second MCU computing the second sum-product comprises the first MCU computing the first sum-product and the second MCU computing the second sum-product in parallel.

### Example Implementation 8

The example of implementation 6, wherein the computing system comprises an accumulator; and, wherein the method of the third MCU adding the first sum-product and the second sum-product comprises the third MCU adding product among the first subset of the (K+P) number of products, and adding a product among the second subset of the (K+P) number of products, to the accumulator.

### Example Implementation 9

A computer program comprises a computer readable storage medium having first program instructions embodied therewith, wherein the first program instructions are executable by at least one processor to cause the at least one processor to: generate an Integrated Summation (ISUM) integrated matrix comprising number K of multiplicand columns and number P of addend columns, wherein each of columns 1 though the number K of multiplicand columns comprises respective columns 1 through the number K of a first multiplicand matrix having the number K of columns, and wherein each of the number P of addend columns comprises an integrated addend; generate an ISUM row-extended matrix comprising the number K of multiplicand rows and the number P of extended rows, wherein rows 1 through the number K of the multiplicand rows comprise respective rows 1 though the number K of a second multiplicand matrix having the number K of rows, and wherein each extended row, among the number P of extended rows, comprises a constant row; compute a (K+P) number of products, the (K+P) number of products comprising each column element of columns 1 through (K+P) of a row of the ISUM integrated matrix, multiplied by a corresponding row element, among rows 1 through (K+P), of a column of the ISUM row-extended matrix; and, compute an Integrated Sum comprising a sum of the (K+P) number of products.

### Example Implementation 10

The example of implementation 9, wherein the first program instructions are executable by at least one processor to further cause the at least one processor to output the Integrated Sum to an element of an Integrated Sum Matrix, the element of the Integrated Sum matrix included in a row element of the Integrated Sum matrix corresponding to the row of the ISUM integrated matrix and included in a column element of the Integrated Sum matrix corresponding to the column of the ISUM row-extended matrix.

### Example Implementation 11

The example of implementation 9, wherein the first program instructions are executable by at least one processor to further cause the at least one processor to compute the Integrated Sum as a multiply-accumulate computation.

### Example Implementation 12

The example of implementation 9, wherein the first program instructions are executable by at least one processor to further cause the at least one processor to compute, in parallel, the Integrated Sum as a sum of a first sum-product and a second sum-product, the first sum-product comprising a sum of a first subset of the (K+P) number of products, the second sum-product comprising a sum of a second subset of the (K+P) number of products.

### Example Implementation 13

A computing system comprises: an ISUM Integrated Summation (ISUM) matrix integrator and an ISUM processing unit (ISUM PU), wherein the ISUM matrix integrator is configured to:
generate an ISUM integrated matrix comprising number K of multiplicand columns and number P of addend columns, wherein each of columns 1 though the number K of multiplicand columns comprises respective columns 1 through the number K of a first multiplicand matrix having the number K of columns, and wherein each of the number P of addend columns comprises an integrated addend; and,
generate an ISUM row-extended matrix comprising the number K of multiplicand rows and the number P of extended rows, wherein rows 1 through the number K of the multiplicand rows comprise respective rows 1 though the number K of a second multiplicand matrix having the number K of rows, and wherein each extended row, among the number P of extended rows, comprises a constant row; and, wherein the ISUM PU is configured to: compute (K+P) number of products, the (K+P) number of products comprising each column element of columns 1 through (K+P) of a row of the ISUM integrated matrix, multiplied by a corresponding row element, among rows 1 through (K+P), of a column of the ISUM row-extended matrix; and, compute an Integrated Sum comprising a sum of the (K+P) number of products.

### Example Implementation 14

The example of implementation 13, wherein the ISUM PU configured to compute the Integrated Sum comprises the ISUM PU further configured to compute the Integrated sum as a multiply-accumulate computation of each column element of the columns 1 through (K+P) of the row of the ISUM integrated matrix multiplied by the corresponding row element, among rows 1 through (K+P), of the column of the ISUM row-extended matrix.

### Example Implementation 15

The example of implementation 13, wherein the first multiplicand matrix comprises a matrix of weight values; and, wherein an addend column of the ISUM integrated matrix comprises a column of a matrix of bias values.

### Example Implementation 16

The example of implementation 13, wherein the ISUM PU comprises a first matrix computation unit (MCU) and a second MCU; and, wherein the ISUM PU configured to compute the Integrated Sum comprises: the first MCU configured to compute, in a first multiply-accumulate (MACC) computation, a first set of MACC sum-products; the second ISUM MCU configured to compute, in a second MACC computation, a second set of MACC sum-products, the first set of MACC sum-products comprising a sum of a first subset of the (K+P) number of products and the second set of MACC sum-products comprising a sum of a second subset of the (K+P) number of products; and, one of the first MCU and the second MCU further configured to compute the Integrated Sum comprising a sum of the first set of MACC sum-products and the second set of MACC sum-products.

### Example Implementation 17

The example of implementation wherein the computing system further comprises an accumulator; wherein the ISUM PU comprises a first MCU and a second MCU; wherein the ISUM PU is further configured to: input, to the first MCU, a first column element, among the each column element of the columns 1 through (K+P) of the row of the ISUM integrated matrix and input, to the first MCU, a first row element, among the corresponding row element of rows 1 through (K+P) of the column of the ISUM multiplicand matrix; and, input, to the second MCU, a second column element, among the each column element of the columns 1 through (K+P) of the row of the ISUM integrated matrix and, input, to the second MCU, a second row element, among the corresponding row element of rows 1 through (K+P) of the column of the ISUM multiplicand matrix.

The first MCU is configured to compute a first product, among the (K+P) number of products, comprising the first row element multiplied by the first column element; the second MCU is configured to compute a second product, among the (K+P) number of product comprising the second row element multiplied by the second column element; at least one of the first MCU and the second MCU are further configured to add the first product and the second product to the accumulator; and, the ISUM PU configured to compute the Integrated Sum comprises the ISUM PU further configured to compute the Integrated Sum including the accumulator.

### Example Implementation 18

The example of implementation 17, wherein the first MCU comprises a first tensor buffer, comprising a set of row element buffers, and a second tensor buffer comprising a set of column element buffers; wherein the ISUM PU configured to input the first column element to the first MCU comprises the ISUM PU configured to input the first column element into a column buffer among the set of column element buffers; wherein the first MCU configured to compute the first product comprises the first MCU further configured to input the first column element from the column buffer; wherein the ISUM PU configured to input the first row element to the first MCU comprises the ISUM PU configured to input the first row element into a row buffer among the set of row element buffers; and, wherein the first MCU configured to compute the first product comprises the first MCU further configured to input the first row element from the row buffer.

### Example Implementation 19

The example of implementation wherein the ISUM matrix integrator is a component of the ISUM PU.

### Example Implementation 20

The example of implementation 13, wherein the ISUM PU comprises a processor; and, wherein the ISUM PU configured to compute the (K+P) number of products comprises the processor configured to compute at least a subset of the (K+P) number of products.

### Example Implementation 21

A computer-implemented method comprises generating, by a computing system, an Integrated Summation (ISUM) integrated matrix comprising a number K of multiplicand columns and a number P of addend columns, wherein each of the number K of multiplicand columns comprises a corresponding column of a first multiplicand matrix, and wherein each of the number P of addend columns of the ISUM integrated matrix comprises an integrated addend; computing, by the computing system, a set of products comprising products of each column element, among the number K of multiplicand columns, of a row of the ISUM integrated matrix multiplied by a corresponding row element of a column of a second multiplicand matrix; computing, by the computing system, an addend product comprising an addend element multiplied by a constant, the addend element comprising an element of the row of the ISUM integrated matrix included an addend column among the number P of addend columns of the ISUM integrated matrix; and, computing, by the computing system, an Integrated Sum comprising a sum of the products included in the set of products and the addend product.

### Example Implementation 22

The example of implementation 21, wherein the method further comprises outputting, by the computing system, the Integrated Sum to an element of an Integrated Sum Matrix, the element of the Integrated Sum matrix included in a row element of the Integrated Sum matrix corresponding to the row of the ISUM integrated matrix and included in a column element of the Integrated Sum matrix corresponding to the column of the second multiplicand matrix.

### Example Implementation 23

The example of implementation 21, wherein the integrated addend comprises one of a constant integrated addend and a column of an addend matrix.

### Example Implementation 24

The example of implementation 21, wherein the first multiplicand matrix comprises a matrix of weight values; and, wherein an addend column of the ISUM integrated matrix comprises a column of a matrix of bias values.

### Example Implementation 25

The example of implementation 21, wherein the computing system comprises at least one matrix computation unit (MCU); and, wherein the method of the computing system computing the Integrated Sum comprises:
computing, by a first MCU, among the at least one MCU, a first sum-product, the first sum-product comprising a sum of a subset of the set of products, the first sum-product included in the sum of the set of products added to the addend product; and computing, by a second MCU, among the at least one MCU, a second sum-product, the second sum-product comprising a sum of the first sum-product and the addend product, the second sum-product included in the sum of the set of products added to the addend product.

### Example Implementation 26

The example of implementation 25, wherein the method of the first MCU computing the first sum-product comprises the first MCU computing the first sum-product as a multiply-accumulate computation.

### Example Implementation 27

The example of implementation 21, wherein the constant comprises a value of a constant input element of the computing system.

### Example Implementation 28

The example of implementation 27, wherein the computing system comprises multiplier selection logic and the constant input element comprises an input to the multiplier selection logic; and, wherein the multiplier selection logic outputs the value of the constant input element to compute the addend element multiplied by the constant.

### Example Implementation 29

A computing system comprises an Integrated Summation (ISUM) matrix integrator, at least one memory, and at least one matrix computation unit (MCU),
wherein the ISUM matrix integrator is configured to: generate, in a first memory among the at least one memory, an Integrated Summation (ISUM) integrated matrix comprising a number K of multiplicand columns and a number P of addend columns, wherein each of the number K of multiplicand columns comprises a corresponding column of a first multiplicand matrix, and wherein each of the number P of addend columns of the ISUM integrated matrix comprises an integrated addend; and,
wherein the at least one MCU is configured to: compute a set of products comprising products of each column element, among the number K of multiplicand columns, of a row of the ISUM integrated matrix multiplied by a corresponding row element of a column of a second multiplicand matrix; compute an addend product comprising an addend element multiplied by a constant, the addend element comprising an element of the row of the ISUM integrated matrix included an addend column among the number P of addend columns of the ISUM integrated matrix; and, compute an Integrated Sum comprising a sum of the products included in the set of products and the addend product.

### Example Implementation 30

The example of implementation 29, wherein the computing system further comprises a constant input element, the constant input element comprising a value of the constant; and, wherein the computing system configured to compute the addend product comprising the addend element multiplied by the constant comprises the computing system further configured to multiply the addend element by the value of the constant included in the constant input element to compute the addend product.

### Example Implementation 31

The example of implementation 29, wherein the ISUM matrix integrator comprises a processor and a program; and, wherein the ISUM matrix integrator configured to generate the ISUM integrated matrix comprises the processor executing the program to generate at least a portion of the ISUM integrated matrix.

### Example Implementation 32

The example of implementation 29, wherein the at least one MCU configured to compute the Integrated Sum comprises a first MCU, among the at least one MCU, configured to compute a first subset of the set of products and a second MCU, among the at least one MCU, configured to compute a second subset of the set of products; and, wherein a third MCU, among the at least one MCU is configured to compute a sum of first products, included among the first subset of the set of products, and second products included among products among the second subset of the set of products.

### Example Implementation 33

The example of implementation 29, wherein the at least one MCU configured to compute the Integrated Sum comprises the at least one MCU further configured to: compute, in a first multiply-accumulate (MACC) computation, a first MACC sum-product comprising a sum of a first subset of the set of products; compute, in a second MACC computation, a second MACC sum-product comprising a sum of a second subset of the set of products; and, compute, in a third MACC computation, a third MACC sum-product comprising a sum of the addend product and at least one of the first MACC sum-product and the second MACC sum-product.

### Example Implementation 34

The example of implementation 29, wherein the integrated addend comprises one of a constant integrated addend and a column of an addend matrix.

### Example Implementation 35

The example of implementation 29, wherein the first multiplicand matrix comprises a matrix of weight values; and, wherein an addend column of the ISUM integrated matrix comprises a column of a matrix of bias values.

### Example Implementation 36

A matrix computation unit (MCU) comprises a multiply-accumulate (MACC) Arithmetic Logic Unit (ALU), multiplier selection logic, and a constant input element, wherein the MACC ALU comprises a first multiplier input and a second multiplier input; wherein the multiplier selection logic comprises a multiplicand input and a constant input; wherein the constant input element comprising a value of a constant;
wherein the MACC ALU is configured to: receive, from the first multiplier input a first multiplicand element; input, from the second multiplier input, a second multiplicand element; compute a product comprising the first multiplicand element multiplied by the second multiplicand element; compute a sum-product comprising the product added to a first value of an accumulator; and, store the sum-product in the accumulator;
wherein the MCU is configured to: input to the first multiplier input of the MACC ALU a column element from among column elements of a row of an Integrated Summation (ISUM) integrated matrix comprising a number K of multiplicand columns and a number P of addend columns, wherein each of the number K of multiplicand columns comprises a corresponding column of a first multiplicand matrix, and wherein each of the number P of addend columns of the ISUM integrated matrix comprises an integrated addend; input to the multiplicand input of the multiplier selection logic, a row element, from among row elements of a column of a second multiplicand matrix; and, input to the constant input of the multiplier selection logic an output of the multiplier selection logic; and,
wherein the multiplier selection logic is configured to: determine that the column element is input from a multiplicand column of the ISUM integrated matrix; responsive to determining that the column element is input from the multiplicand column of the ISUM integrated matrix, output the multiplicand input of the multiplier selection logic to the second multiplier input of the MACC ALU for the MACC ALU to compute the product as the column element multiplied by the multiplicand input; determine that the column element is input from an addend column of the ISUM integrated matrix; and, responsive to determining that the column element is input from the addend column of the ISUM integrated matrix, output the constant input of the multiplier selection logic to the second multiplier input of the MACC ALU for the MACC ALU to compute the product as the column element multiplied by the constant input.

### Example Implementation 37

The example of implementation 36, wherein the multiplier selection logic comprises a counter coupled to a counter, the counter configured to count computations of products by the MACC ALU; and, wherein the multiplier selection logic configured to determine that the column element is input from the addend column of the ISUM integrated matrix comprises the multiplier selection logic further configured to determine that the column element is input from the addend column of the ISUM integrated matrix based on the counter reaching a value greater than the number K.

### Example Implementation 38

The example of implementation 37, wherein the counter is further configured to output, to the multiplier selection logic, a status indicating to the multiplier selection logic to output the constant input of the multiplier selection logic to the second multiplier input of the MACC ALU from the constant input element; and, wherein the multiplier selection logic is further configured to output the constant input of the multiplier selection logic to the second multiplier input of the MACC ALU responsive to the status.

### Example Implementation 39

The example of implementation 36, wherein the first multiplicand matrix comprises a matrix of weight values; and, wherein an addend column of the ISUM integrated matrix comprises a column of a matrix of bias values.

### Example Implementation 40

The example of implementation 36 wherein the integrated addend comprises one of a constant integrated addend and a column of an addend matrix.

Implementations can comprise, additionally or alternatively, methods and apparati of computing systems disclosed herein to process matrices in backpropagation. A summary of examples of such implementations includes:

### Example Implementation 41

A computer-implemented method comprises executing, by a computing system, (K+P) number of transposition cycles to generate an Integrated Summation (ISUM) transpose-extended matrix having N number of rows and (K+P) number of columns; generating, by the computing system, in cycles 1 to K of the (K+P) number of transposition cycles, columns 1 to K of ISUM transpose-extended matrix to comprise a matrix transposition of corresponding rows 1 to K of a first multiplicand matrix; generating, by the computing system, in cycles (K+1) to (K+P) of the (K+P) number of transposition cycles, each of columns (K+1) to (K+P) of the ISUM transpose-extended matrix to comprise a multiplicand column having N number of rows; computing, by the computing system, a first sum-product comprising a sum of products of elements of a row of a second multiplicand matrix, having M rows and N columns, multiplied by corresponding elements of a first column of the ISUM transpose-extended matrix, the first column among columns 1 to K, of the ISUM transpose-extended matrix; and, computing, by the computing system, a second sum-product comprising a sum of products of the elements of the row of the second multiplicand matrix multiplied by corresponding elements of a second column of the ISUM transpose-extended matrix, the second column among columns (K+1) to (K+P), of the ISUM transpose-extended matrix.

### Example Implementation 42

The example of implementation 41, wherein the first multiplicand matrix comprises an ISUM row-extended matrix having (K+P) number of rows and N number of columns; and, wherein the method of the computing system generating each of columns (K+1) to (K+P) of the ISUM transpose-extended matrix to comprise the multiplicand column comprises transposing, by the computing system, in the cycles (K+1) to (K+P) of the (K+P) number of transposition cycles, rows (K+1) to (K+P) of the ISUM row-extended matrix to comprise corresponding columns of columns (K+1) to (K+P) of the ISUM transpose-extended matrix.

### Example Implementation 43

The example of implementation 41, wherein the first multiplicand matrix has K number of columns; and, wherein the method of the computing system generating each of columns (K+1) to (K+P) of the ISUM transpose-extended matrix to comprise the multiplicand column comprises the computing system including in a third column, among columns (K+1) to (K+P) of the ISUM transpose-extended matrix, a column of a third multiplicand matrix having N rows and one column.

### Example Implementation 44

The example of implementation 41, wherein the method of the computing system generating each of columns (K+1) to (K+P) of the ISUM transpose-extended matrix to comprise the multiplicand column comprises: generating, by the computing system, a constant column consisting of N number of constant elements each comprising a value of a constant; and, including, by the computing system, in a third column among columns (K+1) to (K+P) of the ISUM transpose-extended matrix, the constant column.

### Example Implementation 45

The example of implementation 44, wherein the computing system includes a constant input element having the value of the constant; and, wherein the method of the computing system generating the constant column comprises the computing system generating the value of the constant from the constant input element.

### Example Implementation 46

The example of implementation 45, wherein the constant input element is included in multiplier selection logic of the computing system; and, wherein the method of the computing system generating the value of the constant from the constant input element comprises computing system generating the constant column further comprises the computing system, in the cycles (K+1) to (K+P) of the (K+P) number of transposition cycles, configuring the multiplier selection logic to output the value of the constant from the constant input element.

### Example Implementation 47

The example of implementation 41, wherein the second sum-product consists of a sum of products of elements of columns 1 to N of the row of the second multiplicand matrix computed by multiplying the elements of the row of the first multiplicand matrix multiplied by the corresponding elements of the second column among the columns (K+1) to (K+P) of the ISUM transpose-extended matrix.

### Example Implementation 48

The example of implementation 41, wherein the second multiplicand matrix comprises a loss function input matrix having M rows and N columns; wherein the first sum-product comprises a gradient of elements a row of the loss function input matrix multiplied by a third column of the ISUM transpose-extended matrix, the third column among columns 1 to K of the ISUM transpose-extended matrix; and, wherein the second sum-product comprises a gradient of elements of the row of the loss function input matrix multiplied by a fourth column of the ISUM transpose-extended matrix, the fourth column among columns (K+1) to (K+P) of the ISUM transpose-extended matrix.

### Example Implementation 49

A computing system comprises at least one memory, the at least one memory comprising a first multiplicand matrix having at least K number of rows and N number of columns and a second multiplicand matrix having M rows and N columns; a transposition processing unit (XP PU) configured to execute a (K+P) number of transposition cycles to: generate, in cycles 1 to K of the (K+P) number of transposition cycles, columns 1 to K of an Integrated Summation (ISUM) transpose-extended matrix to comprise a matrix transposition of corresponding rows 1 to K of the first multiplicand matrix, the ISUM transpose-extended matrix having N number of rows and (K+P) number of columns; and, generate, in cycles (K+1) to (K+P) of the (K+P) number of transposition cycles, each of columns (K+1) to (K+P) of the ISUM transpose-extended matrix to comprise a multiplicand column having N number of rows.

The computing system further comprises a backpropagation processing unit (BP PU) configured to: compute a first sum-product comprising a sum of products of elements of a row of a second multiplicand matrix, having M rows and N columns, multiplied by corresponding elements of a first column of the ISUM transpose-extended matrix, the first column among columns 1 to K, of the ISUM transpose-extended matrix; and, compute a second sum-product comprising a sum of products of the elements of the row of the second multiplicand matrix multiplied by corresponding elements of a second column of the ISUM transpose-extended matrix, the second column among columns (K+1) to (K+P), of the ISUM transpose-extended matrix.

### Example Implementation 50

The example of implementation 49, wherein the first multiplicand matrix comprises an ISUM row-extended matrix having (K+P) number of rows and N number of columns; and, wherein the XP PU configured to generate the ISUM transpose-extended matrix to comprise the multiplicand column in each of columns (K+1) to (K+P) of the ISUM transpose-extended matrix comprises the XP PU further configured to transpose, in the cycles (K+1) to (K+P) of the (K+P) number of transposition cycles, rows (K+1) to (K+P) of the ISUM row-extended matrix to comprise corresponding columns among columns (K+1) to (K+P) of the ISUM transpose-extended matrix.

### Example Implementation 51

The example of implementation 49, wherein the first multiplicand matrix comprises an ISUM row-extended matrix having (K+P) number of rows and N number of columns; and, wherein the XP PU configured to generate the ISUM transpose-extended matrix to comprise the multiplicand column in each of columns (K+1) to (K+P) of the ISUM transpose-extended matrix comprises the XP PU further configured to include, in a third column, among columns (K+1) to (K+P) of the ISUM transpose-extended matrix, a column of a third multiplicand matrix having N rows and one column.

### Example Implementation 52

The example of implementation 51, wherein the first multiplicand matrix having at least K number of columns comprises the first multiplicand matrix having K number of columns; and, wherein the XP PU configured to generate each of columns (K+1) to (K+P) of the ISUM transpose-extended matrix to comprise the multiplicand column comprises the XP PU further configured to include, in a third column, among columns (K+1) to (K+P) of the ISUM transpose-extended matrix, a column of a third multiplicand matrix having N rows and one column.

### Example Implementation 53

The example of implementation 49, wherein XP PU configured to generate each of columns (K+1) to (K+P) of the ISUM transpose-extended matrix to comprise the multiplicand column comprises the XP PU further configured to: generate a constant column consisting of N number of constant elements each comprising a value of a constant; and, include, in a third column among columns (K+1) to (K+P) of the ISUM transpose-extended matrix, the constant column.

### Example Implementation 54

The example of implementation 53, wherein the computing system includes a constant input element having the value of the constant; and, wherein the XP PU configured to generate the constant column comprises the XP PU further configured to generate the value of the constant from the constant input element

### Example Implementation 55

The example of implementation 54, wherein the computing system further comprises multiplier selection logic configurable to output the value of the constant from the constant input element; and, wherein the XP PU configured to generate the value of the constant from the constant input element comprises the XP PU further configured to configure the multiplier selection logic, in the cycles (K+1) to (K+P) of the (K+P) number of transposition cycles, to output the value of the constant from the constant input element to generate the value of the constant from the constant input element.

### Example Implementation 56

The example of implementation 49, wherein the second column comprises a constant column having constant value one; and, wherein the BP PU configured to compute the sum of products of the elements of the row of the second multiplicand matrix multiplied by the corresponding elements of the second column comprises the BP PU further configured to compute a sum of elements of columns 1 to N of the row of the second multiplicand matrix by multiplying the elements of the row of the second multiplicand matrix by the constant value one in the corresponding elements of the second column.

### Example Implementation 57

A transposition processing unit (XP PU) comprises an output vector and column output logic, wherein the XP PU is configured to: execute a (K+P) number of transposition cycles to generate (K+P) number of columns of an Integrated Summation (ISUM) transpose-extended matrix; input to the output vector, in transposition cycles 1 to K of the (K+P) number of transposition cycles, a column element included a row, among respective rows 1 to K of an input matrix having K number of row; input into the output vector, in transposition cycles (K+1) to (K+P) of the (K+P) number of transposition cycles, a value of a constant; and, output to a column of the ISUM transpose-extended matrix, the output vector, the column of the ISUM transpose-extended matrix corresponding to a first cycle number corresponding to a first transposition cycle among the (K+P) number of transposition cycles.

### Example Implementation 58

The example of implementation 57, wherein the column element is selected from a column of the row of the input matrix corresponding to a second cycle number corresponding to a second transposition cycle among the (K+P) number of transposition cycles, the second transposition cycle among the transposition cycles 1 to K; and, wherein the column of the ISUM transpose-extended matrix comprises a column of the ISUM transpose-extended matrix corresponding to the second cycle number.

### Example Implementation 59

The example of implementation 57, wherein the XP PU further comprises a counter, an input gate, a constant input element comprising the value of the constant, and boolean expression logic; wherein the XP PU is further configured to set a value of the counter to correspond to a transposition cycle among the (K+P) number of transposition cycles; wherein the input gate is configured to receive, on a matrix input of the input gate, the column element, and to receive, on a constant input of the input gate, an output of the constant input element; wherein the output vector is configured to receive an output of the input gate; and, wherein the boolean expression logic is configured to receive a value of the counter and, based on the value of the counter, select one of the matrix input and the constant input for output from the input gate to the output vector.

The XP PU configured to input, in transposition cycles 1 to K of the (K+P) number of transposition cycles, the column element into the output vector comprises the boolean expression logic selecting, based on the counter corresponding to a second transposition cycle, the matrix input of the input gate for output from the input gate to the output vector, the second transposition cycle among the transposition cycles 1 to K of the (K+P) number of transposition cycles; and, the XP PU configured input into the output vector, in transposition cycles (K+1) to (K+P) of the (K+P) number of transposition cycles, the value of the constant, comprises the boolean expression logic selecting, based on the counter corresponding to a third transposition cycle, the constant input of the input gate for output from the input gate to the output vector, the third transposition cycle among the transposition cycles (K+1) to (K+P) of the (K+P) number of transposition cycles.

What is claimed is:

1. A method, the method comprising:
generating, by a computing system, an Integrated Summation (ISUM) integrated matrix comprising number K of multiplicand columns and number P of addend columns, wherein each of columns 1 though the number K of multiplicand columns comprises respective columns 1 through the number K of a first multiplicand matrix having the number K of columns, and wherein each of the number P of addend columns comprises an integrated addend;
generating, by the computing system, an ISUM row-extended matrix comprising the number K of multiplicand rows and the number P of extended rows, wherein rows 1 through the number K of the multiplicand rows comprise respective rows 1 though the number K of a second multiplicand matrix having the number K of rows, and wherein each extended row, among the number P of extended rows, comprises a constant row;
computing, by the computing system, (K+P) number of products, the (K+P) number of products comprising each column element of columns 1 through (K+P) of a row of the ISUM integrated matrix, multiplied by a corresponding row element, among rows 1 through (K+P), of a column of the ISUM row-extended matrix; and,
computing, by the computing system, an Integrated Sum comprising a sum of the (K+P) number of products.

2. The method of claim 1, wherein the method of the computing system computing the Integrated Sum comprising the sum of the (K+P) number of products comprises computing, by the computing system, the Integrated sum as a multiply-accumulate computation of each column element of the columns 1 through (K+P) of the row of the ISUM integrated matrix multiplied by the corresponding row element, among rows 1 through (K+P), of the column of the ISUM row-extended matrix.

3. The method of claim 1, wherein the method further comprises outputting, by the computing system, the Integrated Sum to an element of an Integrated Sum Matrix, the element of the Integrated Sum matrix included in a row element of the Integrated Sum matrix corresponding to the row of the ISUM integrated matrix and included in a column element of the Integrated Sum matrix corresponding to the column of the ISUM row-extended matrix.

4. The method of claim 1, wherein an integrated addend, among the number P of addend columns included in the ISUM integrated matrix, is selected from a group consisting of: a column of a first addend matrix and a column of a second addend matrix comprising products of a constant multiplied by each element of a column of a third addend matrix.

5. The method of claim 1, wherein column element of an extended row, among the number P of extended rows, is a constant.

6. The method of claim 1, wherein the computing system comprises a plurality of matrix computation units (MCUs); and,
wherein the method of the computing system computing the Integrated Sum comprises:
computing, by a first MCU among the plurality of MCUs, a first sum-product, the first sum-product comprising a sum of a first subset of the (K+P) number of products;
computing, by a second MCU among the plurality of MCUs, a second sum-product, the second sum-product comprising a sum of a second subset of the (K+P) number of products; and
adding, by a third MCU among the plurality of MCUs, the first sum-product and the second sum-product.

7. The method of claim 6, wherein the method of the first MCU computing the first sum-product and the second MCU computing the second sum-product comprises the first MCU computing the first sum-product and the second MCU computing the second sum-product in parallel.

8. The method of claim 6, wherein the computing system comprises an accumulator; and,
wherein the method of the third MCU adding the first sum-product and the second sum-product comprises the third MCU adding product among the first subset of the (K+P) number of products, and adding a product among the second subset of the (K+P) number of products, to the accumulator.

9. A computer program product, the computer program product comprising a computer readable storage medium having first program instructions embodied therewith, wherein the first program instructions are executable by at least one processor to cause the at least one processor to:
generate an Integrated Summation (ISUM) integrated matrix comprising number K of multiplicand columns and number P of addend columns, wherein each of columns 1 though the number K of multiplicand columns comprises respective columns 1 through the number K of a first multiplicand matrix having the number K of columns, and wherein each of the number P of addend columns comprises an integrated addend;
generate an ISUM row-extended matrix comprising the number K of multiplicand rows and the number P of extended rows, wherein rows 1 through the number K of the multiplicand rows comprise respective rows 1 though the number K of a second multiplicand matrix having the number K of rows, and wherein each extended row, among the number P of extended rows, comprises a constant row;
compute a (K+P) number of products, the (K+P) number of products comprising each column element of columns 1 through (K+P) of a row of the ISUM integrated matrix, multiplied by a corresponding row element, among rows 1 through (K+P), of a column of the ISUM row-extended matrix; and,
compute an Integrated Sum comprising a sum of the (K+P) number of products.

10. The computer program product of claim 9, wherein the first program instructions are executable by at least one processor to further cause the at least one processor to output the Integrated Sum to an element of an Integrated Sum Matrix, the element of the Integrated Sum matrix included in a row element of the Integrated Sum matrix corresponding to the row of the ISUM integrated matrix and included in a column element of the Integrated Sum matrix corresponding to the column of the ISUM row-extended matrix.

11. The computer program product of claim 9, wherein the first program instructions are executable by at least one processor to further cause the at least one processor to compute the Integrated Sum as a multiply-accumulate computation.

12. The computer program product of claim 9, wherein the first program instructions are executable by at least one processor to further cause the at least one processor to compute, in parallel, the Integrated Sum as a sum of a first sum-product and a second sum-product, the first sum-product comprising a sum of a first subset of the (K+P) number of products, the second sum-product comprising a sum of a second subset of the (K+P) number of products.

13. A computing system, the computing system comprising an ISUM Integrated Summation (ISUM) matrix integrator and an ISUM processing unit (ISUM PU),
wherein the ISUM matrix integrator is configured to:
generate an ISUM integrated matrix comprising number K of multiplicand columns and number P of addend columns, wherein each of columns 1 though the number K of multiplicand columns comprises respective columns 1 through the number K of a first multiplicand matrix having the number K of columns, and wherein each of the number P of addend columns comprises an integrated addend; and,
generate an ISUM row-extended matrix comprising the number K of multiplicand rows and the number P of extended rows, wherein rows 1 through the number K of the multiplicand rows comprise respective rows 1 though the number K of a second multiplicand matrix having the number K of rows, and wherein each extended row, among the number P of extended rows, comprises a constant row; and,
wherein the ISUM PU is configured to:
compute (K+P) number of products, the (K+P) number of products comprising each column element of columns 1 through (K+P) of a row of the ISUM integrated matrix, multiplied by a corresponding row element, among rows 1 through (K+P), of a column of the ISUM row-extended matrix; and,
compute an Integrated Sum comprising a sum of the (K+P) number of products.

14. The computing system of claim 13, wherein the ISUM PU configured to compute the Integrated Sum comprises the ISUM PU further configured to compute the Integrated sum as a multiply-accumulate computation of each column element of the columns 1 through (K+P) of the row of the ISUM integrated matrix multiplied by the corresponding row element, among rows 1 through (K+P), of the column of the ISUM row-extended matrix.

15. The computing system of claim of claim 13, wherein the ISUM PU is further configured to output by the Integrated Sum to an element of an Integrated Sum Matrix, the element of the Integrated Sum matrix included in a row element of the Integrated Sum matrix corresponding to the row of the ISUM integrated matrix and included in a column element of the Integrated Sum matrix corresponding to the column of the ISUM row-extended matrix.

16. The computing system of claim of claim 13, wherein the ISUM PU comprises a first matrix computation unit (MCU) and a second MCU; and,
wherein the ISUM PU configured to compute the Integrated Sum comprises:
the first MCU configured to compute, in a first multiply-accumulate (MACC) computation, a first set of MACC sum-products;
the second ISUM MCU configured to compute, in a second MACC computation, a second set of MACC sum-products, the first set of MACC sum-products comprising a sum of a first subset of the (K+P) number of products and the second set of MACC sum-products comprising a sum of a second subset of the (K+P) number of products; and,
one of the first MCU and the second MCU further configured to compute the Integrated Sum comprising a sum of the first set of MACC sum-products and the second set of MACC sum-products.

17. The computing system of claim 13, wherein the computing system further comprises an accumulator;
wherein the ISUM PU comprises a first MCU and a second MCU;
wherein the ISUM PU is further configured to:
input, to the first MCU, a first column element, among the each column element of the columns 1 through (K+P) of the row of the ISUM integrated matrix and input, to the first MCU, a first row element, among the corresponding row element of rows 1 through (K+P) of the column of the ISUM multiplicand matrix;
input, to the second MCU, a second column element, among the each column element of the columns 1 through (K+P) of the row of the ISUM integrated matrix and, input, to the second MCU, a second row element, among the corresponding row element of rows 1 through (K+P) of the column of the ISUM multiplicand matrix;
wherein the first MCU is configured to compute a first product, among the (K+P) number of products, comprising the first row element multiplied by the first column element;
wherein the second MCU is configured to compute a second product, among the (K+P) number of products, comprising the second row element multiplied by the second column element;
wherein at least one of the first MCU and the second MCU are further configured to add the first product and the second product to the accumulator; and,
wherein the ISUM PU configured to compute the Integrated Sum comprises the ISUM PU further configured to compute the Integrated Sum including the accumulator.

18. The computing system of claim 17, wherein the first MCU comprises a first tensor buffer, comprising a set of row element buffers, and a second tensor buffer comprising a set of column element buffers;
wherein the ISUM PU configured to input the first column element to the first MCU comprises the ISUM PU configured to input the first column element into a column buffer among the set of column element buffers;
wherein the first MCU configured to compute the first product comprises the first MCU further configured to input the first column element from the column buffer;
wherein the ISUM PU configured to input the first row element to the first MCU comprises the ISUM PU configured to input the first row element into a row buffer among the set of row element buffers; and,
wherein the first MCU configured to compute the first product comprises the first MCU further configured to input the first row element from the row buffer.

19. The computing system of claim 13, wherein the first multiplicand matrix comprises a matrix of weight values; and,
wherein an addend column of the ISUM integrated matrix comprises a column of a matrix of bias values.

20. The computing system of claim of claim 13, wherein the ISUM PU comprises a processor; and,
wherein the ISUM PU configured to compute the (K+P) number of products comprises the processor configured to compute at least a subset of the (K+P) number of products.
